(19) United States
(12) Patent Application Publication
(10) Pub. No.: US 2024/0042443 A1
(43) Pub. Date: Feb. 8, 2024

(54) MICROFLUIDIC DEVICE WITH INTEGRATED MAGNETS FOR BIOMARKER DETECTION AND MANIPULATION

(71) Applicant: UVic Industry Partnerships Inc., Victoria (CA)

(72) Inventors: Mohsen Akbari, Victoria (CA); Amir Seyfoori, Victoria (CA)

(73) Assignee: UVic Industry Partnerships Inc., Victoria (CA)

(21) Appl. No.: 18/360,442

(22) Filed: Jul. 27, 2023

Related U.S. Application Data
(60) Provisional application No. 63/392,735, filed on Jul. 27, 2022.

(51) Int. Cl. B01L 3/00; B03C 1/28

(52) U.S. Cl. CPC B01L 3/502761; B03C 1/288; B01L 2200/0647; B01L 2300/087; B01L 2400/084; B03C 2201/26; B03C 2201/18

(57) ABSTRACT

A microfluidic device includes a channel having converging and diverging portions, and a plurality of magnets arranged next to the channel. The plurality of magnets is arranged to apply a magnetic field across the channel to capture magnetic particles in diverging portions of the channel where a velocity of a liquid in the channel is reduced.

### CROSS REFERENCE TO RELATED APPLICATION

The present application claims the benefit of U.S. Provisional Application No. 63/392,735, filed Jul. 27, 2022, which is incorporated herein by reference in its entirety.

### FIELD

The present disclosure concerns embodiments of microfluidic devices for use in detecting and/or manipulating biomarkers.

### BACKGROUND

Capturing rare disease-associated biomarkers from body fluids can allow for early-stage diagnosis of life-threatening disease such as HIV, malaria, and cancer and therefore increase patient survival rate. Circulating tumor cells (CTCs) can provide information about cancer prognosis, metastasis, and progression. Clinical solutions for quantifying CTCs in blood include macroscale immunomagnetic separation systems and are currently used in the diagnosis of several cancer types. However, microfluidic systems that employ magnetic particle separation for such purposes have limited efficiencies due to generation of low magnetic forces that are insufficient to trap cells in defined positions within microchannels. Accordingly, a need exists in the art for improved microscale devices and systems capable of identifying and manipulating biomarkers in human body fluids.

### SUMMARY

The present disclosure pertains to microfluidic devices for capture, detection, and/or isolation of biomarkers from a sample liquid introduced to the device, and methods of using the same. In a representative example, a microfluidic device comprises a channel, comprising converging and diverging portions; and a plurality of magnets arranged next to the channel; wherein the plurality of magnets is arranged to apply a magnetic field across the channel to capture magnetic particles in diverging portions of the channel where a velocity of a liquid in the channel is reduced.

In any or all of the examples described herein, the plurality of magnets comprises a first magnet, a second magnet, and a third magnet, the first magnet is beneath the channel, and the channel extends between the second magnet and the third magnet.

In any or all of the examples described herein, the second and third magnets are permanent magnets or electromagnets.

In any or all of the examples described herein, the first magnet comprises a soft, superparamagnetic material.

In any or all of the examples described herein, the first magnet is one magnet of an array of first magnets; and the first magnets of the array of first magnets are spaced apart along a direction of flow through the channel.

In any or all of the examples described herein, the channel comprises a plurality of chambers, each chamber comprising a portion of the channel wherein walls of the channel diverge in the direction of flow to a widest portion of the diverging portion and subsequently converge from the widest portion to a narrowest portion; and first magnets of the array of first magnets are positioned beneath the chambers of the channel along a direction of flow through the channel.

In any or all of the examples described herein, sequential chambers of the channel are spaced apart from each other along the flow direction by narrower connecting portions, and a widest diameter of the chambers of the channel and a widest diameter of connecting portions of the channel are in a ratio of 2:1 to 4:1.

In any or all of the examples described herein, first magnets of the array of first magnets have an ellipsoid shape or an arrow shape.

In any or all of the examples described herein, a length dimension of the first magnets of the array of first magnets is greater than a width dimension of the first magnets of the array of first magnets; and the first magnets of the array of first magnets are arranged such that their length dimensions are perpendicular to the flow direction of the channel.

In any or all of the examples described herein, the microfluidic device comprises a first inlet in fluid communication with the channel and a second inlet in fluid communication with the channel; the first inlet communicates with the channel along a longitudinal axis of the channel; and the second inlet communicates with the channel radially outward of the longitudinal axis of the channel such that liquid injected into the channel through the second inlet is radially outward of liquid injected into the channel through the first inlet.

In any or all of the examples described herein, the microfluidic device comprises a first substrate and a second substrate, the first substrate being arranged on top of the second substrate; the second magnet and the third magnet are on the first substrate; and the first magnet is on the second substrate and aligned with the channel on the first substrate above on the first magnet.

In any or all of the examples described herein, the plurality of magnets comprises a first magnet, a second magnet, a third magnet, and a fourth magnet; the first, second, third, and fourth magnets are arranged on a plane with the channel, the first and fourth magnets are located between the second and third magnets, and the channel extends between the first and fourth magnets; and the first and fourth magnets comprise a soft, superparamagnetic material and the second and third magnets are permanent magnets or electromagnets.

In any or all of the examples described herein, the first magnet and the fourth magnet are aligned with chambers of the channel along a direction of flow.

In another representative example, a microfluidic device comprises a substrate defining a channel, the channel extending between an inlet and an outlet, the channel alternatingly widening and narrowing to define a plurality of chambers in a direction of flow along the channel between the inlet and the outlet; and a plurality of magnets arranged about the channel and configured to apply a magnetic field to the chambers to capture magnetic particles in the chambers.

In any or all of the examples described herein, the plurality of magnets includes a first magnet array positioned beneath the channel.

In any or all of the examples described herein, magnets of the first magnet array are aligned with the chambers; and the plurality of magnets further comprises a second magnet array comprising a plurality of permanent magnets arranged on opposite sides of the channel.

In any or all of the examples described herein, the substrate is a first substrate, and the microfluid device further comprises a second substrate, the first substrate being arranged on top of the second substrate; the plurality of permanent magnets is on the first substrate; and the first magnet array is on the second substrate and aligned with the channel on the first substrate above the first magnet array.

In any or all of the examples described herein, magnets of the first magnet array have an ellipsoid shape or an arrow shape, and comprise a soft, superparamagnetic material.

In any or all of the examples described herein, sequential chambers of the channel are spaced apart from each other along the flow direction by narrower connecting portions, and a widest diameter of the chambers of the channel and a widest diameter of connecting portions of the channel are in a ratio of 2:1 to 4:1.

In any or all of the examples described herein, the microfluidic device comprises a first inlet in fluid communication with the channel and a second inlet in fluid communication with the channel; the first inlet communicates with the channel along a longitudinal axis of the channel; and the second inlet communicates with the channel radially outward of the longitudinal axis of the channel such that liquid injected into the channel through the second inlet is radially outward of liquid injected into the channel through the first inlet.

The foregoing objects, features, and advantages of the disclosed technology will become more apparent from the following detailed description, which proceeds with reference to the accompanying figures.

### BRIEF DESCRIPTION OF THE DRAWINGS

FIG. 1A is an exploded, perspective view of an exemplary two-layer microfluidic device.

FIG. 1B is a perspective view of an exemplary assembled two-layer microfluidic device.

FIG. 2 is a top view of an exemplary upper substrate of the two-layer microfluidic device illustrated in FIG. 1, showing an exemplary channel and exemplary second and third magnets. The directions of the poles of the second and third magnets in relation to one another are shown.

FIG. 3A is a top view of an exemplary lower substrate of the two-layer microfluidic device illustrated in FIG. 1, showing an exemplary array of magnets of an exemplary first magnet. Each magnet of the array of magnets shown has an ellipsoid shape.

FIG. 3B is a top view of an exemplary lower substrate of the two-layer microfluidic device illustrated in FIG. 1, showing an exemplary array of magnets of an exemplary first magnet. Each magnet of the array of magnets shown has an arrow shape.

FIG. 4 is a magnified top view of an exemplary inlet or outlet of the channel of the microfluidic device illustrated by FIG. 1A.

FIG. 5 is a magnified top view of exemplary chambers of the channel of the microfluidic device illustrated by FIG. 1A.

FIG. 6A is a magnified top view of an exemplary chamber of the channel and an exemplary magnet of the array of magnets of the first magnet of the microfluidic device illustrated in FIG. 1A. The exemplary magnet shown has an ellipsoid shape.

FIG. 6B is a magnified top view of an exemplary chamber of the channel and an exemplary magnet of the array of magnets of the first magnet of the microfluidic device illustrated in FIG. 1A. The exemplary magnet shown has an arrow shape.

FIG. 7 is a top, perspective view of an exemplary one-layer microfluidic device.

FIG. 8A is a top view of the one-layer microfluidic device illustrated in FIG. 7, showing an exemplary channel, second magnet, first magnet, fourth magnet, and third magnet. The directions of the poles of the second and third magnets in relation to one another are shown.

FIG. 8B is a magnified top view of an exemplary inlet or outlet of the channel of the microfluidic device illustrated by FIGS. 7 and 8A.

FIG. 9 is a magnified top view of exemplary chambers of the channel the microfluidic device illustrated by FIG. 7, along with a portion of an exemplary first magnet and a portion of an exemplary second magnet arranged on opposite sides of the channel.

FIG. 10 shows the distribution of captured magnetic particles in four chambers having different diameters. Each chamber shown is one exemplary chamber of a channel of a one-layer microfluidic device (such as the device illustrated by FIGS. 7 and 8A).

FIG. 11A is a perspective view of the assembled two-layer microfluidic device.

FIG. 11B is a representation of the simulated velocity magnitude of the fluid inside the microfluidic channel showing increasing fluid velocity toward the center of the channel.

FIG. 11C illustrates the magnetic force vector directions adjacent to the micromagnet, as applied to magnetic particles.

FIG. 11D is a perspective view showing the experimental setup of the capturing protocol using the microfluidic device. The dashed line shows a magnified view of magnetic nano/hybrid microgel-labeled breast cancer cells inside a chamber of the channel.

FIGS. 12A-12L show finite element simulations for optimization of the magnetic capturing strategy.

FIG. 12A is a schematic illustration of the magnetic capturing mechanism in the microfluidic channel.

FIG. 12B is a graphical simulation of the distribution of the drag force exerted on cells within straight channels and channels with chambers.

FIG. 12C is a graph depicting the ratio of the drag force in a chamber to the drag force in a straight channel (drag forces were obtained along the dashed line shown in FIG. 12B). The ratio at the tip of the micromagnet is 0.77, indicating a 23% decrease in the drag force by changing the channel geometry from straight to having chambers. The length of the micromagnet is shown by Lμm.

FIG. 12D is a graph separately depicting the drag force in a chamber and the drag force in a straight channel.

FIG. 12E is a graphical simulation of the magnetic flux density in the microchannel at z=H/2, where H is the channel height. A d-d cross section is shown in the lower panel.

FIG. 12F is a graphical simulation showing the distribution of the magnetic force exerted on the magnetic particles inside the channel at z=H/2. Arrows show the direction of the force, which is always toward the tips of the micromagnets (bottom corners of the microchannel).

FIG. 12G is a graph showing a quantitative comparison of the drag force, F_{D} (top graph), and magnetic force, F_{M} (bottom graph) in the regions of the channel indicated.

FIG. 12H is a particle tracing simulation demonstrating the capturing positions of the magnetic particles along the channel, with respect to the initial positions of the particles upon entering the channel. A typical particle at the indicated P position, around 60 μm far from the right bottom corner, can be captured in the 17^{th} well of the 24-chambered channel, and the magnetic particles initially located at the top-center cannot be captured. For all simulations, a flowrate of 2 μL/min was applied, 1.3 T permanent magnets were used, MnFe₂O₄ was used as the micromagnet material, and the micromagnets were ellipsoid in shape.

FIG. 12I is a particle tracing simulation demonstrating the capturing positions of the magnetic particles along the channel, with respect to the initial positions of the particles upon entering the channel. The micromagnets were arrow shaped. FIGS. 12H and 121 together show the effect of micromagnet geometry on capture efficiency. Using ellipsoidal micromagnets, efficiency was 92/110 (84%) with core flow and 48% without core flow. Using arrow-shaped micromagnets, efficiency was 87/110 (79%) with core flow and 44% without core flow.

FIG. 12J is a set of three graphs depicting the distribution of the magnetic flux density in a single chamber along the x, y, and z directions.

FIG. 12K illustrates the distribution of the drag force exerted on cells within straight channels (see comparisons in FIGS. 12B-12D).

FIG. 12L illustrates the distribution of the drag force exerted on cells within channels with chambers (see comparisons in FIGS. 12B-12D).

FIG. 13 is a set of three particle tracing simulations demonstrating the effect of different flow rates on the capturing position of the particles along the microchannel.

FIGS. 14A-14H show optimization of the capturing process using the two-layer microfluidic device fabricated with two different micromagnet materials.

FIG. 14A is a graph showing the microparticle capturing efficiency in the different zones under a flow rate of 0.5 μL/min and in the presence of side permanent magnets with Br=0.8 T.

FIG. 14B is a graph showing the microparticle capturing efficiency in the different zones under a flow rate of 2 μL/min and in the presence of side permanent magnets with Br=0.8 T.

FIG. 14C is a graph showing the microparticle capturing efficiency in the different zones under a flow rate of 5 μL/min and in the presence of side permanent magnets with Br=0.8 T.

FIG. 14D is a graph showing the magnetic particle capturing efficiency in the different zones under a flow rate of 0.5 μL/min and in the presence of side permanent magnets with Br=1.3 T.

FIG. 14E is a graph showing the magnetic particle capturing efficiency in the different zones under a flow rate of 2 μL/min and in the presence of side permanent magnets with Br=1.3 T.

FIG. 14F is a graph showing the magnetic particle capturing efficiency in the different zones under a flow rate of 5 μL/min and in the presence of side permanent magnets with Br=1.3 T.

FIG. 14G is a graph showing the total capture rate of the magnetic particles in the entire channel in the presence of permanent external magnets of 0.8 T.

FIG. 14H is a graph showing the total capture rate of the magnetic particles in the entire channel in the presence of permanent external magnets of 1.3 T.

FIG. 15 is a vibrating-sample magnetometer (VSM) plot of the MnFe₂O₄ and gama-Fe₂O₃ nanopowders, indicating the magnetization of the micromagnet materials in the presence of the external magnetic field.

FIGS. 16A-16H show optimization of the capturing process using the two-layer microfluidic device fabricated with two different micromagnet geometries and external magnetic field strengths.

FIG. 16A is a graph showing magnetic particle capturing efficiency in the different zones of the channel under a flow rate of 0.5 μL/min and in the presence of permanent external magnets of either 0.8 or 1.3 T, and arrow-shaped micromagnets.

FIG. 16B is a graph showing magnetic particle capturing efficiency in the different zones of the channel under a flow rate of 2 μL/min and in the presence of permanent external magnets of either 0.8 or 1.3 T, and arrow-shaped micromagnets.

FIG. 16C is a graph showing magnetic particle capturing efficiency in the different zones of the channel under a flow rate of 5 μL/min and in the presence of permanent external magnets of either 0.8 or 1.3 T, and arrow-shaped micromagnets.

FIG. 16D is a graph showing magnetic particle capturing efficiency in the different zones of the channel under a flow rate of 0.5 μL/min and in the presence of permanent external magnets of either 0.8 or 1.3 T, and ellipsoid micromagnets.

FIG. 16E is a graph showing magnetic particle capturing efficiency in the different zones of the channel under a flow rate of 2 μL/min and in the presence of permanent external magnets of either 0.8 or 1.3 T, and ellipsoid micromagnets.

FIG. 16F is a graph showing magnetic particle capturing efficiency in the different zones of the channel under a flow rate of 5 μL/min and in the presence of permanent external magnets of either 0.8 or 1.3 T, and ellipsoid micromagnets.

FIG. 16G is a graph showing the total capture rate of the magnetic particles in the entire channel in the presence of permanent external magnets of either 0.8 or 1.3 T, and arrow-shaped micromagnets.

FIG. 16H is a graph showing the total capture rate of the magnetic particles in the entire channel in the presence of permanent external magnets of either 0.8 or 1.3 T, and ellipsoid micromagnets.

FIGS. 17A-17B show the effects of micromagnet geometry at a fixed flow rate (2 μL/min) and in the presence of non-magnetic particles on the capture rate of magnetic particles in a 1 mL solution.

FIG. 17A is a graph showing the magnetic particle capture rate in all zones of the channel separately for a device having ellipsoid or arrow-shaped micromagnets.

FIG. 17B is a graph showing the magnetic particle capture rate for the entire channel of 40 chambers for a device having ellipsoid or arrow-shaped micromagnets.

FIG. 18A is an optical microscope image showing the fluid flow (core and sheath flow) in the channel.

FIG. 18B is phase contrast and fluorescent microscope images of magnetic nano/hybrid microgel-labeled MCF-7 cells and non-labeled Jurkat cells.

FIG. 18C is a phase contrast and fluorescent microscope image (merged) showing the location of the target cells after capture at the tip of the micromagnets in a chamber.

FIG. 18D is a phase contrast and fluorescent microscope image (merged) of the accumulation of MCF-7 breast cancer cells after capturing and before their release from the chamber.

FIG. 18E is a phase contrast and fluorescent microscope image (merged) of the accumulation of MCF-7 breast cancer cells after capturing and after their release from the chamber (following removal of the magnetic field).

FIG. 18F is a 2.5-dimensional fluorescent image of captured cell distribution at the tip of an ellipsoidal micromagnet in the middle of the channel (the 20^{th} chamber) at a flow rate of 0.5 μL/min.

FIG. 18G is a 2.5-dimensional fluorescent image of captured cell distribution at the tip of an ellipsoidal micromagnet in the middle of the channel (the 20^{th} chamber) at a flow rate of 2 μL/min.

FIG. 18H is a 2.5-dimensional fluorescent image of captured cell distribution at the tip of an ellipsoidal micromagnet in the middle of the channel (the 20^{th} chamber) at a flow rate of 5 μL/min.

FIG. 18I is a 2.5-dimensional fluorescent image of captured cell distribution at the tip of an arrow-shaped micromagnet in the middle of the channel (the 20^{th} chamber) at a flow rate of 0.5 μL/min.

FIG. 18J is a 2.5-dimensional fluorescent image of captured cell distribution at the tip of an arrow-shaped micromagnet in the middle of the channel (the 20^{th} chamber) at a flow rate of 2 μL/min.

FIG. 18K is a 2.5-dimensional fluorescent image of captured cell distribution at the tip of an arrow-shaped micromagnet in the middle of the channel (the 20^{th} chamber) at a flow rate of 5 μL/min.

FIG. 18L is a chart showing the cell capture rate in all zones of the channel separately for a device having ellipsoid micromagnets.

FIG. 18M is a chart showing the cell capture rate for the entire channel of 40 chambers for a device having arrow-shaped micromagnets.

FIG. 19A is a graph showing FTIR spectra of the i) microgels without incorporated magnetic particles and ii) the magnetic nano/hybrid microgels.

FIG. 19B is a VSM plot of the synthesized magnetic nano/hybrid microgel compared to the pure Fe3O4 nanoparticles, indicating a decrease in the iron oxide magnetization following incorporation into the microgel and magnetic nano/hybrid microgel formation.

FIG. 19C is an SEM image of the poly(N-isopropylacrylamide-co-acrylic acid) (PNIPAM-AA) microgels.

FIG. 19D is an SEM image of the magnetic nano/hybrid microgels.

FIG. 19E is a graph of a dynamic light scattering (DLS) analysis showing the hydrodynamic diameter of the PNIPAM-AA and magnetic nano/hybrid microgels over different temperatures.

FIG. 20A is a fluorescent microscopy image of the effect of a uniform magnetic field without micromagnets on the MCF-7 cell capture position.

FIG. 20B is a is a phase contrast and fluorescent microscope image (merged) of the effect of a uniform magnetic field without micromagnets on the MCF-7 cell capture position.

FIG. 20C is a fluorescent microscopy image of the effect of a uniform magnetic field without micromagnets on the MCF-7+Jurkat cells capture position.

FIG. 20D is a is a phase contrast and fluorescent microscope image (merged) of the effect of a uniform magnetic field without micromagnets on the MCF-7+Jurkat cells capture position.

FIG. 20E is a chart comparing the effect of the presence versus absence of the micromagnets on the capture rate of the target cells and the mixture of the target and non-target cells along the entire channel.

FIG. 21A is a chart showing cell capture rate optimization of the magnetic microfluidic device in the presence of target MCF-7 cells or a mixture of target MCF-7 and non-target Jurkat cells.

FIG. 21B is a graph showing the capture rates of different numbers of MCF-7 cells in 1 mL DMEM media containing 6×10⁶ Jurkat cells.

FIG. 21C is a bright field microscopy image showing target and non-target cell locations in response to a localized micromagnet field. Scale bar is 100 μm.

FIG. 21D is a fluorescent microscopy image showing target and non-target cell locations in response to a localized micromagnet field.

FIG. 21E is a bright field and fluorescent microscopy image (merge of FIGS. 21C and 21D) showing target and non-target cell locations in response to a localized micromagnet field. A upper arrow and a lower arrow show Jurkat and MCF-7 cells, respectively.

FIG. 21F is a fluorescent microscopy image showing a population of non-target Jurkat cells in the outlet of the microfluidics device after capturing. Scale bar is 100 μm.

FIG. 21G is a fluorescent microscopy image showing a population of target MCF-7 cells in the outlet of the microfluidics device after capturing.

FIG. 21H is a bright field and fluorescent microscopy image (merge of FIGS. 21F and 21G) showing target MCF-7 and non-target Jurkat cells in the outlet of the microfluidics device after capturing. Most of the cell populations in the outlet contained Jurkat cells with the purity of 87%.

FIG. 22A is a schematic diagram illustrating an exemplary use of the smart, thermoresponsive, magnetic nano/hybrid microgels in the disclosed devices, including antibody conjugation, dye loading, cell binding, cell capturing, and in-situ cell staining in response to temperature.

FIG. 22B is a microscopy image showing single cell captured inside a microfluidic channel chamber.

FIG. 22C is a set of three graphs showing the increased fluorescence intensity of the magnetic nano/hybrid microgels (loaded with the AgNC dye), indicating the thermo-responsive behavior of the magnetic nano/hybrid microgels over time at 37.5° C.

FIG. 22D is a fluorescent microscopy image showing a single cell (arrow) captured in the microfluidic device in the presence of AgNC-loaded magnetic nano/hybrid microgels.

FIG. 22E is a graph showing the fluorescence intensity of a single cell captured in the microfluidic device in the presence of AgNC-loaded magnetic nano/hybrid microgels at 25° C.

FIG. 22F is a graph showing the fluorescence intensity of a single cell captured in the microfluidic device in the presence of AgNC-loaded magnetic nano/hybrid microgels at 37.5° C.

FIG. 23 is a bright field and fluorescent microscopy image (merged) showing the washing step after in-situ/on-chip staining of captured cells and persistence of florescence emissions from the cells, indicating the infiltration of the polymer dot-based dyes into the cell cytosol.

### DETAILED DESCRIPTION

### Explanation of Terms

For purposes of this description, certain aspects, advantages, and novel features of the embodiments of this disclosure are described herein. The disclosed device, methods, and kits should not be construed as being limiting in any way. Instead, the present disclosure is directed toward all novel and nonobvious features and aspects of the various disclosed embodiments, alone and in various combinations and sub-combinations with one another. The device, methods, and kits are not limited to any specific aspect or feature or combination thereof, nor do the disclosed embodiments require that any one or more specific advantages be present or problems be solved. It should be understood that the disclosed embodiments can be adapted for identification, manipulation, and/or isolation of any biomarker from any suitable sample fluid.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “introduce,” “flow,” or “provide” to describe the disclosed methods. These terms are high-level abstractions of the actual operations that are performed. The actual operations that correspond to these terms may vary depending on the particular implementation and are readily discernible by one of ordinary skill in the art.

Unless otherwise noted, technical terms are used according to conventional usage. Definitions of common terms in molecular biology can be found in Krebs et al. (Eds.), Lewin's Genes XII, published by Jones & Bartlett Publishers, 2017; and Meyers et al. (Eds.), The Encyclopedia of Cell Biology and Molecular Medicine, published by Wiley-VCH in 16 volumes, 2008; and other similar references. Although biological methods and materials similar or equivalent to those described herein can be used in the practice or testing of the present disclosure, suitable methods and materials are described below.

As used in this application and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language. As used herein, the term “and/or” used between the last two of a list of elements means any one or more of the listed elements. For example, the phrase “A, B, and/or C” means “A”, “B,”, “C”, “A and B”, “A and C”, “B and C”, or “A, B, and C.”

Although there are alternatives for various components, features, parameters, operating conditions, etc., of embodiments of the device set forth herein, that does not mean that those alternatives are necessarily equivalent and/or perform equally well. Nor does it mean that the alternatives are listed in a preferred order unless stated otherwise.

Directions and other relative references (e.g., inner, outer, upper, lower, etc.) may be used to facilitate discussion of the drawings and principles herein, but are not intended to be limiting. For example, certain terms may be used such as “inside,” “outside,”, “top,” “down,” “interior,” “exterior,” and the like.

Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part and the object remains the same.

To facilitate review of the various embodiments of this disclosure, the following explanations of specific terms are provided.

Axis, longitudinal axis: The term “axis” or “longitudinal axis” refer to an axis extending in the upstream and downstream directions, or in the proximal and distal directions, unless otherwise expressly defined.

Administer, Administering, Administration: As used herein, administering a therapeutic agent (e.g., an anti-cancer, antibiotic, and/or immunotherapeutic agent) to a subject means to apply, give, or bring the agent into contact with the subject, by any effective route. Administration can be accomplished by a variety of routes, such as, for example, parenterally (such as intravenous administration), intramuscularly, topically, orally, or mucosally; however, other routes of administration can be utilized. Appropriate routes of administration can be determined based on factors such as the subject, the condition or disease being treated, and other factors.

Agent, Therapeutic Agent: A therapeutic agent includes treating agents, prophylactic agents, and replacement agents. A therapeutic agent may thus be any substance or any combination of substances that is useful for achieving an end or result, such as ameliorating one or more condition or disease (such as a cancer, an infectious disease, and/or an immune condition) in a subject, for example, a substance or combination of substances (such as in a combination therapy for cancer treatment) useful for inhibiting cancer growth or metastasis in a subject. Agents include proteins, nucleic acid molecules, compounds, small molecules, organic compounds, inorganic compounds, or other molecules of interest.

Antibody: A polypeptide ligand (such as an immunoglobulin, antigen-binding fragment, or derivative thereof) comprising at least one variable region that recognizes and binds (such as specifically recognizes and specifically binds) an epitope of an antigen. The term “antibody” is used herein in the broadest sense and encompasses various antibody structures, including but not limited to monoclonal antibodies, polyclonal antibodies, multispecific antibodies (e.g., bispecific antibodies), and antigen binding fragments, so long as they exhibit the desired antigen-binding (e.g., biomarker-binding) activity. Antibodies are characterized by reacting specifically with the antigen in some demonstrable way.

Non-limiting examples of antibodies include, for example, intact immunoglobulins and variants and antigen binding fragments thereof that retain binding affinity for the antigen. Examples of antigen binding fragments include but are not limited to Fv, Fab, dsFv. Fab′, Fab′-SH, F(ab′)₂; diabodies; linear antibodies; single-chain antibody molecules (e.g., scFv and ds-scFv); and multispecific antibodies formed from antibody fragments. Antibody fragments include antigen binding fragments either produced by the modification of whole antibodies or those synthesized de novo using recombinant DNA methodologies (see, e.g., Kontermann and Dubel (Eds.), Antibody Engineering, Vols. 1-2, 2^{nd} ed., Springer-Verlag, 2010).

Antibodies also include genetically engineered forms such as chimeric antibodies (such as humanized murine antibodies) and heteroconjugate antibodies (such as bispecific antibodies). Antibodies also include defucosylated forms of disclosed antibodies.

An antibody may have one or more binding sites. If there is more than one binding site, the binding sites may be identical to one another or may be different. For instance, a naturally occurring immunoglobulin has two identical binding sites, a single-chain antibody or Fab fragment has one binding site, while a bispecific or bifunctional antibody has two different binding sites.

Mammalian immunoglobulin molecules are composed of a heavy (H) chain and a light (L) chain, each of which has a variable region, termed the variable heavy (V_{H}) region and the variable light (V_{L}) region, respectively. Together, the V_{H} region and the V_{L} region are responsible for binding the antigen recognized by the antibody. There are five main heavy chain classes (or isotypes) of mammalian immunoglobulin, which determine the functional activity of an antibody molecule: IgM, IgD, IgG, IgA and IgE. Antibody isotypes not found in mammals include IgX, IgY, IgW and IgNAR. IgY is the primary antibody produced by birds and reptiles, and has some functionally similar to mammalian IgG and IgE. IgW and IgNAR antibodies are produced by cartilaginous fish, while IgX antibodies are found in amphibians

Antibody variable regions contain “framework” regions and hypervariable regions, known as “complementarity determining regions” or “CDRs.” The CDRs are primarily responsible for binding to an epitope of an antigen. The framework regions of an antibody serve to position and align the CDRs in three-dimensional space. The amino acid sequence boundaries of a given CDR can be readily determined using any of a number of well-known numbering schemes, including those described by Kabat et al. (Sequences of Proteins of Immunological Interest, U.S. Department of Health and Human Services, 1991; the “Kabat” numbering scheme), Chothia et al. (see Chothia and Lesk, J Mol Biol 196:901-917, 1987; Chothia et al., Nature 342:877, 1989; and Al-Lazikani et al., (JMB 273,927-948, 1997; the “Chothia” numbering scheme), and the ImMunoGeneTics (IMGT) database (see, Lefranc, Nucleic Acids Res 29:207-9, 2001; the “IMGT” numbering scheme). The Kabat and IMGT databases are maintained online.

A “monoclonal antibody” is an antibody produced by a single clone of lymphocytes or by a cell into which the coding sequence of a single antibody has been transfected. Monoclonal antibodies include humanized monoclonal antibodies.

Aptamer: Oligonucleotide (such as DNA or RNA) or peptide molecules that bind to a specific target molecule, such as a target protein. Target recognition and target-aptamer binding can involve three-dimensional, shape-dependent interactions as well as hydrophobic interactions, base-stacking, and intercalation. In some embodiments, an aptamer is a ligand and can be conjugated to a magnetic nanoparticle to bind a target molecule, such as a biomarker, such as a biomarker in a sample from a subject.

Biomarker: A detectable and/or measurable indicator of a biological state or condition. For example, a biomarker can be detected and/or measured (such as quantified) in a sample (such as a sample from a subject) to examine normal biological processes, pathogenic processes, and/or a response to a treatment for a disease or condition. A biomarker can be any suitable molecule, such as a cell, nucleotide or modified nucleotide, nucleic acid (such as a DNA or RNA), peptide or protein, lipid, glycolipid, polysaccharide, extracellular vesicle (such as an exosome), metabolite, or any other detectable and/or measurable biological molecule that can indicate a biological state or condition. In some embodiments, a biomarker can be used to diagnose a condition or disease in a subject, predict a risk of occurrence of a condition or disease in a subject, predict a survival outcome in a subject that has a condition or disease, determine recurrence of a condition or disease in a subject, predict or determine metastasis of a cancer in a subject, and/or predict or assess a subject's current or future response to a treatment. In some examples, a biomarker is a cell, such as a circulating tumor cell. In some examples, the biomarker is a molecule, such as a protein, expressed on the surface of a cell, such as a circulating tumor cell.

Biotin, biotin-binding proteins: Biotin, also known as B-vitamin B7 (formerly vitamin H and coenzyme R), is a small (244.3 Daltons), naturally occurring, water soluble molecule comprised of an ureido ring joined with a tetrahydrothiophene ring. Biotin can be conjugated to a molecule of interest (such as a protein) without significantly altering the biological activity of the molecule of interest. The highly specific interaction of biotin-binding proteins (such as avidin, streptavidin, or neutravidin) with biotin makes it a useful tool in assay systems designed to detect and target biological analytes, such as biomarkers. Once biotin is conjugated to a molecule, the biotin tag can be used to facilitate association (such as binding) of that molecule to a biotin-binding protein. In some examples, one or more biotin or biotin-binding molecules is conjugated to the surface of a magnetic particle described herein, and is used to detect and facilitate capture of a molecule comprising a biotin-binding molecule (such as avidin, streptavidin, or neutravidin) or a biotin molecule, respectively. If a specific biotinylated molecule is not available, commercially available reagents are available to facilitate biotinylation. Avidin, streptavidin, and neutravidin can also be modified as needed.

Cancer: Also referred to as a “malignant tumor” or “malignant neoplasm,” cancer refers to any of a number of diseases characterized by uncontrolled, abnormal proliferation of cells. Cancer cells have the potential to spread locally or through the bloodstream and lymphatic system to other parts of the body (e.g., metastasize) with any of a number of characteristic structural and/or molecular features. A “cancer cell” is a cell having specific structural properties, lacking differentiation, and being capable of invasion and metastasis. Indolent and high-grade forms are included. The “cancer burden” in a subject can be measured in some examples as the number, volume, and/or weight of one or more tumors. A tumor that does not metastasize is referred to as “benign.” A tumor that invades the surrounding tissue and/or can metastasize is a cancer (and is referred to as “malignant”).

Chemotherapeutic agent: Any chemical or biological agent with therapeutic usefulness (e.g., a therapeutic agent) in the treatment of diseases characterized by abnormal cell growth. For example, chemotherapeutic agents can be useful for the treatment of a solid cancer, such as a sarcoma, carcinoma, lymphoma, colorectal, or skin cancer. Particular examples of chemotherapeutic agents that can be used in the disclosed embodiments include microtubule ligands, DNA intercalators or cross-linkers, DNA synthesis inhibitors, DNA and RNA transcription inhibitors, antibodies, enzymes, enzyme inhibitors, gene regulators, and angiogenesis inhibitors. In some embodiments, a chemotherapeutic agent is a radioactive compound. Other chemotherapeutic agents that can be used are provided in Sausville and Longo, Principles of Cancer Treatment, Chapter 69 in Harrison's Principles of Internal Medicine (20^{th} ed.), McGraw-Hill, 2018; Niederhuber et al., Cancer Pharmacology, Ch. 25 in Abeloff's Clinical Oncology (6^{th} ed.), Elsevier, 2019; Gullatte et al., Clinical Guide to Antineoplastic Therapy: A Chemotherapy Handbook (4^{th} ed.), Oncology Nursing Society, 2020; Chabner and Longo, Cancer Chemotherapy, Immunotherapy and Biotherapy: Principles and Practice (6^{th} ed.), Lippincott Williams & Wilkins, 2018; Skeel, Handbook of Cancer Chemotherapy (9^{th} ed.), Lippincott Williams & Wilkins, 2016. Combination chemotherapy is the administration of more than one chemotherapeutic agent to treat cancer.

Circulating tumor cell: A circulating tumor cell (CTC) is a cell that has entered into the vasculature or lymphatics from a primary cancer (such as a primary tumor) and is carried in the blood circulation. CTCs can extravasate and become seeds for the subsequent growth of additional tumors (metastases) in distant organs.

Control: A sample or standard used for comparison with an experimental sample. In some embodiments, the control is a sample obtained from a healthy subject (such as a subject without a cancer, a subject without an infectious disease, or a subject without an immune condition) or a non-tumor tissue or tumor tissue sample obtained from a patient diagnosed with cancer. In some embodiments, the control is a historical control or standard reference value or range of values (such as a previously tested control sample, such as a group of cancer patients with poor prognosis, or group of samples that represent baseline or normal values). In some examples, a control is a positive control, such as a biomarker indicative of a condition or disease. In some embodiments, a positive control is a cell (such as a CTC), nucleotide or modified nucleotide, nucleic acid (such as a DNA or RNA), peptide or protein, lipid, glycolipid, polysaccharide, extracellular vesicle (such as an exosome), metabolite, or other molecule indicative of a condition or disease. As used herein, a “normal” control is a sample or standard from or based on a subject without the condition or disease, such as a subject without a cancer or non-cancerous tissue from a subject.

Detect: To identify the existence, presence, or fact of something. Detecting as used herein includes detecting of a biomarker (such as a cell (such as a CTC), nucleotide or modified nucleotide, nucleic acid (such as a DNA or RNA), peptide or protein, lipid, glycolipid, polysaccharide, extracellular vesicle (such as an exosome), or metabolite) is present or absent, such as in a sample from a subject. In some examples, detection can include further quantification of the biomarker.

Diagnosis: The process of identifying a disease by its signs, symptoms and results of various tests. The conclusion reached through that process is also called “a diagnosis.” Forms of testing commonly performed include tests of human body fluid samples (such as blood tests), medical imaging, and biopsy.

Immune condition: A disorder or disease, such as an autoimmune disorder or disease, in which the immune system produces an immune response (e.g., a B cell or a T cell response) against an endogenous antigen, with consequent injury to tissues. The injury may be localized to certain organs, such as thyroiditis, or may involve a particular tissue at different locations, such as Goodpasture's disease, or may be systemic, such as lupus erythematosus.

In some examples, autoimmune diseases include systemic lupus erythematosus, Sjogren's syndrome, rheumatoid arthritis, type I diabetes mellitus, Wegener's granulomatosis, inflammatory bowel disease, polymyositis, dermatomyositis, multiple endocrine failure, Schmidt's syndrome, autoimmune uveitis, Addison's disease, adrenalitis, Graves' disease, thyroiditis, Hashimoto's thyroiditis, autoimmune thyroid disease, pernicious anemia, gastric atrophy, chronic hepatitis, lupoid hepatitis, atherosclerosis, presenile dementia, demyelinating diseases, multiple sclerosis, subacute cutaneous lupus erythematosus, hypoparathyroidism, Dressler's syndrome, myasthenia gravis, autoimmune thrombocytopenia, idiopathic thrombocytopenic purpura, hemolytic anemia, pemphigus vulgaris, pemphigus, dermatitis herpetiformis, alopecia arcata, pemphigoid, scleroderma, progressive systemic sclerosis, CREST syndrome (calcinosis, Raynaud's phenomenon, esophageal dysmotility, sclerodactyly, and telangiectasia), adult onset diabetes mellitus (Type II diabetes), male and female autoimmune infertility, ankylosing spondylitis, ulcerative colitis, Crohn's disease, mixed connective tissue disease, polyarteritis nedosa, systemic necrotizing vasculitis, juvenile onset rheumatoid arthritis, glomerulonephritis, atopic dermatitis, atopic rhinitis, Goodpasture's syndrome, Chagas' disease, sarcoidosis, rheumatic fever, asthma, recurrent abortion, anti-phospholipid syndrome, farmer's lung, erythema multiforme, post cardiotomy syndrome, Cushing's syndrome, autoimmune chronic active hepatitis, bird-fancier's lung, allergic disease, allergic encephalomyelitis, toxic epidermal necrolysis, alopecia, Alport's syndrome, alveolitis, allergic alveolitis, fibrosing alveolitis, interstitial lung disease, erythema nodosum, pyoderma gangrenosum, transfusion reaction, leprosy, malaria, leishmaniasis, trypanosomiasis, Takayasu's arteritis, polymyalgia rheumatica, temporal arteritis, schistosomiasis, giant cell arteritis, ascariasis, aspergillosis, Sampter's syndrome, eczema, lymphomatoid granulomatosis, Behcet's disease, Caplan's syndrome, Kawasaki's disease, dengue, encephalomyelitis, endocarditis, endomyocardial fibrosis, endophthalmitis, erythema elevatum et diutinum, psoriasis, erythroblastosis fetalis, eosinophilic faciitis, Shulman's syndrome, Felty's syndrome, filariasis, cyclitis, chronic cyclitis, heterochronic cyclitis, Fuch's cyclitis, IgA nephropathy, Henoch-Schonlein purpura, glomerulonephritis, graft versus host disease, transplantation rejection, human immunodeficiency virus infection, echovirus infection, cardiomyopathy, Alzheimer's disease, parvovirus infection, rubella virus infection, post vaccination syndromes, congenital rubella infection, Hodgkin's and Non-Hodgkin's lymphoma, renal cell carcinoma, multiple myeloma, Eaton-Lambert syndrome, relapsing polychondritis, malignant melanoma, cryoglobulinemia, Waldenstrom's macroglobulemia, Epstein-Barr virus infection, rubulavirus, and Evan's syndrome.

Infectious disease: Also known as transmissible disease or communicable disease, infectious diseases are illnesses resulting from an infection. Infections are caused by infectious agents, including viruses, viroids, prions, bacteria; nematodes, such as parasitic roundworms and pinworms; arthropods, such as ticks, mites, fleas, and lice; fungi, such as ringworm; and other macroparasites, such as tapeworms and other helminths. Hosts fight infections using the immune system, such as the innate response (e.g., in mammals), which involves inflammation, followed by an adaptive response. Medications used to treat infections include antibiotics, antivirals, antifungals, antiprotozoals, and antihelminthics. Specific, non-limiting examples of infectious diseases include human immunodeficiency syndrome (HIV), human papillomavirus (HPV), hepatitis B virus (HBV), hepatitis C virus (HVC), tuberculosis (TB), and malaria.

Isolated: An “isolated” or “purified” biological component (such as a biomarker, such as a cell (such as a CTC), nucleotide or modified nucleotide, nucleic acid (such as a DNA or RNA), peptide or protein, lipid, glycolipid, polysaccharide, extracellular vesicle (such as an exosome), or metabolite) has been substantially separated, produced apart from, or purified away from other components (for example, other biological components in the cell or environment in which the component naturally occurs). Cells, nucleic acids, peptides and proteins, and other components (such as from a sample from a subject) that have been “isolated” or “purified” thus include cells, nucleic acids, proteins, exosomes purified by standard purification methods.

The term “isolated” or “purified” does not require absolute purity; rather, it is intended as a relative term. Thus, for example, an isolated biological component is one in which the biological component is more enriched than the biological component is in its natural environment within a cell, organism, sample, or production vessel (for example, a cell culture system). Preferably, a preparation is purified such that the biological component represents at least 50%, such as at least 70%, at least 80%, at least 90%, at least 95%, or greater, of the total biological component content of the preparation.

Ligand: A molecule that binds to another molecule. Such binding can be covalent or noncovalent (such as electrostatic). Exemplary ligands include antibodies, aptamers, biotin, avidin, streptavidin, neutravidin, and similar.

Prognosis: A prediction of the future course of a disease, such as a cancer. The prediction can include determining the likelihood of a subject with BE to develop EAC, or to survive a particular amount of time (e.g., determining the likelihood that a subject will survive 1, 2, 3 or 5 years), to respond to a particular therapy (e.g., chemotherapy, EMR, ESD, esophageal surgery, cryoablation, or radiofrequency ablation), or combinations thereof.

Sample or biological sample: A sample of biological material obtained from a subject, which can include cells, proteins, and/or nucleic acid molecules (such as DNA and/or RNA, such as mRNA). Biological samples include all clinical samples useful for detection of a condition or disease (such as a cancer, infectious disease, or immune condition) in subjects. Appropriate samples include any conventional biological samples, including clinical samples obtained from a human or veterinary subject. Exemplary samples include, without limitation, cancer samples (such as from surgery, tissue biopsy, tissue sections, or autopsy), cells, cell lysates, blood smears, cytocentrifuge preparations, cytology smears, bodily fluids (e.g., blood, plasma, serum, stool/feces, saliva, sputum, urine, bronchoalveolar lavage, semen, cerebrospinal fluid (CSF), breast milk, etc.), or fine-needle aspirates. Samples may be used directly from a subject or may be processed before analysis (such as concentrated, diluted, purified, such as isolation and/or amplification of cells, nucleic acid molecules, proteins, or other components in the sample).

Subject: Living multi-cellular vertebrate organisms, a category that includes human and non-human mammals, such as mammals and non-mammals, such as non-human primates, mice, rabbits, sheep, dogs, cats, horses, cows, chickens, amphibians, and reptiles. In an example, a subject is a human. In a particular example, the subject has, or is at risk of having, a cancer. In an additional example, a subject is selected that is in need of inhibiting of growth of a cancer or metastasis. For example, the subject has been diagnosed with a cancer and is in need of treatment.

Treating or inhibiting a disorder: “Inhibiting” a disease or condition refers to inhibiting the full development of a disease or condition, for example, a cancer (e.g., a tumor or hematological malignancy), infectious disease, and/or immune condition. Inhibition of a disease or condition can span the spectrum from partial inhibition to substantially complete inhibition (e.g., including, but not limited to prevention) of a disease or condition (such as a cancer, infection, or immune disease). In some examples, the term “inhibiting” refers to reducing or delaying the onset or progression of a disease or condition. “Treatment” refers to a therapeutic intervention that ameliorates a sign or symptom of a disease or condition after it has begun to develop. The term “ameliorating,” with reference to a disease or condition, refers to any observable beneficial effect of the treatment. The beneficial effect can be evidenced, for example, by a delayed onset of clinical symptoms of the disease or condition in a susceptible subject, a reduction in severity of some or all clinical symptoms of the disease or condition, a slower progression of the disease or condition, an improvement in the overall health or well-being of the subject, or by other parameters well known in the art that are specific to the particular disease or condition, such as improved survival of a subject having a cancer. Treatment may be assessed by objective or subjective parameters including, but not limited to, the results of a physical examination, imaging, or a blood test. A “prophylactic” treatment is a treatment administered to a subject who does not exhibit signs of a disease or condition or exhibits only early signs for the purpose of decreasing the risk of developing pathology, such as to prevent the occurrence or recurrence of a cancer.

### OVERVIEW OF SEVERAL EMBODIMENTS

The following representative embodiments are provided to illustrate particular features of certain embodiments, but the scope of the claims should not be limited to those features exemplified.

### Microfluidic Device

The present disclosure pertains to a microfluidic device for capture, detection, and/or isolation of biomarkers from a sample liquid introduced to the device. A device disclosed herein includes a channel with alternatingly widening and narrowing (converging and diverging) portions, and a plurality of magnets arranged next to the channel, and/or arrayed around the channel along various axes. The channel can extend between one or a plurality of inlets and one or a plurality of outlets. In some embodiments, the plurality of magnets can include a first magnet array positioned beneath the channel and spaced apart along its length, a second magnet positioned on one side of the channel, and a third magnet positioned on a side of the channel opposite the second magnet. In other embodiments, the plurality of magnets can include a first magnet array and a second magnet array positioned on opposite sides of the channel and spaced apart along its length, a magnet positioned on the same side of the channel as the first magnet array, and a magnet positioned on the same side of the channel as the second magnet array. The plurality of magnets can be arranged to apply a magnetic field across the channel to capture magnetic particles in diverging portions of the channel where a velocity of a liquid in the channel is reduced.

### First Representative Embodiment

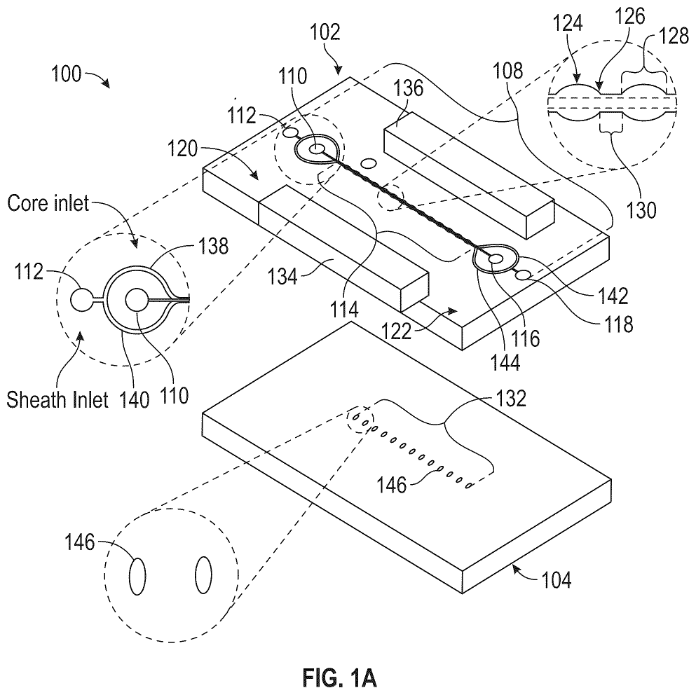

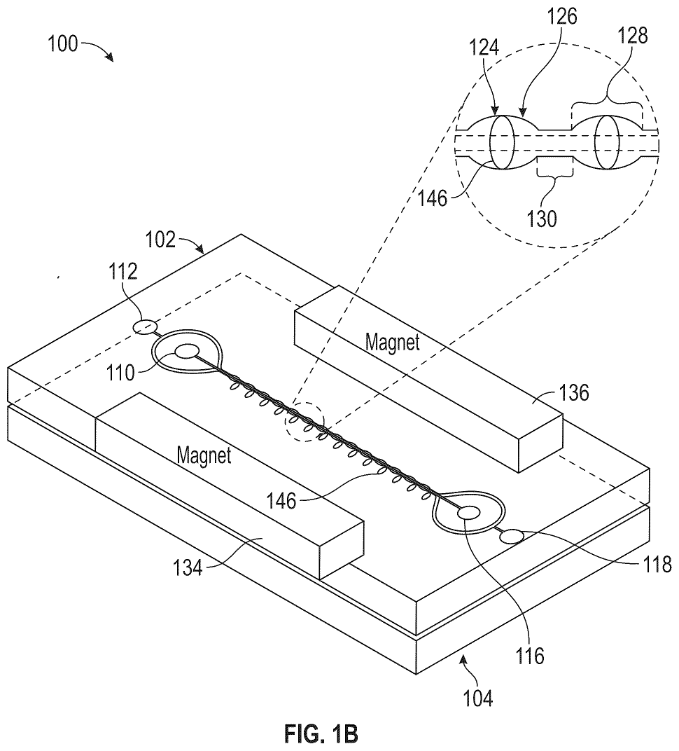

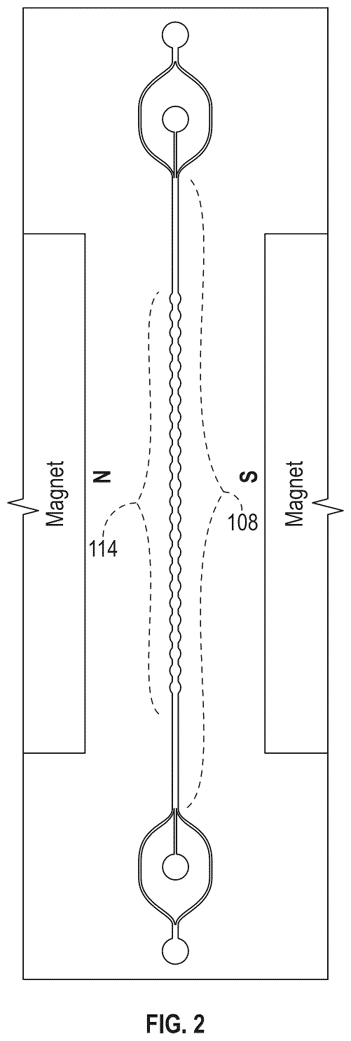

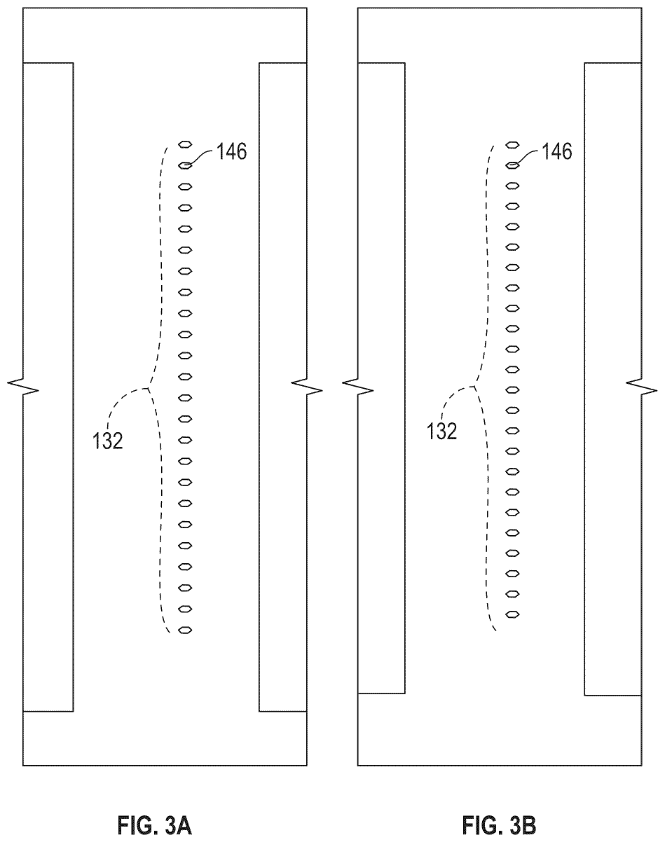

Referring to FIGS. 1A, 1B, 2, 3A, 3B, 4, 5, 6A, and 6B, in one exemplary embodiment, a microfluidic device 100 can comprise one or a plurality of substrates 102. For example, the microfluidic device 100 (FIGS. 1A, 1B, and 2) can comprise a first substrate 102 and a second substrate 104 in a stacked arrangement. In some embodiments, the first substrate and the second substrate comprises one or more polymers, such as, but not limited to, a plastic, such as a thermoplastic (such as poly(methyl methacrylate) (PMMA), polyester, or polycarbonate); polydimethylsiloxane (PDMS); poly(ethylene glycol) diacrylate (PEGDA); cyclic olefin copolymer (COP); cyclic olefin polymer (COP); or any combination thereof. In a particular embodiment, the first and second substrates are fabricated using PDMS. The first and second substrates, and features of the first and/or second substrate (such as a channel, cavity, well, reservoir, chamber, or any combination thereof), can be fabricated using any suitable method, such as, but not limited to, casting, stamping, rolling, laminating, soft-lithography, replica molding, 3D printing (additive manufacturing), injection molding, micromilling (micromachining), etching, hot embossing, or any combination thereof.

The first substrate can define a channel 108 extending along a longitudinal axis in a direction of a flow. The channel 108 can comprise one or a plurality of inlets, and one or a plurality of outlets. The channel can comprise the same number of outlets as compared to inlets, or a different number of outlets as compared to inlets. In certain embodiments, the channel 108 comprises a first inlet 110, a second inlet 112, a main portion 114, a first outlet 116, and a second outlet 118. In some embodiments, the channel extends along a longitudinal axis (e.g., in a direction of flow) from a region of a first end of the first substrate 120 to a region of a second end of the first substrate 122. In such embodiments, the first inlet 110 and the second inlet 112 are arranged in the region of the first end of the first substrate 120, and the first outlet 116 and the second outlet 118 are arranged in the region of the second end of the first substrate 122. In some embodiments, the microfluidic device 100 is reversible, such that a first inlet 110 can alternatively or at another time be a first outlet 116 and a second inlet 112 can alternatively or at another time be a second outlet 118. Such a design can facilitate flowing a first and/or a second liquid through the channel 108 of the device 100 in a first direction of flow, and, at another time or times, the same or different first and/or second liquids through the channel 108 of the device 100 in a second direction of flow that is opposite the first direction of flow.

In certain embodiments, the main portion of the channel 114 between the first 110 and second inlets 112 and the first 116 and second outlets 118 alternatingly widens, such as at one or more diverging portions 124, and narrows, such as at one or more converging portions 126, to define a plurality of chambers 128. In some embodiments, a chamber is a portion of the channel wherein the walls of the channel diverge in the direction of flow (i.e., along a longitudinal axis) to a widest portion, and subsequently converge from the widest portion to a narrowest portion. The channel 108 can thus comprise the plurality of chambers 128 extending along the longitudinal axis, between the first 110 and second inlets 112 and the first 116 and second outlets 118.

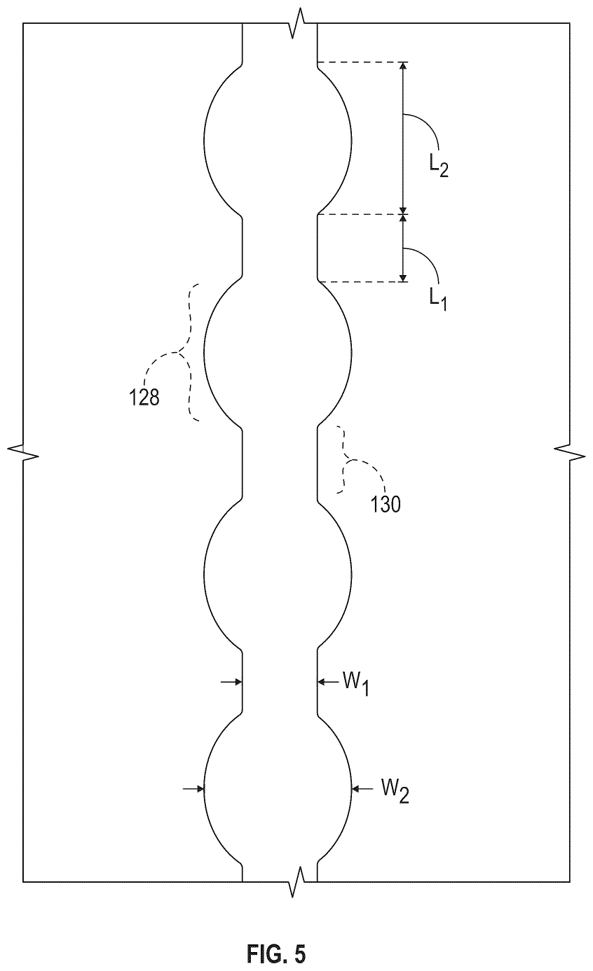

With reference to FIG. 5, in some examples of the disclosed microchannel device 100, the chambers 128 are spaced apart along all or part of the length of the main portion 114 of the channel along the longitudinal axis. Thus, the channel can comprise relatively narrow connecting portions 130 that have a width W₁ less than a maximum width W₂ of the chambers 128. Such connecting portions 130 between chambers 128 can be, for example, 10 to 500 μm in width (such as in diameter), such as 10-250 μm, 10-150 μm, 10-100 μm, 50-150 μm, 125-375 μm, or 250-500 μm in width, where the width W₁ is perpendicular to the longitudinal axis (e.g., perpendicular to the direction of flow). In some embodiments, the connecting portions 130 between the chambers 128 are 10-50 μm, 50-100 μm, 100-150 μm, 150-200 μm, 200-250 μm, 250-300 μm, 300-350 μm, 350-400 μm, 400-450 μm, or 450-500 μm in width. In specific, non-limiting embodiments, a connecting portion 130 between chambers 128 is 80 micrometers in diameter. In some embodiments, the length L₁ of a connecting portion 130 (e.g., a distance between one chamber and a subsequent chamber) is 50 micrometers to 5 millimeters or more, such as 50-300 μm, 50-200 μm, 50-100 μm, 100-150 μm, 150-200 μm, 200-250 μm, 250-300 μm, 300-350 μm, 350-400 μm, 400-450 μm, 450-500 μm, 500-750 μm, 750 μm-1 mm, 1-1.5 mm, 1.5-2 mm, 2-2.5 mm, 2.5-3 mm, 3.5-4 mm, 4-4.5 mm, 4.5-5 mm, or more. In specific, non-limiting embodiments, the length L₁ of a connecting portion 130 is 80 micrometers. A connecting portion 130 may be any shape, such as circular (such as cylindrical) or rectangular (such a cuboidal). In other embodiments, one chamber can directly communicate with a subsequent chamber without a connecting portion between the communicating chambers.

A width W₁ (such as a diameter) of a connecting portion 130 and a length L₁ of connecting portion 130 can be in a ratio of 0.5:1 to 1.5:1, such as 0.6:1, 0.7:1, 0.8:1, 0.9:1, or 1:1. In particular embodiments, the width W₁ (such as a diameter) of the connecting portion 130 and the length L1 of the connecting portion 130 are in a ratio of 1:1.

In some embodiments, the walls of the chambers have a curved, square, triangular, or trapezoidal shape. In exemplary embodiments, walls of the chambers 128 have a curved shape. In certain embodiments, the walls of the chambers 128 are circular (such as spherical i.e., having a constant radius all along the arc), elliptical, or parabolic. In specific, non-limiting examples, a chamber 128 is spherical in shape. FIGS. 6A, 6B, 10, 18D, and 18E show exemplary curved channel shapes. In some embodiments, a chamber 128 having a round (e.g., circular) shape has a radius of curvature of 25 to 500 micrometers, such as 50-400 μm, 50-300 μm, 100-300 μm, 25-50 μm, 50-100 μm, 100-150 μm, 150-200 μm, 200-250 μm, or 250-300 μm. In particular embodiments, the chamber 128 radius of curvature is 200 μm. In some embodiments, a chamber 128 having an ellipsoid shape has a major axis of 300 to 800 micrometers, such as 300-700 μm, 300-600 μm, 300-500 μm, 300-400 μm, or 300-350 μm. In some embodiments, a chamber 128 having an ellipsoid shape has a minor axis of 100 to 800 micrometers, such as 100-700 μm, 100-600 μm, 100-500 μm, 100-400 μm, 100-300 μm, 100-200 μm, or 100-150 μm. In particular embodiments, the chamber 128 major axis is 600 μm and the minor axis is 400 μm. In some embodiments, all chambers 128 of a channel 108 are the same shape, different shapes, or a combination of a number of different shapes.

Referring again to FIG. 5, in some embodiments, a width W₂ (such as a diameter) of a chamber 128 at a widest portion is 50 to 1000 μm in width, such as 50-500 μm, 250-750 μm, or 500-1000 μm, wherein the width W₂ is perpendicular to the longitudinal axis of the channel 108 (i.e., perpendicular to the direction of flow). In specific, non-limiting examples, the width W₂ (such as the diameter) of a chamber 128 at a widest portion is 50-100 μm, 100-200 μm, 200-300 μm, 300-400 μm, 400-500 μm, 500-600 μm, 600-700 μm, 700-800 μm, 800-900 μm, or 900-1000 μm. In some embodiments, the length L₂ of a chamber 128 (e.g., a distance between one connecting portion 130 and a subsequent connecting portion 130, or between one chamber 128 and another chamber 128 when no connecting portion 130 is present) is 50 to 4000 micrometers, such as 100-1500 μm, 100-1000 μm, 500-1000 μm, 50-100 μm, 100-200 μm, 200-300 μm, 300-400 μm, 400-500 μm, 500-600 μm, 600-700 μm, 700-800 μm, 800-900 μm, 900-1000 μm, 1000-1500 μm, 1500-2000 μm, 2000-2500 μm, 2500-3000 μm, 3000-3500 μm, or 3500-4000 μm, where the length L₂ of the chamber 128 is along the longitudinal axis of the channel 108 (i.e., along the direction of flow). In specific, non-limiting embodiments, the length L₂ of a chamber 128 is 600 micrometers. The chambers 128 of a channel 108 may be the same lengths, the same widths at the widest portions, or different lengths, different widths at the widest portions, or any combination thereof.

The greatest width W₂ (such as a widest diameter) of a chamber 128 and the length L₂ of the chamber 128 can be in a ratio of 0.5:1 to 1.5:1, such as 0.5:1 to 1:1, 0.6:1, 0.7:1, 0.8:1, 0.9:1, or 1:1. In particular embodiments, the greatest width W₂ (such as a widest diameter) of a chamber 128 and the length L₁ of the chamber 128 are in a ratio of 0.8:1.

A greatest width W₂ (such as a widest diameter) of a chamber 128 and a width W₁ (such as a diameter) of a connecting portion of the channel 108 can be in a ratio of 1:1 to 4:1, such as 2:1 to 4:1, etc. In particular embodiments, a greatest width W₂ (such as a widest diameter) of a chamber 128 and a width W₁ (such as a diameter) of a connecting portion 130 of the channel 108 are in a ratio of 2:1.

The channel 108 of a disclosed device 100 can include any number of chambers 128. In some embodiments, the channel 108 includes 1 to 50 or more chambers 128, such as at least 1-10, at least 10-20, at least 20-30, at least 30-40, or at least 40-50 chambers 128. In some embodiments, the channel 108 includes 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, or more than 50 chambers 128. In a specific, non-limiting embodiment, the channel 108 includes 24 chambers 128. In another specific, non-limiting embodiment, the channel 108 includes 40 chambers 128. Thus, in some embodiments, the main portion 114 of the channel of a microfluidic device disclosed herein can have a greatest width (as defined by the widest portion of the widest chamber 128) of up to 1000 μm, and a length along the longitudinal axis of the main portion 114 of the channel of 50 μm to more than 200 mm. In some embodiments, the length of the main portion 114 of the channel along its longitudinal axis is 50 μm to 100 mm in length. In particular embodiments, the main portion 114 of the channel along its longitudinal axis is 50 μm to 50 mm in length, such as 50 μm to 10 mm, 5-15 mm, 10-20 mm, 15-25 mm, 20-30 mm, 25-35 mm, 30-40 mm, 35-45 mm, or 40-50 mm in length.

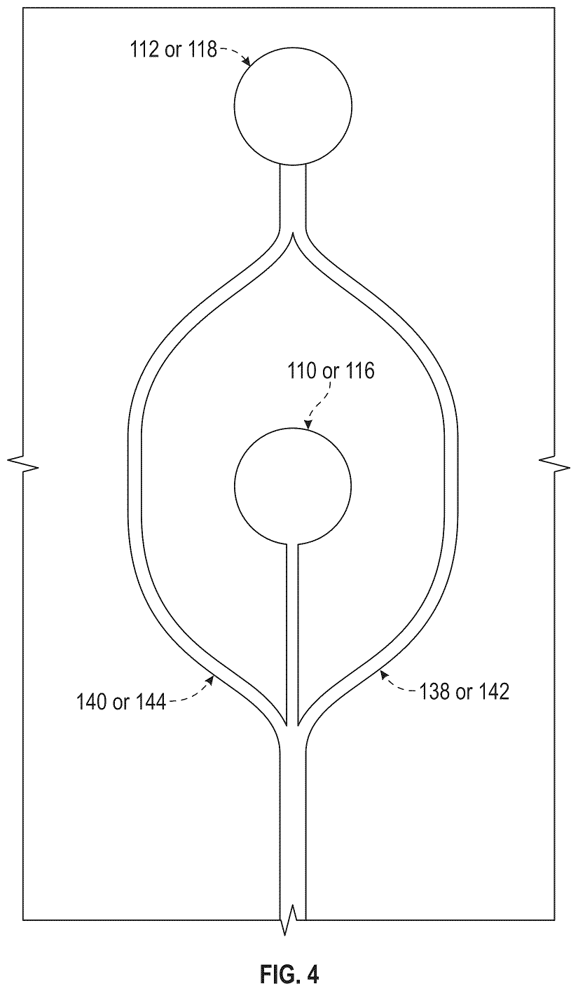

Referring to FIG. 4, the first inlet 110 and the second inlet 112 can be fluidly coupled (also referred to as being in “fluid communication”) with the main portion 114 of the channel, such as at an opposite end of the channel 108 in relation to the first outlet 116 and the second outlet 118. In certain embodiments, the second inlet 112 comprises a first channel 138 (also referred to as a first inlet channel) and a second channel 140 (also referred to as a second inlet channel). In such embodiments, the first inlet 110, the first channel 138 of the second inlet, and the second channel 140 of the second inlet are fluidly coupled to the channel 108 in close proximity in relation to one another. For example, the first 138 and second channels 140 of the second inlet 112 can communicate with the channel 108 radially outward of the first inlet 110. In particular embodiments, the first inlet 110 is aligned with the longitudinal axis of the channel 108, and the first 138 and second channels 140 of the second inlet 112 communicate with the channel 108 radially outward of the longitudinal axis of the channel such that liquid injected into the channel through the second inlet 112 is radially outward of liquid injected into the channel through the first inlet 110. Stated differently, liquid injected through the first inlet 110 is located at or near the center of the channel 108 and away from the walls, and liquid injected through the second inlet 112 surrounds the liquid injected through the first inlet and is generally located closer to the walls of the channel.

In particular embodiments, the first inlet 110, the first channel of the second inlet 138, and the second channel of the second inlet 140 are fluidly coupled to the channel 108 such that the first inlet 110 is fluidly coupled to a center of the channel, the first channel of the second inlet 138 is fluidly coupled to the channel 108 between the center of the channel and a first wall of the channel, the second channel of the second inlet 140 is fluidly coupled to the channel 108 between the center of the channel and a second wall of the channel, and the first wall of the channel and the second wall of the channel are on opposite sides of the center of the channel, such as shown in FIG. 6A.

In some embodiments, the first outlet 116 and the second outlet 118 are fluidly coupled with the main portion 114 of the channel at an opposite end of the channel in relation to the first inlet 110 and the second inlet 112. In certain embodiments, the second outlet 118 comprises a first outlet channel 142 and a second outlet channel 144. In such embodiments, the first outlet 116, the first outlet channel of the second outlet 142, and the second outlet channel of the second outlet 144 are fluidly coupled to the channel 108 in close proximity in relation to one another. For example, the second outlet 118 can communicate with the main portion 114 of the channel radially outward of the first outlet 116. In particular embodiments, the first outlet 116 communicates with the channel 108 along the longitudinal axis of the channel, and the second outlet 118 communicates with the channel 108 radially outward of the longitudinal axis of the channel.

In particular embodiments, the first outlet 116, the first outlet channel of the second outlet 142, and the second outlet channel of the second outlet 144 are fluidly coupled to the channel 108 such that the first outlet 116 is fluidly coupled to a center of the channel 108, the first outlet channel of the second outlet 142 is fluidly coupled to the channel 108 between the center of the channel 108 and a first wall of the channel 108, the second outlet channel of the second outlet 144 is fluidly coupled to the channel 108 between the center of the channel 108 and a second wall of the channel 108, and the first wall of the channel and the second wall of the channel are on opposite sides of the center of the channel, such as shown in FIG. 6A.

In some embodiments, the disclosed microfluidics device 100 includes a first outlet 116 without a second outlet, or vice versa, such that fluid introduced to the channel of the device through a first 110 or second inlet 112 exits the channel through a single outlet.

The channel 108 can be formed on the first substrate 102 at the time of fabrication of the first substrate 102 or at a later time after the first substrate 102 has been fabricated. The channel 108 can be formed using any suitable method, such as, but not limited to, casting, stamping, rolling, laminating, soft-lithography, replica molding, 3D printing (additive manufacturing), injection molding, micromilling (micromachining), etching, hot embossing, or any combination thereof.

A magnetic field can be applied across the main portion 114 of the channel of a disclosed microfluidic device 100. The magnetic field applied across the main portion 114 of the channel can be generated by a plurality of magnets, such as a plurality of magnets arranged on opposite sides of the channel from one another. Thus, some embodiments of the disclosed microfluidic device 100 can include a plurality of magnets arranged about the main portion 114 of the channel and configured to apply a magnetic field to the main portion 114 of the channel, such as to capture magnetic particles in the chambers 128, such as in a region at or near the widest portions of the chambers where a velocity of a liquid in the main portion 114 of the channel is reduced. In some embodiments, the plurality of magnets includes a first magnet 132 on a first side of the main portion 114 of the channel, a second magnet 134 on a second side of the main portion 114 of the channel, and a third magnet 136 on a third side of the main portion 114 of the channel. In certain examples, the first magnet 132 can be a single, unitary magnet (e.g., extending along a length of the channel), or an array of magnets as shown.

The second 134 and third 136 magnets can be arranged on the first substrate 102 such that the main portion 114 of the channel is disposed between the second magnet 134 and the third magnet 136. In particular embodiments, the main portion 114 of the channel is equidistant from the second magnet 134 and the third magnet 136. The second 134 and third magnets 136 can be positioned on and/or incorporated into the first substrate 102, and can apply a magnetic field across the main portion 114 of the channel. The second 134 and third magnets 136 arranged on the second and third sides of the main portion 114 of the channel, respectively, can be any suitable magnets, such as permanent magnets or electromagnets. A permanent magnet can be manufactured from any suitable material, such as, but not limited to, neodymium (NdFeB), samarium cobalt (SmCo), AlNiCo (aluminum, nickel, and cobalt), or ferrite. Electromagnets are commonly classed as non-permanent magnets, and are distinguished from permanent magnets by their ability to generate magnetic fields when electric current flows through them.

The second 134 and third magnets 136 can be arranged in an attracting configuration. In some embodiments, and as shown in FIG. 2, a south pole of the second magnet 134 is arranged opposite a north pole 136 of the third magnet or a north pole of the second magnet 134 is arranged opposite a south pole of the third magnet 136. The attracting configuration can generate an almost uniform magnetic field between the second 134 and third 136 magnets. In embodiments of the disclosed microfluidic device 100, a magnetic field applied across the main portion 114 of the channel of the device (such as a magnetic field applied across the channel using the second 134 and third 136 magnets) can be selectively applied and/or removed, such as for a period of time. In some embodiments, the second 134 and third 136 magnets can be physically removed from the device 100, thereby removing the magnetic field from across the main portion 114 of the channel. In embodiments wherein the second 134 and third 136 magnets are electromagnets, an electrical current flowed through the magnets can be removed, thereby removing the magnetic field from across the main portion 114 of the channel.

In some embodiments, the first magnet 132 is beneath the main portion 114 of the channel. In such embodiments, the first magnet 132 is arranged on and/or incorporated into the second substrate 104. Thus, in assembling the device 100 for use (such as shown in FIG. 1B), the first substrate 102 can be arranged above the second substrate 104 such that the main portion 114 of the channel in the first substrate 102 is arranged directly above and is aligned with the first magnet 132 in the second substrate 104.

The first magnet 132 can be fabricated using any suitable material. In some embodiments, the first magnet 132 includes a superparamagnetic material, such as a soft superparamagnetic material (e.g., a paste) comprising magnetic nanoparticles in a colloidal suspension (e.g., a ferrofluid). In some embodiments, the soft, superparamagnetic material is superparamagnetic iron oxide nanoparticles (SPIONS), a ferrite, or iron particles. In particular embodiments, the ferrite is MnFe₂O₄, gamma-Fe₂O₃ nanopowder, ZnFe₂O₄, nickel ferrite, Mg-nickel ferrite, or Fe₃O₄. In a specific, non-limiting embodiment, the first magnet 132 includes MnFe₂O₄ nanoparticles. A liquid component of a soft superparamagnetic material (e.g, a paste) can be aqueous or non-aqueous. Exemplary aqueous liquid components can include water, phosphate-buffered saline (PBS), or a hydrogel solution such as a gelatin solution. In some examples, a hydrogel solution, such as a gelatin solution, can include a concentration of the hydrogel (such as measured prior to the addition of other magnetic paste components) at 2 to 10% by weight, such as 2%, 3%, 4%, 5%, 6%, 7%, 8%, 9%, or 10% by weight. Exemplary non-aqueous liquid components can include alcohols (e.g., ethanol). The first magnet 132 can be introduced to the second substrate 104 using any suitable method, such as casting, 3D printing, sputter coating, soft lithography, or any combination thereof.

In certain examples, the first magnet 132 can comprise an array of magnets 146, where the number of magnets 146 in the array 132 of magnets is equal to the number of chambers 128 in the main portion 114 of the channel. A magnet 146 of the array 132 of magnets is also referred to herein as a micromagnet. The magnets 146 of the array 132 of magnets can be introduced to the second substrate 104 within any suitable cavity fabricated on a surface of the second substrate 104, such that the magnets 146 do not protrude above the surface of the second substrate 104. This arrangement can allow the first substrate 102 to be situated above the second substrate 104 in an assembled device 100 (such as shown in FIG. 1B) such that the two substrates can contact one another unimpeded.

The magnets 146 of the array 132 of magnets can be any suitable shape. Magnets 146 can have the same shapes or different shapes in any suitable combination. In some embodiments, a north pole and a south pole of a magnet 146 can have the same shape, such that the magnet 146 is bilaterally symmetric along both x- and y-axes, such as shown in FIGS. 6A and 6B. In some embodiments, a north and south pole of the magnet 146 can have an ellipsoid shape, an arrow shape, a triangle shape, a rectangle shape, or a diamond shape, etc., that concentrates the magnetic field at the end portion of the magnet. An exemplary ellipsoid-shaped magnet 146, and its alignment beneath an exemplary chamber 128 of a channel, is shown in FIGS. 1A, 6A, 18D, and 18E. In some embodiments, a magnet 146 having an ellipsoid shape has a major axis of 300 to 800 micrometers, such as 300-700 μm, 300-600 μm, 300-500 μm, 300-400 μm, or 300-350 μm. In some embodiments, a magnet 146 having an ellipsoid shape has a minor axis of 100 to 800 micrometers, such as 100-700 μm, 100-600 μm, 100-500 μm, 100-400 μm, 100-300 μm, 100-200 μm, or 100-150 μm. In particular embodiments, the magnet 146 major axis is 600 μm and the minor axis is 400 μm. In exemplary arrow-shaped magnet 148, and its alignment beneath an exemplary chamber 128 of a channel, is shown in FIG. 6B. In other embodiments, the north and south poles of a magnet of the array of magnets can have different shapes, such that the magnet is bilaterally symmetric along the x axis but not the y-axis, wherein the x-axis passes through the north and south poles.

A length dimension of the magnets 146 of the array 132 of magnets can be greater than a width dimension of the magnets. The length dimension of each magnet 146 of the array of magnets can be equal or substantially equal to (e.g., ±10%) the widest diameter W₂ of the chambers 128 of the main portion 114 of the channel. For example, the length dimension of the magnets 146 can be in any of the ranges as described above for the chamber width W₂. Thus, in some embodiments, a length of a magnet 146 can be 50 to 1000 μm in width, such as 50-500 μm, 250-750 μm, or 500-1000 μm, wherein the length is perpendicular or substantially perpendicular to the longitudinal axis of the channel 108 (i.e., perpendicular to the direction of flow). In specific, non-limiting examples, the length of a magnet 146 can be 50-1000 μm, 100-800 μm, 200-800 μm, 400-800 μm, 50-100 μm, 100-200 μm, 200-300 μm, 300-400 μm, 400-500 μm, 500-600 μm, 600-700 μm, 700-800 μm, 800-900 μm, or 900-1000 μm. In specific, non-limiting embodiments, the length of a magnet 146 can be 600 micrometers.

In some embodiments, a greatest width (such as a widest diameter) of a magnet 146 of the array 132 of magnets can be 50 to 1000 micrometers, such as 50-100 μm, 100-200 μm, 200-300 μm, 300-400 μm, 400-500 μm, 500-600 μm, 600-700 μm, 700-800 μm, 800-900 μm, or 900-1000 μm, where the width of the magnet 146 is along the longitudinal axis of the channel 108 (i.e., along the direction of flow).

In specific, non-limiting embodiments, a greatest width of a magnet 146 can be 200 micrometers. The magnets 146 of the array 132 of magnets may be the same lengths, the same widths at the widest portions, or different lengths, different widths at the widest portions, or any combination thereof. In specific, non-limiting embodiments, the length dimension of each magnet 146 of the array 132 of magnets can be the same as a widest diameter of each chamber 128 of the main portion 114 of the channel, and the widest diameters of each chamber 128 of the main portion 114 of the channel are the same numerical value.

The greatest width (such as a widest diameter) of a magnet 146 and the length of the magnet 146 can be in a ratio of 4:5 or less, such as 3:4, 3:5, 3:6, 3:7, 3:8, 3:9, 3:10, 3:15, 3:20, 3:25, 1:10, or less. In particular embodiments, the greatest width (such as a widest diameter) of a magnet 146 and the length of the magnet 146 are in a ratio of 1:3.

In an assembled device 100 (e.g., a device wherein the first substrate is arranged above the second substrate, such as is shown in FIG. 1B), magnets 146 of the array of magnets can be spaced apart beneath the main portion 114 of the channel, along the longitudinal axis (e.g., in a direction of flow) of the channel 108.

Magnets 146 of the array 132 of magnets arranged in this fashion can be spaced apart such that they do not physically contact one another. The magnets 146 can be arranged under the main portion 114 of the channel such that one magnet 146 of the array is situated beneath each chamber 128 of the main portion 114 of the channel. In certain examples, a magnet 146 of the array of magnets can be arranged beneath each chamber 128 such that the length dimension of the magnet 146 is perpendicular to the longitudinal axis of the channel 108 and the width dimension of the magnet 146 is along the longitudinal axis. Each magnet 146 of the array of magnets can have the same length dimension and/or the same width dimension as the other magnets 146. In embodiments wherein the chambers 128 of the main portion 114 of the channel are of different lengths, and/or different widths at a widest portion of the chamber 128, the magnets 146 can have different lengths (and/or different widths) such that the length of each magnet 146 is the same or nearly the same as a widest width of the chamber 128 beneath which the magnet 146 is aligned.

In some embodiments of the disclosed microfluidic device 100, the magnets 146 of the array 132 of magnets can be arranged above, rather than below, the main portion 114 of the channel, to the same or similar effect. In such a configuration, the array 132 of magnets can be arranged above the channel on a substrate that is shorter than the length of the channel 108 such that the inlets and outlets of the channel are accessible (e.g., so that one or more liquids can be introduced to the inlets unimpeded by the substrate containing the array of magnets of the first magnet).

As described herein, arranging the second 134 and third 136 magnets in an attracting configuration generates a force field directing magnetic particles in the main portion 114 of the channel toward the tips of the magnets 146 of the array 132 of magnets. Stated differently, the interaction of the magnetic fields of the magnets 134 and 136 with the magnets 146 beneath the chambers 128 can attract magnetic particles suspended in liquid in the channel toward the sides of the chambers and the ends of the magnets 146. While the attracting configuration can generate an almost uniform magnetic field between the second 134 and third 136 magnets in the absence of the first magnet array 132, the presence of the first magnet array 132 can localize the field, particularly close to the tips of the magnets 146 of the array. Further, this configuration can form a symmetric mapping of magnetic flux density inside the main portion 114 of the channel with respect to the channel longitudinal axis, while the density gradually increases approaching the bottom surface of the main portion 114 of the channel. This can form a force field directing magnetic particles in the main portion 114 of the channel toward the tips of the magnets 146 of the array 132. The relative placements of the second 134 and third 136 magnets and the first magnet array 132 allows a magnetic particle, and thus any biomarker bound to a magnetic particle, to be captured near the tip of a magnet 146 of the array 132. As described herein, each end portion or tip of a magnet 146 can be aligned beneath opposite walls of a chamber 128 at a widest portion of the chamber 128, where one end portion of the magnet 146 is the south pole of the magnet and the other end portion is the north pole of the magnet (such as is shown in FIGS. 6A and 6B). In examples in which the magnets 146 comprise a paste or suspension of magnetic nanoparticles, the magnetic field between the magnets 134 and 136 can act on the magnetic nanoparticles in the magnets 146 and cause the magnets 146 to form north and south poles. For example, a north pole of a magnet 146 can be arranged opposite the north pole of the magnet 134, and a south pole of the magnet 146 can be arranged opposite the south pole of the second magnet 134, or vice versa.

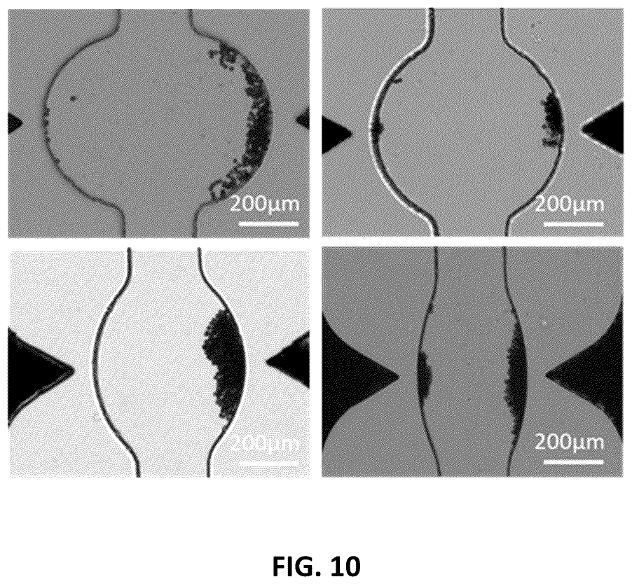

FIGS. 10-23 illustrate representative examples of a microfluidic device 100 disclosed herein, and exemplary uses of the device, and are further described in Example 1 below.

### Second Representative Embodiment

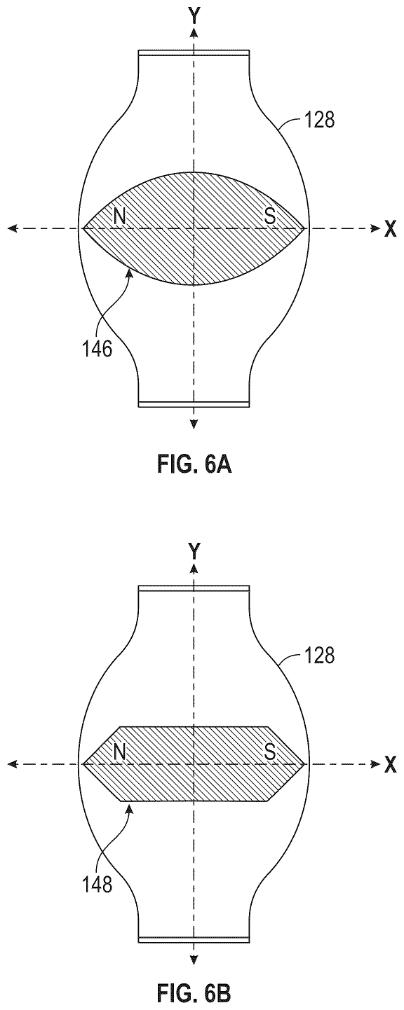

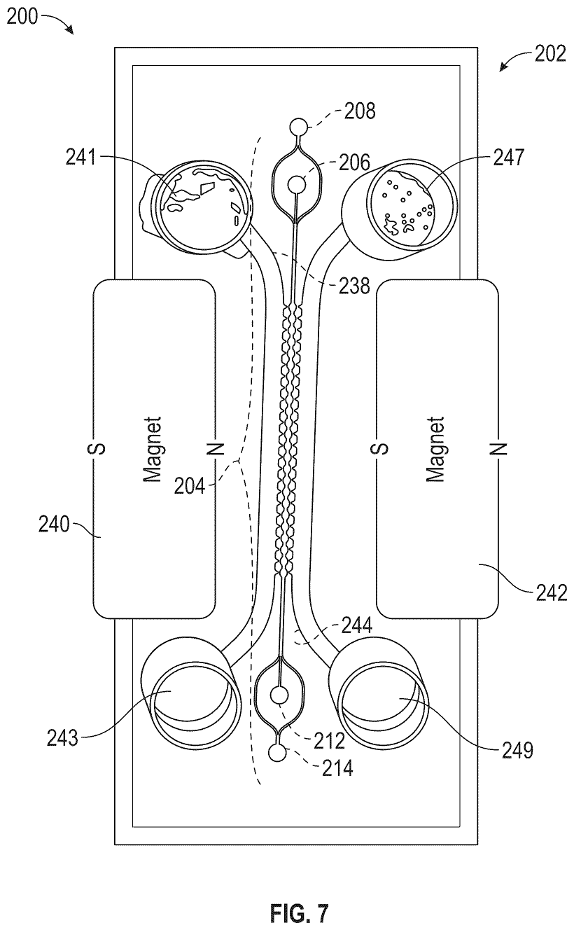

Referring to FIGS. 7, 8A, 8B, 9, and 10, in another exemplary embodiment, a microfluidic device 200 can comprise a substrate 202. As described above, in some embodiments, the substrate comprises one or more polymers, such as any of the polymers described in the first representative embodiment above. In a particular embodiment, the substrate is fabricated using PDMS. The substrate, and features of the substrate (such as a channel, cavity, well, reservoir, cavity, chamber, or any combination thereof), can be fabricated using any suitable method, such as those methods described in the first representative embodiment above.

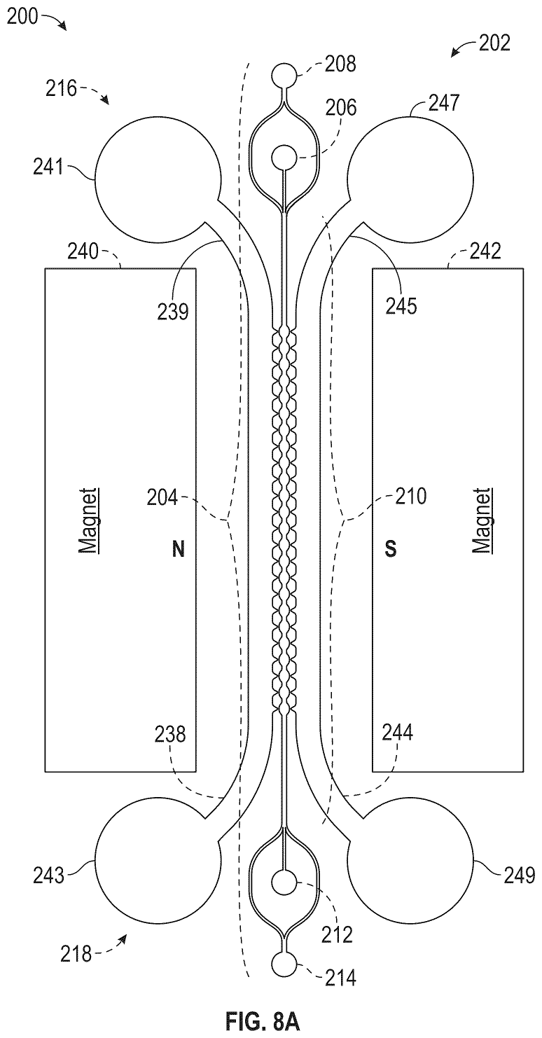

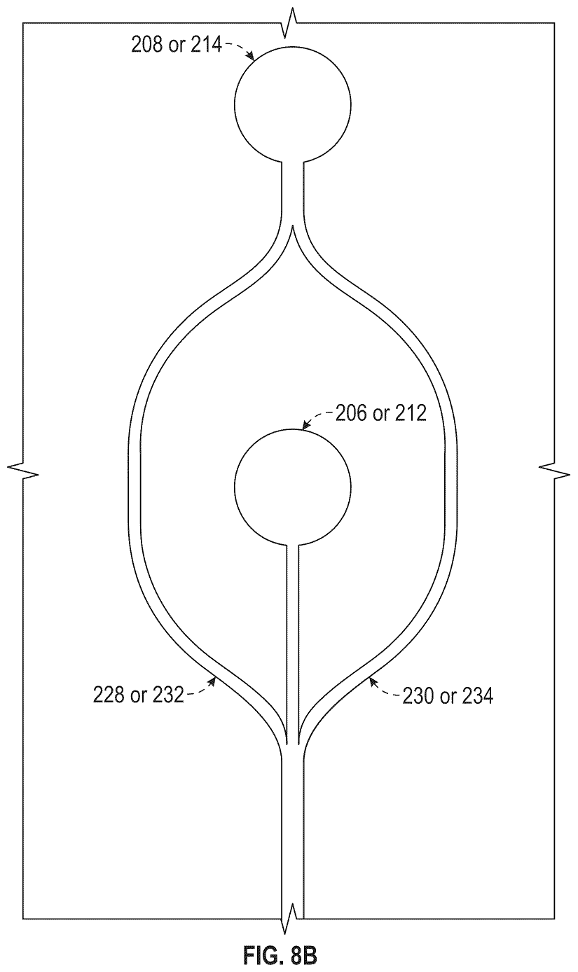

The first substrate can define a channel 204 extending along a longitudinal axis in a direction of a flow. The channel 204 can comprise a plurality of inlets and a plurality of outlets. The channel can comprise the same number of outlets as compared to inlets, or a different number of outlets as compared to inlets. Referring to FIGS. 8A and 8B, in certain embodiments, the channel 204 comprises a first inlet 206, a second inlet 208, a main portion 210, a first outlet 212, and a second outlet 214. In some embodiments, the channel extends along a longitudinal axis (e.g., in a direction of flow) from a region of a first end portion 216 of the substrate to a region of a second end portion 218 of the substrate. In such embodiments, the first inlet 206 and the second inlet 208 are arranged in the region of the first end portion 216 of the substrate, and the first outlet 212 and the second outlet 214 are arranged in the region of the second end portion 218 of the first substrate. In some embodiments, the microfluidic device 200 is reversible, such that a first inlet 206 can alternatively or at another time be a first outlet 212 and a second inlet 208 can alternatively or at another time be a second outlet 214. Such a design can facilitate flowing a first and/or a second liquid through the channel 204 of the device 200 in a first direction of flow, and, at another time or times, the same or different first and/or second liquids through the channel 204 of the device 200 in a second direction of flow that is opposite the first direction of flow.

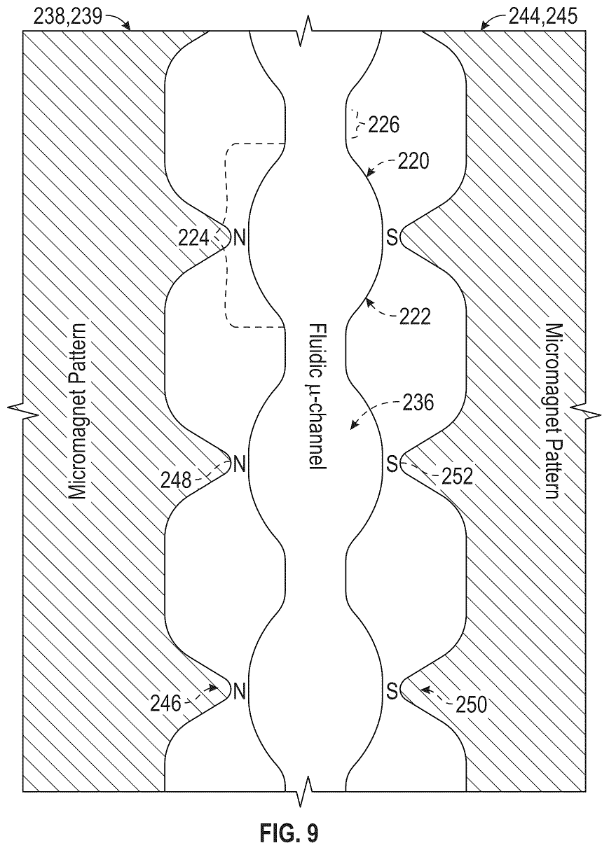

Referring to FIG. 9, in certain embodiments, the main portion of the channel 210 between the first 206 and second inlets 208 and the first 212 and second outlets 214 alternatingly widens, such as at one or more diverging portions 220, and narrows, such as at one or more converging portions 222, to define a plurality of chambers 224. In some embodiments, a chamber is a portion of the channel wherein the walls of the channel diverge in the direction of flow (i.e., along a longitudinal axis) to a widest portion (of a diverging portion 220), and subsequently converge from the widest portion to a narrowest portion. The channel 204 can thus comprise the plurality of chambers 224 extending along the longitudinal axis, between the first 206 and second inlets 208 and the first 212 and second outlets 214.

In some examples, the disclosed microchannel device 200, chambers 224 are spaced apart along all or part of the length of the main portion 210 of the channel along the longitudinal axis. Thus, the channel can comprise relatively narrow connecting portions 226 that have a width less than a maximum width of the chambers 224. Exemplary width (such as diameter) and length dimensions of the connecting portions of the second exemplary embodiment, along with exemplary ratios of a width of a connecting portion to a length of a connecting portion, can be similar to those provided for the first exemplary embodiment described herein. A connecting portion 226 may be any shape, such as circular (such as cylindrical) or rectangular (such a cuboidal). In other embodiments, one chamber can directly communicate with a subsequent chamber without a connecting portion between the communicating chambers.

In exemplary embodiments, walls of the chambers 224 have a curved shape. In certain embodiments, the walls of the chambers 224 are circular (such as spherical i.e., having a constant radius all along the arc), elliptical, or parabolic. In specific, non-limiting examples, a chamber 224 is spherical in shape. FIGS. 6A, 6B, 9, 10, 18D, and 18E show exemplary curved channel shapes. In some embodiments, all chambers 224 of a channel 204 are the same shape, different shapes, or a combination of a number of different shapes. Exemplary greatest width (such as a diameter at a widest portion of a chamber) and length dimensions of the chambers of the second exemplary embodiment, along with exemplary ratios of a greatest width of a chamber to a length of a chamber, are identical to those provided for the first exemplary embodiment described herein. The chambers 224 of a channel 204 may be the same lengths, the same widths at the widest portions, or different lengths, different widths at the widest portions, or any combination thereof.

The channel 204 of a disclosed device 200 can include any number of chambers 224. Exemplary numbers of chambers (and ranges of numbers of chambers) of the second exemplary embodiment can be similar to those provided for the first exemplary embodiment described herein. Thus, in some embodiments, the main portion 210 of the channel of a microfluidic device 200 disclosed herein can have a greatest width (as defined by the widest portion of the widest chamber) of up to 1000 μm, and a length along the longitudinal axis of the main portion 210 of the channel of 50 μm to more than 200 mm. Exemplary lengths of the main portion 210 of the channel of the second exemplary embodiment are also identical to those provided for the first exemplary embodiment described herein.

Referring to FIG. 8B, as in the first exemplary embodiment described herein, the first inlet 206 and the second inlet 208 can be fluidly coupled with the main portion 210 of the channel, such as at an opposite end of the channel in relation to the first outlet 212 and the second outlet 214. In certain embodiments, the second inlet 208 comprises a first channel 228 and a second channel 230. Fluid coupling of the first and second inlets with the main portion of the channel of the second exemplary embodiment is identical to fluid coupling of the first and second inlets with the main portion of the channel of the first exemplary embodiment described above.

As in the first exemplary embodiment described herein, the first outlet 212 and the second outlet 214 are fluidly coupled with the main portion 210 of the channel at an opposite end of the channel in relation to the first inlet 206 and the second inlet 208. In certain embodiments, the second outlet 212 comprises a first outlet channel 232 and a second outlet channel 234. Fluid coupling of the first and second outlets with the main portion of the channel of the second exemplary embodiment is identical to fluid coupling of the first and second outlets with the main portion of the channel of the first exemplary embodiment described above.

The channel 204 can be formed on the substrate 202 at the time of fabrication of the substrate 202 or at a later time after the substrate 202 has been fabricated. The channel 204 can be formed using any suitable method, such as those methods described above for the first representative embodiment.

As in the microfluidic device 100 of the first exemplary embodiment, a magnetic field can be applied across the main portion 210 of the channel of the microfluidic device 200 of the present embodiment. The magnetic field applied across the main portion 210 of the channel can be generated by a plurality of magnets, such as a plurality of magnets arranged on opposite sides of the channel from one another. Thus, some embodiments of the disclosed microfluidic device 200 include a plurality of magnets arranged about the main portion 210 of the channel and configured to apply a magnetic field to the main portion 210 of the channel, such as to capture magnetic particles in the chambers 224, such as in a region at or near the widest portions 236 of the chambers where a velocity of a liquid in the main portion 210 of the channel is reduced. Referring to FIGS. 7 and 8A, in some embodiments, the plurality of magnets includes a first magnet 238 on a first side of the main portion 210 of the channel, a second magnet 240 on the first side of the main portion 210 of the channel, a third magnet 242 on a second side of the main portion 210 of the channel, and a fourth magnet 244 on the second side of the main portion 210 of the channel.

The magnets can be arranged on the substrate 202 such that the main portion 210 of the channel is disposed between the first magnet 238 and the fourth magnet 244, and between the second magnet 240 and the third magnet 242, wherein the main portion 210 of the channel is between the first magnet 238 and the fourth magnet 244. The first 238 and fourth 244 magnets can be between the second magnet 240 and the third magnet 242. In particular embodiments, the main portion 210 of the channel is equidistant from the first magnet 238 and the fourth magnet 244, and the main portion 210 of the channel is equidistant from the second magnet 240 and the third magnet 242.

The second 240 and third magnets 242 can be positioned on and/or incorporated into the substrate 202, and can apply a magnetic field across the main portion 210 of the channel. The second 240 and third magnets 242 can be any kind of magnets, such as permanent magnets or electromagnets as described above for the first representative embodiment.

The second 240 and third magnets 242 can be arranged in an attracting configuration. In some embodiments, and as shown in FIGS. 7 and 8, a south pole of the second magnet 240 is arranged opposite a north pole of the third magnet 242 or a north pole of the second magnet 240 is arranged opposite a south pole of the third magnet 242. The attracting configuration can generate an almost uniform magnetic field between the second 240 and third 242 magnets. In embodiments of the disclosed microfluidic device 200, a magnetic field applied across the main portion 210 of the channel of the device (such as a magnetic field applied across the channel using the second 240 and third 242 magnets) can be removed, such as reversibly, such as for a period of time. In some embodiments, the second 240 and third 242 magnets can be physically removed from the device 200, thereby removing the magnetic field from across the main portion 210 of the channel. In embodiments wherein the second 240 and third 242 magnets are electromagnets, an electrical current flowed through the magnets can be removed, thereby removing the magnetic field from across the main portion 210 of the channel.

The first 238 and fourth 244 magnets can be fabricated using any suitable material, such as those materials described above for the first representative embodiment. In some embodiments, the first 238 and fourth 244 magnets can include a superparamagnetic material, such as a soft superparamagnetic paste material as described herein. In a specific, non-limiting embodiment, the first 238 and fourth 244 magnets include MnFe₂O₄ nanoparticles, or nanoparticles comprising other magnetic materials. The first 238 and fourth 244 magnets can be introduced to the substrate 202 using any suitable method, such as any of the methods described above for the first representative embodiment.

The first magnet 238 can be introduced to the substrate 202 within a first channel 239 that has been formed on the substrate, where the magnet is arranged next to the main portion 210 of the channel, along the longitudinal axis (i.e., in a direction of flow) of the channel 204. Similarly, the fourth magnet 244 can be introduced to the substrate 202 within a second channel 245 formed on the substrate 202, where the magnet is arranged next to the main portion 210 of the channel along the longitudinal axis (i.e., in a direction of flow) of the channel 204, on an opposite side of the channel 204 compared to the first magnet 238. The channels 239 and 245 can be formed using any of the methods described herein. In some examples, the first 238 and/or fourth 244 magnets can be introduced to (such as injected into, such as using a pipette) the substrate 202 through an inlet 241, 243, 247, or 249 located at one or both ends of a channel 239 or 245 arranged on the substrate 202.

Referring to FIGS. 8A and 9, the first magnet 238 and the fourth magnet 244 can be any suitable shape. The first magnet 238 can have the same shape or a different shape compared to the fourth magnet 244. In particular embodiments, the first magnet 238 has the same shape as the fourth magnet 244. The first magnet 238 can include a plurality of extension portions or peaks 246 that extend outwardly from the channel 239 toward the channel 204. The peaks 246 can be arranged such that an apex 248 of each peak 246 is situated next to the widest portion (such as a widest diameter) of a chamber 224 of the channel 204. Stated differently, the apices 246 are at the same longitudinal distance along the channel 204 as the associated chamber 224. The peaks 246 can be similarly shaped extensions defined in the channel 239 in which the superparamagnetic material is received.

The fourth magnet 244 can also include a plurality of extension portions or peaks 250 arranged such that an apex 252 of each peak 250 is situated next to the widest portion (such as a widest diameter) of a chamber 224 of the channel 204, such as on the opposite side of the channel from the first magnet 238. In such an arrangement, a north pole of the first magnet 238 can be situated opposite a south pole of the fourth magnet 244 or a south pole of the first magnet 238 can be situated opposite a north pole of the fourth magnet 244 depending on the polarity of the magnets 240 and 242, such as shown in FIG. 9. Accordingly, when a magnetic field is applied across the channel 204 and the magnets 238 and 244 by the magnets 240 and 242, a north pole peak of the first magnet 238 can be aligned next to a wall of a chamber 224 at a widest portion of the chamber, such that the north pole peak of the first magnet 238 is on the opposite side of the chamber 224 from a south pole peak of the fourth magnet 244 (such as is shown in FIG. 9). Alternatively, a south pole peak of the first magnet 238 can be aligned next to a wall of a chamber 224 at a widest portion of the chamber, such that the south pole peak of the first magnet 238 is on the opposite side of the chamber 224 from a north pole peak of the fourth magnet 244.

The first 238 and fourth 244 magnets can be arranged such that the main portion 210 of the channel is disposed between the first magnet 238 and the fourth magnet 244. In particular embodiments, the main portion 210 of the channel is equidistant from the first magnet 238 and the fourth magnet 244. In some embodiments, the first magnet 238 arranged on the first side of the channel 204 is symmetric with the fourth magnet 244 arranged on the second side of the channel 204. In such embodiments, the line of symmetry bisects the channel 204 such that the first magnet 238 is the same distance from the center of the channel 204 as the fourth magnet 244.

As described herein, arranging the second 240 and third 242 magnets in an attracting configuration generates a force field directing magnetic particles in the main portion 210 of the channel toward the apices 248 of the peaks 246 of the first magnet 238 and/or the apices 252 of the peaks 250 of the fourth magnet 244. While the attracting configuration can generate an almost uniform magnetic field between the second 240 and third 242 magnets in the absence of the first 238 and fourth 244 magnets, the presence of the first 238 and fourth 244 magnets can localize the field, particularly close to the apices 248 of the peaks 246 of the first magnet 238 and the apices 252 of the peaks 250 of the fourth magnet 244. Further, this configuration can form a symmetric mapping of magnetic flux density inside the main portion 210 of the channel with respect to the channel longitudinal axis, while the density gradually increases approaching the walls near the widest portions (such as widest diameters) of the chambers. This can form a force field directing magnetic particles in the main portion 210 of the channel toward the apices 248 of the peaks 246 of the first magnet 238 and/or the apices 252 of the peaks 250 of the fourth magnet 244. The relative placements of the second 240 and third 242 magnets and the first 238 and fourth 244 magnets allows a magnetic particle, and thus any biomarker bound to a magnetic particle, to be captured near the apex 248 of a peak 246 of the first magnet 238 or the apex 252 of a peak 250 of the fourth magnet 244.

FIG. 10 illustrates representative examples of a microfluidic device 200 disclosed herein, and exemplary uses of the device. Magnetic particles (dark spots within chambers) were captured at or near the widest portions of chambers of varying diameters (top left: 220 μm; top right: 165 μm; bottom left: 110 μm; bottom right: 55 μm) in channels of exemplary devices following application of a magnetic field across the main portion of the channel. The density of the magnetic field was concentrated near the apices of the peaks of the first and second magnets, wherein the first and second magnets were symmetrical and were arranged on opposite sides of the channel. In optimization experiments, fluid flow rates were varied between 1 and 10 μL/min.

### Methods of Using a Disclosed Microfluidic Device

A microfluidic device of the disclosed embodiments can be used in any of the methods disclosed herein. The present disclosure describes flowing a sample liquid through a channel of a disclosed microfluidic device, applying a magnetic field across the channel, and capturing a magnetic particle from the sample liquid, such as in portions of the channel where a velocity of the sample liquid is reduced. Flowing a sample liquid through the channel of a microfluidic device as described enables detection, measurement, and/or isolation of one or more biomarkers in a sample liquid when the magnetic particle includes one or more ligands that bind the one or more biomarkers in the sample liquid. When the magnetic field is applied across the channel, one or more biomarkers bound to the magnetic particle are captured with the magnetic particle. In some embodiments, the disclosed device enables high capture efficiency and capture purity of the one or more biomarkers from the sample, and enables real-time in situ (i.e., within the device) analysis and/or isolation of the one or more biomarkers. Some embodiments of the disclosed device allow for low-cost, yet robust, monitoring of one or more biomarkers associated with a condition or disease of interest (such as a cancer, an infectious disease, and/or an immune condition).

Thus, provided herein are methods of flowing a first liquid and/or a second liquid through the channel of a disclosed microfluidic device. Reference is made to device 100 in the following description for ease of illustration, but it should be understood that the following methods are applicable to all of the microfluidic device examples described herein. Referring to the device of FIGS. 1A, 1B, and 2, in some embodiments of the present methods, the first liquid can be introduced to the channel 108 through the first inlet 110 by any suitable method. Similarly, the second liquid can be introduced to the channel 108 through the second inlet 112 by any suitable method. In some embodiments, the first and second liquids contact one another upon introduction to the channel. In some embodiments, the first liquid is introduced to the channel through the first inlet 110 and the second liquid is introduced to the channel through the second inlet 112, and the second liquid flows through the intermediate channels 138 and 140 and into the main channel 114 radially outward of the first liquid such that the first liquid displaces the second liquid outwardly toward walls of the channel. Liquids can be introduced to the channel of the device 200 in a similar manner.

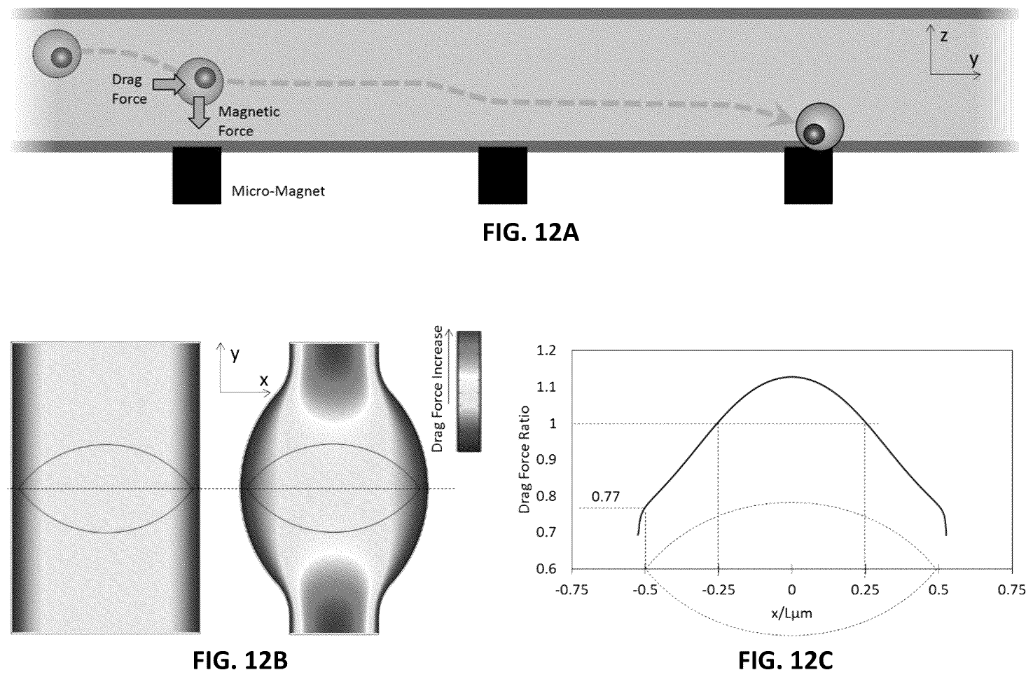

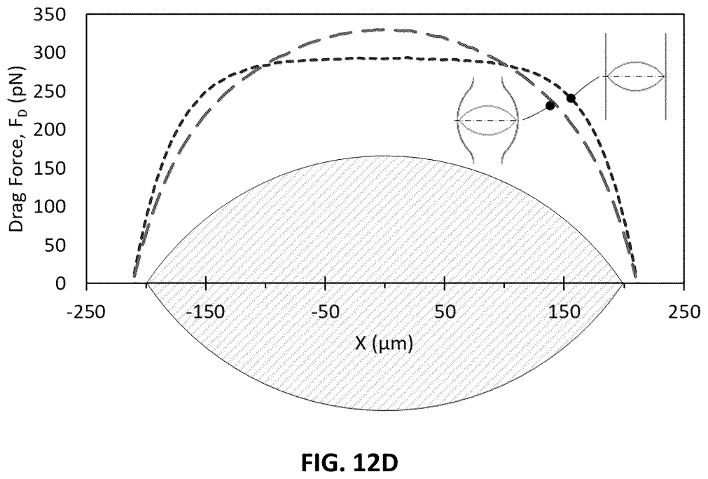

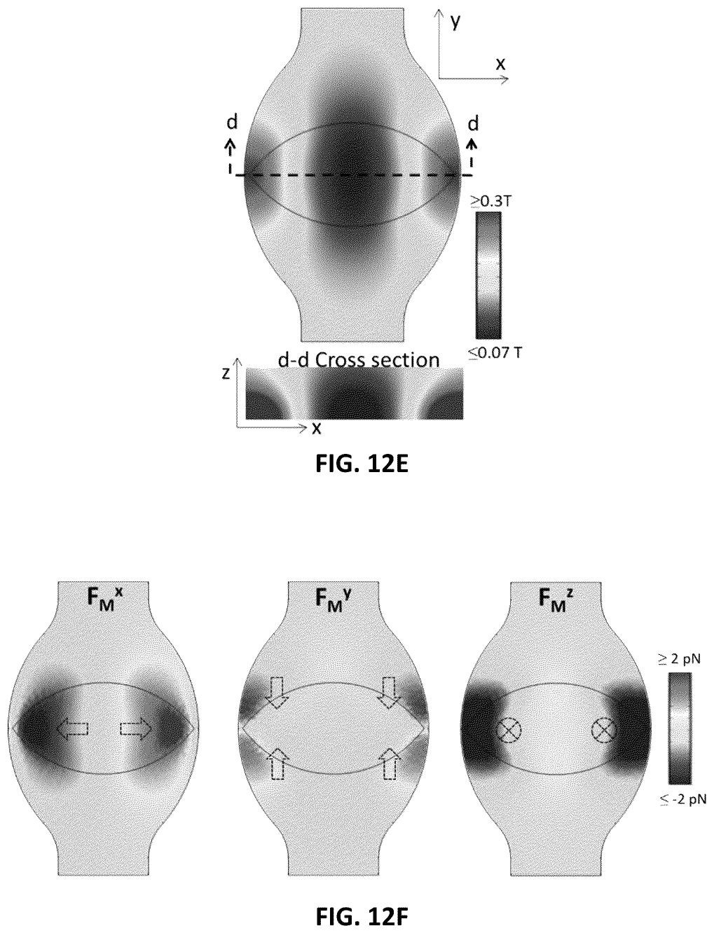

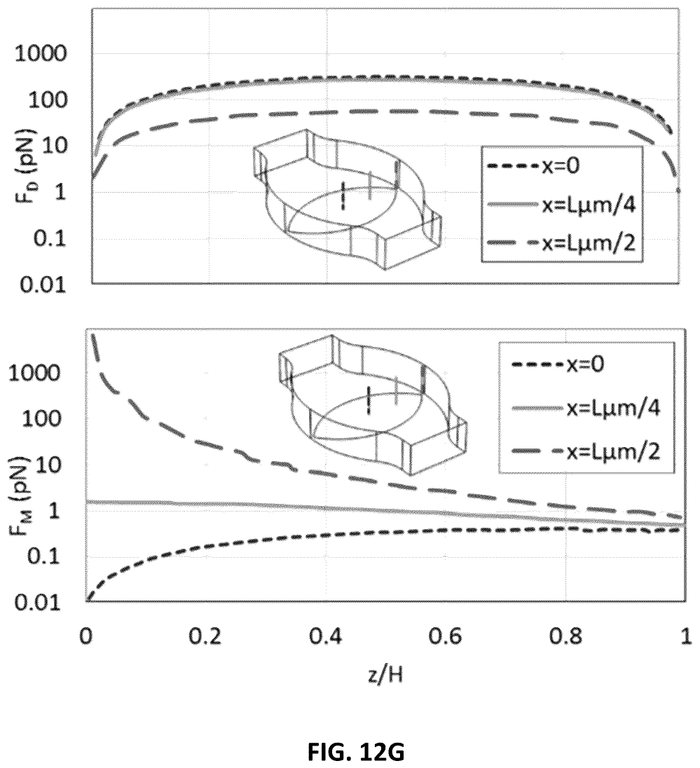

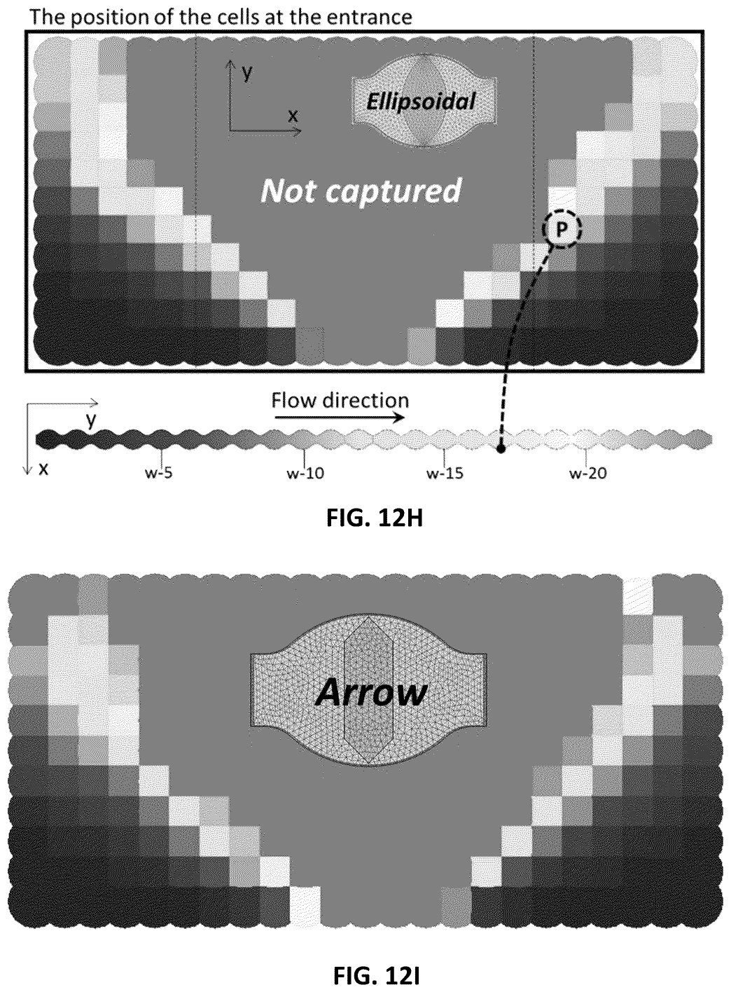

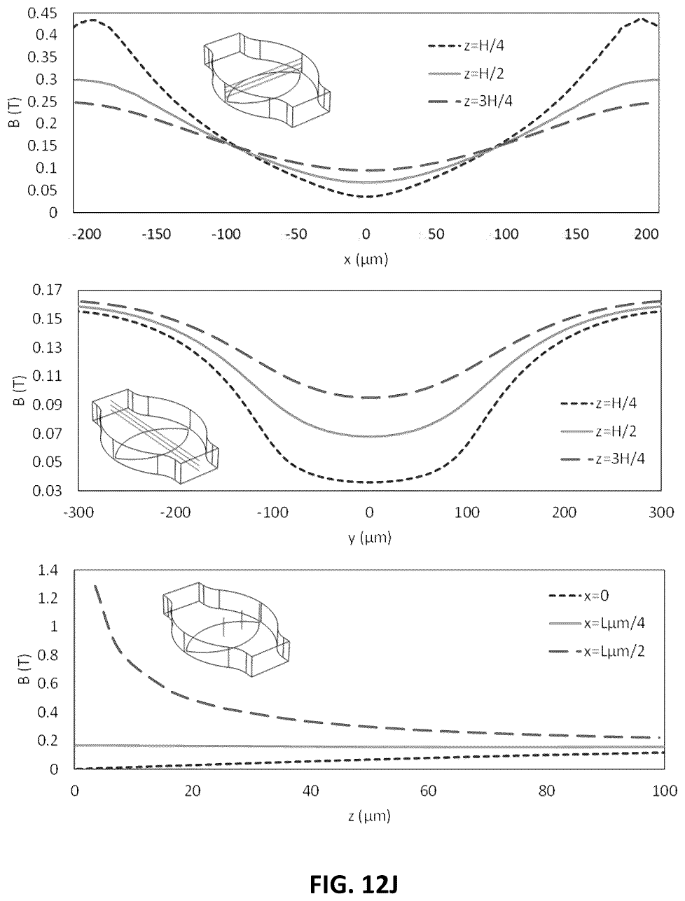

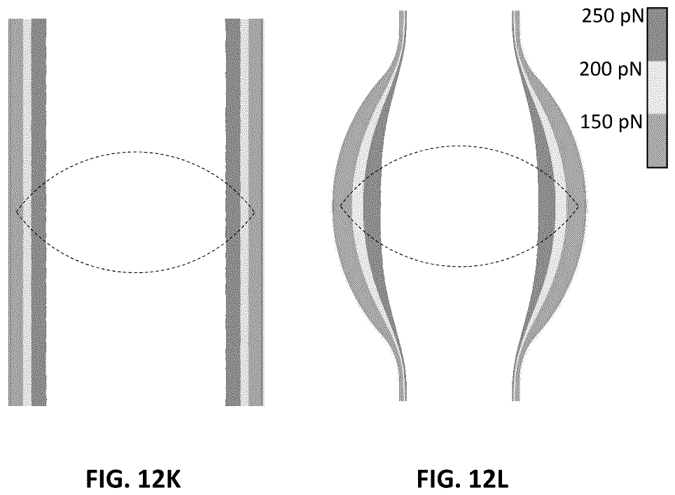

Referring to FIGS. 12B-12D, 12K, and 12L, in some embodiments, a first drag force measured at the periphery of each of the diverging portions of the channel is lower than a second drag force measured at a center of each of the diverging portions of the channel and a third drag force measured at a center of each of the converging portions of the channel. In particular embodiments, introducing the first liquid to the channel through the first inlet and introducing the second liquid to the channel through the second inlet (such as at substantially the same time as, before, or after the first liquid is introduced to the channel through the first inlet) produces a first drag force measured at the periphery of each of the diverging portions of the channel that is lower than (i) a second drag force measured at a center of each of the diverging portions of the channel and (ii) a third drag force measured at a center of each of the converging portions of the channel. In some examples, a first drag force is less than or equal to 200 pN, such as less than 10 pN, or 10-200 pN, 10-50 pN, 50-100 pN, 100-150 pN, or 150-200 pN. In some examples, a second drag force is greater than a first drag force, and is greater than or equal to 300 pN, such as 300-350 pN, 350-400 pN, 400-450 pN, 450-500 pN, 500-1000 pN, or more. In some examples, a third drag force is greater than a first and second drag force, and is greater than 400 pN, such as 400-450 pN, 450-500 pN, 500-1000 pN, 1000-2000 pN, or more. In particular, non-limiting examples, a first drag force is less than or equal to 200 pN, a second drag force is greater than the first drag force and is 300-400 pN, and a third drag force is greater than the first and second drag forces and is greater than 400 pN.

A sample liquid can be introduced and/or flowed through the channel of a disclosed microfluidic device using any of a variety of devices or other suitable means. Methods of introducing a first and/or second liquid to a disclosed microfluidic device can include, but are not limited to, a syringe pump, a pressure pump, a peristaltic pump, a pneumatic pump (such as microfluidic precision pump), or by passive methods (such as capillary microfluidics, gravity driven (hydrostatic pressure) microfluidics, osmosis, pressure-driven microfluidics, or vacuum). Such methods can include a pressure-driven, flow controlled microfluidic pump.

In particular embodiments, the first and second liquids can be miscible or immiscible. In specific, non-limiting embodiments, the first and second liquids are aqueous liquids. An exemplary first liquid useful in the disclosed embodiments can be selected from water (such as sterile water), a cell culture medium, or phosphate-buffered saline (PBS). Suitable cell culture media useful in the disclosed methods can include, but are not limited to, Dulbecco's Modified Eagle Medium (DMEM), Basal Medium Eagle (BME), Minimum Essential Medium (MEM), Ham's F-10 Nutrient Mixture Media, Ham's F-12 Nutrient Mixture Media, McCoy's 5A medium, a Roswell Park Memorial Institute (RPMI) medium, Medium 199, Human Plasma-like Medium (HPLM), or any derivations or combinations thereof.

The second liquid can comprise a sample (such as a sample liquid), such as a sample from a subject. A sample can be collected from a subject that has, or is at risk for developing, a condition or disease disclosed herein, such as a cancer, infectious disease, and/or immune condition. Typical subjects that can be selected for use in the methods disclosed herein include humans, as well as non-human primates and other animals. To identify and/or select relevant subjects, accepted screening methods are employed to determine risk factors associated with, and/or to diagnose, a targeted or suspected condition or disease in a subject, or to determine the status of an existing condition or disease in the subject. These screening methods include, for example, conventional work-ups to determine environmental, familial, occupational, and other such risk factors that may be associated with the targeted or suspected condition or disease, as well as diagnostic methods, such as, but not limited to, various histopathological, morphological, and/or cytological analyses to identify or diagnose the targeted condition or disease. These and other routine methods allow the clinician to select subjects that can benefit from the disclosed methods. In some embodiments, a sample from a subject comprises a sample liquid from the subject. The sample or the sample liquid can comprise, for example, tissue, whole blood, plasma, serum, stool/feces, saliva, sputum, urine, bronchoalveolar lavage, semen, cerebrospinal fluid (CSF), or breast milk collected from the subject using any suitable means. In some examples, the sample is used directly in the methods provided herein. In other examples, the sample is manipulated prior to analysis using the disclosed methods, such as through concentrating, filtering, centrifuging, diluting, desalting, denaturing, reducing, alkylating, proteolyzing, or combinations thereof. In some examples, components of the sample (for example, nucleic acids, such as miRNAs) are isolated or purified from the sample prior to analysis using the disclosed methods, such as isolating cells, proteins, extracellular vesicles, and/or nucleic acid molecules from the samples.

In some embodiments, the first liquid and the second liquid are flowed through the channel at a rate of 0.5 to 50 μl per minute, such as 0.5-10, 10-20, 20-30, 30-40, or 40-50 μl per minute. In some embodiments, the first liquid and the second liquid are flowed through the channel at a rate of 0.5-5, 2.5-7.5, 5-10, 7.5-12.5, 10-15, 12.5-17.5, 15-20, 17.5-22.5, 20-25, 22.5-27.5, 25-30, 27.5-32.5, 30-35, 32.5-37.5, 35-40, 37.5-42.5, 40-45, 42.5-47.5, or 45-50 μl per minute. In some embodiments, the first liquid and the second liquid are flowed through the channel at a rate of 0.5, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 μl per minute. In a specific, non-limiting embodiment, the first liquid and the second liquid are flowed through the channel at a rate of 2 μl per minute.

In some embodiments, a sample liquid (such as a second liquid) of the disclosed methods further comprises magnetic particles. In particular embodiments, the magnetic particles are introduced to the sample liquid before the sample liquid is introduced to a disclosed microfluidic device. Magnetic particles can include materials such as MnFe₂O₄, magnetite (Fe₃O₄) and/or maghemite (gamma-Fe₂O₃), can range from sub-nanometers to micrometers in size, and can respond to an external magnetic field. In some embodiments, the magnetic particles comprise a magnetic metal, a compound comprising a magnetic metal, or a combination thereof. Suitable magnetic particles include, but are not limited to, magnetic particles comprising Fe₃O₄, Fe₂O₃, Fe, Gd, or a combination thereof. In certain embodiments, the magnetic particles comprise Fe₃O₄. In some embodiments, the magnetic particles are 10 nm to 50 μm in diameter, such as 10-100 nm, 90-200 nm, 190-300 nm, 290-400 nm, 390-500 nm, 490-600 nm, 590-700 nm, 690-800 nm, 790-900 nm, 890-1,000 nm (1 μm), 990-1,500 nm, 1-5 μm, 4-10 μm, 9-15 μm, 14-20 μm, 19-25 μm, 24-30 μm, 29-35 μm, 34-40 μm, 39-45 μm, or 44-50 μm in diameter. In some embodiments, the magnetic particles are 5-20 μm in diameter, such as 5-6, 6-7, 7-8, 8-9, 9-10, 10-11, 11-12, 12-13, 13-14, 14-15, 15-16, 16-17, 17-18, 18-19, or 19-20 μm in diameter. Ina specific, non-limiting embodiment, the magnetic particles are 10 to 13.9 μm in diameter.

Embodiments of the disclosed magnetic particles may be prepared by any suitable method, and can include any suitable materials. In some embodiments, the magnetic particles comprise magnetic particle hydrogels (such as microparticle hydrogels or magnetic nanoparticle hydrogels (nanogels)), superparamagnetic iron oxide nanoparticles (SPIONS), DYNABEADS®, paramagnetic polystyrene magnetic beads, or any combination thereof. Magnetic particle hydrogels (such as magnetic nano/hybrid microgels, see the Third Representative Embodiment) of use herein are described in Seyfoori et al. (ACS Applied Materials & Interfaces, 2019, 11(28):24945-24958), which is incorporated herein by reference in its entirety. An exemplary use of such magnetic nano/hybrid microgels with a disclosed microfluidics device is described in the Third Representative Embodiment below. The magnetic nano/hybrid microgels useful with a disclosed microfluidic device can exhibit high biostability, high cytocompatibility, and comprise enough function groups to allow efficient conjugation of an effective number of ligands (such as antibodies) on the surface of a microgel particle. Such microgels comprise a thermoresponsive soft matter matrix poly(N-isopropylacrylamide)-co-acrylic acid (PNIPAM-AA) comprising in situ synthesized supermagnetic Fe₃O₄ nanoparticles to improve applied magnetic force for cell isolation and to enable cell manipulation after the capturing and isolation processes. Such microgels further allow for temperature-dependent protein G coupling in their 3D structure as a linker for oriented antibody conjugation. The available functional groups within the temperature-responsive microgel can be varied by changing the temperature during the synthesis as well as preparation steps to achieve high density of antibody conjugation (Seyfoori et al., ACS Applied Materials & Interfaces, 2019, 11(28):24945-24958).

In some embodiments, the magnetic particle further comprises one or more dyes, such as a visible emission dye or fluorescent dye. In some embodiments, one or more dye molecules is adsorbed to the surface of a magnetic nanoparticle using any suitable means. In embodiments wherein the magnetic particle comprises a polymeric matrix (such as a hydrogel), the polymeric matrix can comprise the one or more dyes.

In some examples, a concentration of the magnetic particles in the second liquid is 6 particles per milliliter to 6×10⁶ particles per milliliter prior to introduction of the second liquid to the channel, such as 6-50,000, such as 6-50, 40-100, 90-500, 400-2,000, 1,500-10,000, 9,000-100,000, 90,000-500,000, 400,000-2,000,000, 500,000-3,000,000, 600,000-4,000,000, 700,000-5,000,000, or 800,000-6,000,000 particles per milliliter prior to introduction of the second liquid to the channel. In particular embodiments, a concentration of the magnetic particles in the second liquid is 10,000-500,000 particles per milliliter prior to introduction of the second liquid to the channel, such as 10,000-30,000, 20,000-40,000, 30,000-50,000, 40,000-60,000, 50,000-70,000, 60,000-80,000, 70,000-90,000-80,000-100,000, 90,000-110,000, or 100,000-120,000 particles per milliliter prior to introduction of the second liquid to the channel. In a specific, non-limiting example, a concentration of the magnetic particles in the second liquid is 60,000 (6×10⁴) particles per milliliter prior to introduction of the second liquid to the channel.

Methods are disclosed including applying a magnetic field across the channel to direct the magnetic particles toward walls of the channel, such as toward a diverging portion of the channel, such as toward a wall of a chamber, such as toward a wall of a widest diameter region of the chamber. In some embodiments, the strength of the magnetic field applied across the channel is 0.5 to 1.5 Tesla, such as 0.5, 0.6, 0.7, 0.8, 0.9, 1.0, 1.1, 1.2, 1.3, 1.4, or 1.5 Tesla. In particular embodiments, the strength of the magnetic field applied across the channel is 0.8 to 1.3 Tesla. In another specific, non-limiting embodiment, the strength of the magnetic field applied across the channel is 0.8 Tesla. In yet another specific, non-limiting embodiment, the strength of the magnetic field applied across the channel is 1.3 Tesla.

In some embodiments, a magnetic field is applied such that magnetic particles are captured in one or more chambers of the channel. In some embodiments, the magnetic particles are captured in one or more diverging portions of the channel. In some embodiments, a magnetic field is applied across the channel such that the magnetic particles are captured in portions of the channel where a velocity of the sample liquid (such as the second liquid) and/or a drag force is reduced as compared to other portions of the channel. In some embodiments, the magnetic field is generated by two magnets, such as a second and third magnet as disclosed herein, which are arranged on opposite sides of the channel from one another. In some embodiments, the second and third magnets are external permanent magnets. In particular embodiments, the second and third magnets are arranged in an attracting configuration. As described herein, this forms a force field directing magnetic particles in the channel toward the tips of the micromagnets. In certain examples, the magnetic field is shaped, concentrated, and/or localized at particular locations along the length of the microchannel (e.g., at the widest point of the chambers) by the ferrofluid magnets (e.g., the magnets 146 in the device of FIG. 1 and the peaks 246 and 250 of the magnets 238 and 244, respectively, in the device of FIG. 7). In certain examples, the magnetic material (e.g., the magnetic nanoparticles) of the ferrofluid magnets are rearranged under the influence of the magnetic field such that the ferrofluid magnets exhibit a polarity similar to the permanent magnets.

In some embodiments of the disclosed methods, when a magnetic field is applied across the channel, 25% to 100% of the magnetic particles in the channel (such as 25% to 100% of the magnetic particles in a sample liquid (such as a second liquid) introduced to the channel) are captured in one or more chambers of the channel. In some embodiments, 25-50%, 50-75%, or 75-substantially 100% of the magnetic particles are captured in one or more chambers of the channel. In some embodiments, 50-60%, 55-65%, 60-70%, 65-75%, 70-80%, 75-85%, 80-90%, 85-95%, or 90-substantially 100% of the magnetic particles are captured in one or more chambers of the channel. In some embodiments, at least 70%, such as at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or substantially 100% of the magnetic particles are captured in one or more chambers of the channel.

In some embodiments, captured magnetic particles can be removed from a disclosed microfluidic device. In embodiments, when a magnetic field applied across the channel of the device is removed, magnetic particles in the chambers of the channel can be washed out of the device, such as through the outlet, using any suitable wash fluid (such as water, PBS, or a suitable cell culture medium), thereby isolating the magnetic particles (e.g., from the sample liquid).

In some embodiments of the disclosed methods, the magnetic particles comprise one or more ligands that specifically bind one or more biomarkers in the sample. In some embodiments, the magnetic particles comprise up to three ligands each, such as one, two, or three ligands each. The one or more ligands can be any ligand suitable for binding a biomarker of interest. The binding of a ligand and biomarker can be covalent or noncovalent (such as electrostatic). In some embodiments, the one or more ligands comprises an antibody, an aptamer, biotin, avidin, streptavidin, or neutravidin.

As used herein, a conjugate is one or more moieties directly or indirectly coupled together. For example, a first moiety may be covalently or noncovalently (e.g., electrostatically) coupled to a second moiety. A ligand (such as an antibody, an aptamer, biotin, avidin, streptavidin, or neutravidin) can be conjugated to, such as immobilized on the surface of, a magnetic particle of use herein by any suitable method. Such methods will depend on the type of magnetic particle and the nature of the ligand employed. For example, the surface of a magnetic particle can be functionalized to provide amine groups (—NH2) to covalently bind to carboxyl groups (—COOH) of an antibody ligand of interest, as described in Haghighi, et al. (Heliyon, 6(4):2020, e03677). In other examples, the surface of a magnetic particle comprises NHS (N-hydroxylsuccinimide) functional groups for conjugating primary amine-containing ligands. Additionally, kits are commercially available (e.g., Abcam: Magnetic Conjugation Kit; Click Chemistry Tools: Click-&-Go™ Magnetic Beads Conjugation Kits) that allow conjugation of an antibody of interest to certain types of magnetic particles. Each magnetic particle may include one or more than one (such as one, two, three, or more) ligand conjugated to the surface of the magnetic particle. In some embodiments, the conjugate may include a weight ratio of ligands to magnetic particles within a range of 1-10, such as a weight ratio within a range of 1-5, 1-3, or 1-2. In some embodiments, the magnetic particles of the ligand-magnetic particle conjugates have an average diameter of 500 nm, such as 300-700 nm, such as 400-600 nm, such as 450-550 nm, such as 475-525 nm.

A biomarker that is capable of interacting with (e.g., binding to) a ligand of use herein can include any one or more components of a sample that is indicative or predictive of the presence of a condition or disease in the subject, the progression of a condition or disease in the subject, the recurrence of a condition or disease in the subject, or the response of the condition or disease in the subject to a treatment that the subject has received, is presently receiving, or could optionally receive. In some examples, the biomarker is a cell (such as a CTC), nucleotide or modified nucleotide, nucleic acid (such as a DNA or RNA), peptide or protein, lipid, glycolipid, polysaccharide, extracellular vesicle (such as an exosome), metabolite, or other component of the sample indicative of an aspect of a condition or disease in the subject. In some examples, the biomarker is circulating tumor DNA. Cell-free DNA is DNA that is no longer fully contained within an intact cell, for example DNA found in plasma or serum. Healthy human blood plasma contains cell-free DNA (cfDNA) that under normal conditions is believed to be primarily derived from apoptosis of normal cells of the hematopoietic lineage. In the event of malignancy, the pool of cfDNA can have traces of circulating tumor DNA (ctDNA) that can be detected through tumor-specific somatic variations and tumor specific methylation patterns.

In some examples, the biomarker is a cell in the sample from the subject, such as a circulating tumor cell (CTC). In some examples, the biomarker is a protein or antigen, such as a protein expressed on the surface of a cell, such as EpCam, HER2, EGFR, CD4, CD8, or CD44. In some examples, the biomarker is an antigen associated with an infectious agent, such as a bacterium or virus. In a specific, non-limiting example, the one or more biomarker is epithelial cell adhesion molecule (EpCam), such as EpCam expressed on a circulating tumor cell (CTC) in the sample. In another specific, non-limiting example, the one or more biomarker is the receptor tyrosine-protein kinase HER2 (also known as erythroblastic oncogene B2 (ERBB2)), such as HER2 expressed on a CTC in the sample. HER2 is a member of the human epidermal growth factor receptor family. ERBB2 is amplified and/or overexpressed in a variety of cancers, including breast, ovarian, gastric, lung, uterine, and salivary duct cancers. In another specific, non-limiting example, the one or more biomarker is epidermal growth factor receptor (EGFR, also known as erythroblastic oncogene B1 (ERBB1)), such as EGFR expressed on a CTC in the sample. Like ERBB2, ERBB1 is amplified and/or overexpressed in a variety of cancers, such as lung, colorectal, brain (such as glioblastoma), and epithelial cancers. EGFR mutations, such as the EGFRvIII mutation in glioblastoma, have also been associated with various cancers.

Also provided herein are methods of detecting a biomarker from a sample, such as a sample from a subject. In embodiments of such methods, a first and second liquid are flowed through a microfluidic device disclosed herein. The first liquid is introduced to the channel through the first inlet and the second liquid is introduced to the channel through the second inlet. The second liquid comprises the sample, such as a from a subject, and magnetic particles. In particular embodiments, the magnetic particles comprise one or more ligands that bind to one or more biomarkers in the sample. In some embodiments, a magnetic field is applied across the channel to direct the magnetic particles toward walls of the channel.

In some embodiments, a biomarker is captured and analyzed in situ, i.e., within the microfluidic device. In such embodiments, the biomarker can be detected, measured (such as quantified), stained, or observed (such as through microscopy) without the need to remove the biomarker from the microfluidic device. In some embodiments, a biomarker can be labeled in situ with one or more dyes released from the magnetic particle to which the biomarker is bound within the microfluidic device. In other embodiments, after a sample liquid (comprising the biomarker and a magnetic particle conjugated to a ligand that specifically binds the biomarker) is introduced to the channel of the microfluidic device (such as through an inlet, such as through a sheath inlet), a magnetic field is applied across the channel to capture (such as in chambers of the channel near the tips of the micromagnets) the biomarker-bound magnetic particle. One or more labels (such as one or more dyes) that interact with the biomarker (or with the magnetic particle, or with a molecule associated with the biomarker) can be introduced to the channel under conditions suitable for the interaction. The one or more labels can then be visualized, such as using suitable microscopy techniques, to detect and/or measure (such as quantify) the biomarker.

In embodiments wherein downstream analysis of a biomarker is desired, the disclosed microfluidic device can capture the biomarker and then release it from the device for further analysis. In some embodiments, the one or more biomarkers bound to the magnetic particles can be removed from the microfluidic device, thereby isolating the one or more biomarkers. In some embodiments, a magnetic field is first applied across the channel of the microfluidic device, the magnetic field is then removed, and the one or more biomarkers bound to the magnetic particles is removed from the microfluidic device. In particular embodiments, removing the biomarker from the device does not compromise the biomarker for use in downstream analyses, such as, but not limited to, protein analyses, immunohistochemical analyses, immunocytochemical analyses, culturing, assessing a treatment response, sequencing analyses, and similar. In a specific, non-limiting embodiment, the biomarker is a CTC, and removal of the CTC from the microfluidic device does not prevent downstream analyses using the CTC (such as, but not limited to, immunohistochemical analysis of the CTC, immunocytochemical analysis of the CTC (such as to identify cytokeratin positive cells) culturing the CTC, assessing CTC response to one or more treatments, sequencing of nucleic acids isolated from the CTC, and similar).

Also provided herein are methods of diagnosing a condition or disease, such as a cancer, an infectious disease, or an immune condition, in a subject. In some embodiments, the condition or disease is a cancer. Examples of solid cancers (also referred to herein as tumors), such as sarcomas and carcinomas, that can be treated and/or inhibited using the disclosed methods include fibrosarcoma, myxosarcoma, liposarcoma, chondrosarcoma, osteogenic sarcoma, and other sarcomas, synovioma, mesothelioma, Ewing's tumor, leiomyosarcoma, rhabdomyosarcoma, colon carcinoma, lymphoma (includes indolent and high grade forms; Hodgkin's lymphoma; and non-Hodgkin's lymphoma, such as diffuse large B-cell, follicular, chronic lymphocytic, small lymphocytic, mantle cell, Burkitt's, cutaneous T-cell, AIDS-related, or central nervous system lymphoma), pancreatic cancer, breast cancer (including basal breast carcinoma, ductal carcinoma and lobular breast carcinoma), lung cancers, ovarian cancer, prostate cancer, hepatocellular carcinoma, squamous cell carcinoma, basal cell carcinoma, adenocarcinoma, sweat gland carcinoma, medullary thyroid carcinoma, papillary thyroid carcinoma, pheochromocytoma, sebaceous gland carcinoma, papillary carcinoma, papillary adenocarcinoma, medullary carcinoma, bronchogenic carcinoma, renal cell carcinoma, hepatoma, bile duct carcinoma, choriocarcinoma, Wilms' tumor, cervical cancer, testicular tumor, seminoma, bladder carcinoma, and CNS tumors (such as a glioma, astrocytoma, medulloblastoma, craniopharyrgioma, ependymoma, pinealoma, hemangioblastoma, acoustic neuroma, oligodendroglioma, meningioma, melanoma, neuroblastoma, and retinoblastoma). Examples of hematological malignancies that can be treated and/or inhibited using the disclosed methods include leukemias, including acute leukemias (such as 11q23-positive acute leukemia, acute lymphocytic leukemia, acute myelocytic leukemia, acute myelogenous leukemia and myeloblastic, promyelocytic, myelomonocytic, monocytic and erythroleukemia), chronic leukemias (such as chronic myelocytic (granulocytic) leukemia, chronic myelogenous leukemia, and chronic lymphocytic leukemia), T-cell large granular lymphocyte leukemia, polycythemia vera, lymphoma, Hodgkin's lymphoma, non-Hodgkin's lymphoma (indolent and high grade forms; includes diffuse large B-cell, follicular, chronic lymphocytic, small lymphocytic, mantle cell, Burkitt's, cutaneous T-cell, AIDS-related, or central nervous system lymphoma), multiple myeloma, Waldenstrom's macroglobulinemia, heavy chain disease, myelodysplastic syndrome, hairy cell leukemia, and myelodysplasia.

In some examples, the condition or disease is an infectious disease. In some examples, the infectious disease is selected from among arboviral infections, botulism, brucellosis, candidiasis, campylobacteriosis, chickenpox, Chlamydia, cholera, coronovirus infections, Staphylococcus infections, coxsackie virus infections, Creutzfeldt-Jakob disease, cryptosporidiosis, Cyclospora infection, cytomegalovirus infections, Epstein-Barr virus infection, dengue fever, diphtheria, ear infections, encephalitis, influenza virus infections, parainfluenza virus infections giardiasis, gonorrhea, Haemophilus influenzae infections, hantavirus infections, viral hepatitis, herpes simplex virus infections, HIV/AIDS, Helicobacter infection, human papillomavirus (HPV) infections, infectious mononucleosis, legionellosis, leprosy, leptospirosis, listeriosis, lyme disease, lymphocytic choriomeningitis, malaria, measles, marburg hemorrhagic fever, meningitis, monkeypox, mumps, mycobacteria infection, Mycoplasma infection, norwalk virus infection, pertussis, pinworm infection, pneumococcal disease, Streptococcus pneumonia infection, Mycoplasma pneumoniae infection, Moraxella catarrhalis infection, Pseudomonas aeruginosa infection, rotavirus infection, psittacosis, rabies, respiratory syncytial virus infection (RSV), ringworm, rocky mountain spotted fever, rubella, salmonellosis, SARS, scabies, sexually transmitted diseases, shigellosis, shingles, sporotrichosis, streptococcal infections, syphilis, tetanus, trichinosis, tuberculosis, tularemia, typhoid fever, viral meningitis, bacterial meningitis, west Nile virus infection, yellow fever, adenovirus-mediated infections and diseases, retrovirus-mediated infectious diseases and yersiniosis zoonoses. For example, the infectious disease can be influenza, parainfluenza, respiratory syncytial virus.

In some embodiments, the condition or disease is an immune condition or disease. The immune condition or disease can be any type of immune system disorder, such as a cytokine storm, an immune system disorder (e.g., an inflammatory or autoimmune disorder) or can be immune system conditions associated with another condition and/or disease (e.g., HIV infection or exposure to microgravity). In some non-limiting examples, the immune system disease or disorder is an inflammatory disorder. In specific embodiments, the inflammatory disorder can be rheumatoid arthritis, chronic obstructive pulmonary lung disease, inflammatory bowel disease, or systemic lupus erythematosus. In other examples, the immune system disease or disorder is an autoimmune disorder. In certain embodiments, the autoimmune disorder is type I diabetes, multiple sclerosis, lupus erythematosus, myasthenia gravis, ankylosing spondylitis, celiac disease, Crohn's disease, Graves' disease, Hashimoto's thyroiditis, transplant rejection, or autoimmune uveitis.

Also provided herein are methods of predicting a survival outcome in a subject that has a condition or disease. In some embodiments, the subject is determined to be at risk of a good or a poor survival when a biomarker in a sample from the subject binds to a magnetic particle conjugated to a ligand that specifically binds the biomarker, and is captured in one or more chambers of the channel of a disclosed microfluidic device. In such embodiments, the captured biomarker is indicative of the good or the poor survival outcome in the subject. In some embodiments, the captured biomarker can be detected and/or measured (such as quantified) in situ (i.e., within the microfluidic device) or can be removed from the device (isolated) for downstream analyses, such as, but not limited to, measuring (such as quantifying), sequencing, staining, culturing (such as culturing of a captured cell), and/or assessing a response (such as a response of a captured cell) to one or more treatments.

Also provided herein are methods of predicting recurrence of a condition or disease, such as a cancer, in a subject. In some embodiments, the subject is determined to be at risk of a recurrence of the condition or disease when a biomarker in a sample from the subject binds to a magnetic particle conjugated to a ligand that specifically binds the biomarker, and is captured in one or more chambers of the channel of a disclosed microfluidic device. In such embodiments, the captured biomarker is indicative of the recurrence of the condition or disease in the subject. In some embodiments, the captured biomarker can be detected and/or measured (such as quantified) in situ (i.e., within the microfluidic device) or can be removed from the device (isolated) for downstream analyses, such as, but not limited to, measuring (such as quantifying), sequencing, staining, culturing (such as culturing of a captured cell), and/or assessing a response (such as a response of a captured cell) to one or more treatments.

Also provided herein are methods of predicting metastasis of a cancer in a subject. In some embodiments, the subject is determined to be at risk of metastasis of the cancer when a biomarker in a sample from the subject binds to a magnetic particle conjugated to a ligand that specifically binds the biomarker, and is captured in one or more chambers of the channel of a disclosed microfluidic device. In such embodiments, the captured biomarker is indicative of the metastasis of the cancer in the subject. In some embodiments, the captured biomarker can be detected and/or measured (such as quantified) in situ (i.e., within the microfluidic device) or can be removed from the device (isolated) for downstream analyses, such as, but not limited to, measuring (such as quantifying), sequencing, staining, culturing (such as culturing of a captured cell), and/or assessing a response (such as a response of a captured cell) to one or more treatments.

Also provided herein are methods of predicting a response to a therapeutic intervention in a subject. In some embodiments, the subject is determined to be at risk of a poor response to the therapeutic intervention or a good response to the therapeutic intervention when a biomarker in a sample from the subject binds to a magnetic particle conjugated to a ligand that specifically binds the biomarker, and is captured in one or more chambers of the channel of a disclosed microfluidic device. In such embodiments, the captured biomarker is indicative of a poor response to the therapeutic intervention or a good response to the therapeutic intervention in the subject. In some embodiments, the captured biomarker can be detected and/or measured (such as quantified) in situ (i.e., within the microfluidic device) or can be removed from the device (isolated) for downstream analyses, such as, but not limited to, measuring (such as quantifying), sequencing, staining, culturing (such as culturing of a captured cell), and/or assessing a response (such as a response of a captured cell) to one or more treatments.

Also provided herein are methods of treating a condition or disease in a subject. In some embodiments, the subject is administered an effective amount of a therapeutic agents, i.e., a quantity of a therapeutic agent sufficient to achieve a desired effect. In some examples, an effective amount of a therapeutic agent (such as an anti-cancer, antibiotic, and/or immunotherapeutic agent) is an amount sufficient to treat or inhibit a disease or condition in a subject (such as a cancer, infection, or immune condition, such as an autoimmune disease). In other examples, an effective amount is an amount of a therapeutic agent sufficient to reduce or ameliorate one or more symptoms of a disease or condition in a subject (such as a reduced cancer burden or increased survival in a subject having cancer). The effective amount (for example, an amount ameliorating, inhibiting, and/or treating a disease or condition in a subject) will be dependent on, for example, the particular condition or disease being treated, the subject being treated, the manner of administration of the therapeutic agent, and other factors. Appropriate amounts in any given instance will be readily apparent or capable of determination by routine experimentation, such as administration of the therapeutic agent combination (such as in a combination therapy for cancer treatment) and observation of a cancer response in the subject.

In one embodiment, a therapeutically effective amount is the amount necessary to eliminate, reduce the size, or prevent metastasis of a tumor, such as reduce a tumor size and/or volume by at least 10%, at least 20%, at least 50%, at least 75%, at least 80%, at least 90%, at least 95%, or even 100%, and/or reduce the number and/or size/volume of metastases by at least 10%, at least 20%, at least 50%, at least 75%, at least 80%, at least 90%, at least 95%, or even 100%, for example as compared to a size/volume/number prior to treatment.

Administration with a therapeutically effective amount can be a single administration or multiple administrations. Administration can involve daily or multi-daily or less than daily (such as weekly, monthly, etc.) doses over a period of a few days to weeks or months, or even years. In particular non-limiting examples, administration involves a once monthly dose, a once every three weeks dose, a once every two weeks dose, a weekly dose, a twice weekly dose, or a daily dose, or a combination thereof. The particular mode/manner of administration and the dosage regimen will be selected by the attending clinician, taking into account the particulars of the case (such as the subject, the disease, the disease state/severity involved, the particular administration, and whether the treatment is prophylactic). In some embodiments, additional therapeutic agents are not administered to the subject. A therapeutic agent can be administered to a subject as an independent prophylaxis or treatment program, or as a follow-up, adjunct, or coordinate treatment regimen to other treatments. A subject can be administered a therapeutic agent by any suitable route, such as intratumoral, intravenous, intraperitoneal, intramuscular, subcutaneous, oral, or topical administration.

In some examples, the methods include treating or inhibiting a cancer. In such examples, a subject (such as a subject with a cancer) is administered one or more chemotherapeutic agents and/or radiation therapy. Such agents include alkylating agents, such as nitrogen mustards (such as mechlorethamine, cyclophosphamide, melphalan, uracil mustard or chlorambucil), alkyl sulfonates (such as busulfan), nitrosoureas (such as carmustine, lomustine, semustine, streptozocin, or dacarbazine); antimetabolites such as folic acid analogs (such as methotrexate), pyrimidine analogs (such as 5-FU or cytarabine), and purine analogs, such as mercaptopurine or thioguanine; or natural products, for example vinca alkaloids (such as vinblastine, vincristine, or vindesine), epipodophyllotoxins (such as etoposide or teniposide), antibiotics (such as dactinomycin, daunorubicin, doxorubicin, bleomycin, plicamycin, or mitocycin C), and enzymes (such as L-asparaginase). Additional agents include platinum coordination complexes (such as cis-diamine-dichloroplatinum II, also known as cisplatin), substituted ureas (such as hydroxyurea), methyl hydrazine derivatives (such as procarbazine), and adrenocrotical suppressants (such as mitotane and aminoglutethimide); hormones and antagonists, such as adrenocorticosteroids (such as prednisone), progestins (such as hydroxyprogesterone caproate, medroxyprogesterone acetate, and magestrol acetate), estrogens (such as diethylstilbestrol and ethinyl estradiol), antiestrogens (such as tamoxifen), and androgens (such as testosterone proprionate and fluoxymesterone). Examples of the most commonly used chemotherapy drugs include adriamycin, melphalan (Alkeran®) Ara-C (cytarabine), carmustine, busulfan, lomustine, carboplatinum, cisplatinum, cyclophosphamide (Cytoxan®), daunorubicin, dacarbazine, 5-fluorouracil, fludarabine, hydroxyurea, idarubicin, ifosfamide, methotrexate, mithramycin, mitomycin, mitoxantrone, nitrogen mustard, paclitaxel (or other taxanes, such as docetaxel), vinblastine, vincristine, VP-16, while newer drugs include gemcitabine (Gemzar®), trastuzumab (Herceptin®), irinotecan (CPT-11), leustatin, navelbine, rituximab (Rituxan®) imatinib (STI-571), Topotecan (Hycamtin®), capecitabine, ibritumomab (Zevalin®), and calcitriol.

In some examples, the methods include treating or inhibiting an immune disease or condition. In such examples, the subject (e.g., a subject with an immune disease or condition, such as an autoimmune disease, transplant rejection, or inflammatory disease) is also administered one or more immunomodulatory therapies (e.g., immunomodulatory biologics, such as muromonab, ipilimumab, abatacept, belatacept, tremelimumab, BMS-936558, CT-011, MK-3475, AMP224, BMS-936559, MPDL3280A, MEDI4736, MGA271, IMP321, BMS-663513, PF-05082566, CDX-1127, anti-OX40, huMAb, OX40L, and TRX518, e.g., Yao et al., Nat Rev Drug Discov, 12(2): 130-146, 2013, and Kamphorst et al., Vaccine, 33(0 2): B21-B28, 2015, both of which are incorporated herein by reference in their entireties; modulatory cytokines, such as IL-7; mTOR modulatory agents, such as rapamycin; antimicrobial therapy, such as vaccination, antifungals, and/or antibiotics), anti-inflammatory agents (NSAIDS; antileukotrines; immune selective anti-inflammatory derivatives, ImSAIDs; bioactive compounds with anti-inflammatory activities, such as plumbagin and plumericin; and/or steroids), disease-modifying antirheumatic drugs (DMARDs, such as methotrexate, sulfasalazine, leflunomide, hydroxychloroquine, tofacitinib, infliximab, etanercept, adalimumab, certolizumab, golimumab, tocilizumab, anakinra, abatacept, and/or rituximab), antimalarial drugs (e.g., chloroquine and hydroxychloroquine), medical procedures (including surgery and stem cell transplantation); immunosuppressive agents (e.g., for preventing rejection of transplanted organs or tissues, treating autoimmune diseases, and/or inflammatory diseases; e.g., glucocorticoids, such as prednisone, dexamethasone, and hydrocortisone; cytostatics, such as alkylating agents and antimetabolites; antibodies, such as Atgam, thymoglobuline, and T-cell receptor- and IL-2 receptor-directed antibodies; immunophilin-targeting agents, such as cyclosporin, tacrolimus, sirolimus, and everolimus; interferons (IFNs), such as IFN, and IFNβ; opioids; TNF binding proteins, such as infliximab, etanercept, and adalimumab; mycophenolate; and small biological agents, such as fingolimod and myriocin), immune tolerance therapy (e.g., for treating subjects at risk for tissue or organ transplantation rejection, subjects with allergies, and/or subjects with autoimmune disease; e.g., T or B cell-targeting or T or B cell-suppressing drugs, such as CAMPATH-1H, calcineurin inhibitors, rituximab, epratuzumab, belimumab, and atacicept; anti-cluster of differentiation (CD)3 antibodies; abatacept; induction of hematopoietic chimerism, such as mixed hematopoietic chimerism, in which the bone marrow of an organ or a tissue recipient is replaced with the donor's bone marrow or a mixture of the donor and recipient bone marrow to reduce organ or tissue transplant rejection; antigen desensitization; see Nepom et al., Immunol Rev; 241(1): 49-62, 2011, incorporated herein by reference), antihistamines, helminthic therapies (e.g., deliberate infestation of the subject with a helminth or with the ova of a helminth for treating immune disorders).

In some examples, the methods include treating or inhibiting an infectious disease in a subject. In such examples, the subject (e.g., a subject with an infectious disease, such as HIV) is also administered one or more anti-infection agents (e.g., antibodies, antifungals, antivirals, and/or antiparasitics). In specific examples, the infectious disease is HIV, and the subject is also administered antiretroviral agents, such as nucleoside and nucleotide reverse transcriptase inhibitors (nRTI), non-nucleoside reverse transcriptase inhibitors (NNRTI), protease inhibitors, entry inhibitors (or fusion inhibitors), maturation inhibitors, or a broad-spectrum inhibitors, such as natural antivirals. Other exemplary agents include lopinavir, ritonavir, zidovudine, lamivudine, tenofovir, emtricitabine, and efavirenz.

A biomarker of use herein can be indicative of a condition or disease through a presence or absence of the biomarker in a sample from the subject, through an increase or decrease in a level of the biomarker in the sample from the subject (such as compared to a control), or in a change in morphology of the biomarker (such as a change in the morphology of a cell) in a sample from the subject (such as compared to a control). Thus, in some examples, a biomarker (such as a biomarker from a sample from a subject) captured in a disclosed microfluidics device is compared to a control, such as compared to a level of the biomarker in a sample from a subject known not to have the disease or condition of interest, for example, a healthy subject. In some embodiments, the control is a normal or healthy sample from the same subject, such as the same subject prior to an occurrence of the disease or condition. In some embodiments, the control is a sample from a subject known not to have recurrence of a condition or disease (such as a cancer) and/or known not to have metastasis of a cancer. In some embodiments, the control is a sample from a subject that has the disease or condition and is known to have a good or a poor survival outcome. In other embodiments, the control is a sample from a subject that has the condition or disease and is known to have a good or poor response to the therapeutic intervention. In other examples, the control is a reference value. For example, the reference value can be derived from the average values obtained from a group of subjects known not to have the condition or disease, from a group of subjects known not to have recurrence of the condition or disease, from a group of subjects known not to have metastasis of the cancer, from a group of subjects that have the condition or disease and are known to have a good or poor survival outcome, and/or from a group of subjects that have the condition or disease and are known to have a good or poor response to a therapeutic intervention.

### Kits Comprising a Disclosed Microfluidic Device

This disclosure also provides kits comprising all or part of a microfluidic device disclosed herein. In some embodiments, a kit further comprises instructions for use of a disclosed microfluidic device, such as in any of the methods disclosed herein. The kit can include one or more containers and a label or package insert on or associated with the one or more containers. Suitable containers include, for example, bottles, vials, syringes, etc. The containers may be formed from a variety of materials such as glass or plastic. A container can hold magnetic particles, such as magnetic particles comprising one or more ligands that specifically bind to one or more biomarkers, or a composition comprising the magnetic particles. Another container can hold a liquid, such as a first liquid, such as water (such as sterile water), a culture medium, or PBS. Another container or containers can hold one or more of a sample preparation reagent, a buffer, a detection reagent, or any combination thereof. In several embodiments the container may have a sterile access port (for example the container may be an intravenous solution bag or a vial having a stopper pierceable by a hypodermic injection needle). A label or package insert indicates that the contents of the container is used for flowing a sample liquid through a channel of a disclosed microfluidic device, and/or for detecting and/or isolating one or more biomarkers in a sample (such as a sample from a subject).

The label or package insert typically will further include instructions for use, for example, in a method of flowing a liquid through a channel of a disclosed microfluidic device, and/or for detecting and/or isolating one or more biomarkers in a sample (such as a sample from a subject). The instructional materials may be written, in an electronic form (such as a computer diskette or compact disk) or may be visual (such as video files). The kits may also include additional components to facilitate the particular application for which the kit is designed. The kits may additionally include buffers and other reagents routinely used for preparing a sample, such as a sample from a subject, for use in a microfluidic device disclosed herein.

### Example 1

The following example is provided to illustrate certain particular features and/or embodiments of a disclosed microfluidic device and uses of the device. This example should not be construed to limit the disclosure to the particular features or embodiments described.

Circulating tumor cells (CTCs), cancerous exosomes, and circulating tumor DNAs (ctDNAs) have clinical importance as diagnostic and prognostic biomarkers of different types of cancers¹. After dissociating from the primary tumor site, cancerous cells intravasate into the blood vessels individually or in clumps. These cells have been captured in the blood and used to detect various cancers, including non-small cell lung cancer (NSCLC)³, breast carcinoma⁴, and pancreatic cancer⁵. Further, the number of captured CTCs in blood has also been shown to be a prognostic biomarker of patient outcome. A recent clinical study reported that colorectal cancer patients with an unfavorable concentration of CTCs per volume of blood (≥3 CTCs per 7.5 ml) had significantly shorter median progression-free survival and overall survival compared to patients with lower CTC counts⁶. Additionally, measuring CTC counts has been used to monitor patient response to a given therapeutic intervention to determine the success of the treatment strategy⁷.

Using immunomagnetic particles that specifically attach to transmembrane proteins on cells is one approach for isolating CTCs from blood samples. In that regard, the only U.S. Food & Drug Administration (FDA) cleared CTC isolation assay, CellSearch System (Menarini Silicon Biosystems Inc., Bologna, Italy), utilizes magnetic particles to capture and enumerate CTCs of epithelial origin in whole blood^{8,9}. However, challenges associated with the current technology (including the CellSearch System, which uses macroscale immunomagnetic particle sorting), include low throughput and low CTC recovery^{6,10}. Such macroscopic approaches require the movement of immunomagnetically tagged CTCs through large distances and volumes of fluid that contain approximately 6×10⁶ leukocytes per ml. The disclosed microfluidic device is a promising solution to this issue due in part to the inherent advantages associated with only having to manipulate CTCs on a length scale of micrometers. Additionally, microfluidic devices can perform complex operations with high levels of automation, which allows for CTCs to be processed in downstream assays and permits large input volumes of sample over time.

CTCs can be captured using microfluidic devices with a wide variety of methods, including direct positive antibody detection^{11,12}, dielectrophoresis^{13,14}, physical filtration^{15,16}, and magnetophoresis¹⁷⁻²⁰. Positive antibody capture can be implemented on a microfluidic chip by coating a micropost array with anti-EpCAM or a similar antibody (such as HER2 or EGFR) that will selectively bind to CTCs while other cells flow through uncaptured^{11, 12}. Dielectrophoresis can be used on a microfluidic platform to take advantage of the differences in charge between CTCs and other blood cells²¹. Applying an electric field induces an electric force on each cell with a direction and magnitude corresponding to the charge of that cell. Physical filtration techniques use the differences in cell morphology and size between CTCs and non-cancerous blood cells to enable CTC capture. On a microfluidic chip, physical filtration approaches such as flexible three-dimensional (3D) microfilters²² and microslits with optimized geometries¹⁵ appear feasible for capturing CTCs. Microfluidic technology enables oncologists to both process and analyze patient samples with precise dynamic control over analyte concentrations using small volumes and high throughput capability²³.

Magnetophoretic-based particle isolation and separation is a common CTC isolation method used in microfluidic systems. This method requires the application of an external magnetic field that induces a magnetic force on magnetic particles within the flow^{24, 25}. Strategic design of the direction and strength of the magnetic field, microchannel geometry, and magnitude of magnetic field per particle allows manipulation of the magnetic particle trajectory relative to the rest of the fluid flow in a variety of ways^{26,27}. Magnetophoresis in microfluidic platforms has two main advantages over conventional macroscopic magnetic particle sorting: high-throughput and high efficiency^{28, 29}. However, the CTC isolation efficiency of these systems is hampered by the low magnetic field gradients generated within the channels. Several complex approaches have attempted to optimize the magnetic field gradient and to improve CTC capture efficiency in microfluidic devices such as using ferromagnetic wires in combination with a large permanent magnet 17, a Halbach array of permanent magnets 18, or fabricating the chip on a substrate containing a ferromagnetic wire array³⁰. An alternating magnetic field generated by an electromagnet has also been used to selectively pass leukocytes through a filter membrane while trapping CTCs³¹.

During magnetophoresis for cell isolation, magnetic labeled cells are influenced by several physical forces. For example, the magnetic and drag forces impact the cellular trajectory through the microchannel in the context of CTC isolation^{32, 33}. Magnetic force is the most dominant force that is applied on magnetic particles and mainly depends on the volume of the magnetic particle and strength of the magnetic field. The drag force depends on the particle's diameter, relative velocity of the particle through the fluid, and the cross-sectional area perpendicular to the direction of flow³⁴. In the disclosed microfluidic device for capturing cancer cells, the effects of both the magnetic and drag forces were leveraged for efficient particle trapping in a localized zone. Experimental conditions that affect these two forces were optimized to improve isolation efficiency. The shape and location of the micromagnets in the disclosed device, as well as the geometry of the channel, were both parameters that influenced the capture efficiency³⁵.

Although quantification of CTC numbers in blood is currently a clinical focus of CTC isolation technologies, additional valuable information can be obtained from the downstream analysis of CTCs. In 2017, 75% of oncologists in the United States reported using genetic sequencing to inform treatment options for patients with advanced refractory disease³⁶. Identifying mutations in CTCs using single-cell RNA or DNA sequencing would increase the clinical usefulness of CTC testing. Immunocytochemistry analysis of CTCs for cytokeratin positive cells can also be used as a prognostic biomarker to predict the risk of relapse following treatment³⁷. If downstream analysis of CTCs is desired, the isolation device must be able to isolate CTCs from the blood stream and then release them for further analysis.

The exemplary embodiment of a disclosed microfluidic device described below addresses various shortcomings of the current magnetophoretic-based CTC capturing technologies. The exemplary microfluidic device uses smart, antibody-conjugated, magnetic nano/hybrid microgels for cancer cell capture and identification. The lower layer of this device contains an array of micromagnets with adjustable magnetic nanomaterials with different magnetic characteristics and the upper layer contains microchannels for particle capturing through the fluid flow. The localized magnetic force generated from micromagnets in the bottom layer can efficiently isolate cancer cells conjugated with the magnetic nano/hybrid microgels in designated capture microchambers (chambers) as they flow through the microchannel (channel) in the upper layer. The microfluidic device was first optimized for magnetic particle capturing in the presence of different micromagnet materials and micromagnet geometries. The shape of the micromagnets and flow rates were optimized using computational finite element simulation, which showed that micromagnets with sharp edges have higher capture efficiencies. The combination of MnFe₂O₄ nanopowders and ellipsoidal shape micromagnets resulted in the most efficient magnetic particle and magnetic particle-bound cell capturing. The efficiency of magnetic particle capture under various flow conditions was further evaluated and optimized, and the optimized conditions were used for tumor cell isolation.

The thermoresponsive smart behavior of the magnetic nano/hybrid microgels for labeling cancer cells was used for tracking and real-time monitoring of the captured cells inside the microfluidic channel without any additional steps. Antibody-conjugated magnetic nano/hybrid microgels were loaded with a cell tracker dye before the capturing process and the magnetic nano/hybrid microgels released their payload after increasing temperature to 37° C. Finally, the example below shows that using these multifunctional magnetic nano/hybrid microgels facilitated the high efficiency capture and in-situ staining of the cancer cells. Antibody-conjugated magnetic nano/hybrid microgels in the microfluidic platform captured target MCF-7 cells at a purity of 87%, which was remarkably more than that of a previous study that attained a captured cell purity of 62%.

Synthesis of magnetic nano/hybrid microgels: The procedure for synthesis of the magnetic nano/hybrid microgels was previously described.³⁸ Poly(N-isopropylacrylamide-co-acrylic acid) (PNIPAM-AA) microparticle hydrogels were synthesized using batch-type precipitation polymerization.³⁹ In situ Fe₃O₄ nanoparticles were synthesized using FeCl₂·4H₂O and FeCl₃·6H₂O solutions (molar ratio 1:2) within the 3D structure of the PNIPAM microgel. To load magnetic nanoparticles (MNPs) into the PNIPAM-AA microgel matrix, 0.3 wt % microgel suspensions were prepared in deionized (DI) water at pH 6. Subsequently, ferrite precursors containing iron (II) and iron (III) chloride hexahydrate were added to 50 mL of the microgel suspension and mixed using mechanical stirring in a N₂ atmosphere for 2 hours. NH₄OH was then added dropwise to the mixture, and the stir rate was increased from 400 to 1000 rotations per minute (rpm). The nanoparticle sedimentation reaction was completed in 1 hour. The magnetic microgels were decanted magnetically and purified using dialysis for 2 days by changing the media every day. The prepared magnetic microgels were called MMG-3 (microgels with matrix concentrations of 0.3 wt %).

Preparation of the magnetic tweezer microfluidic device: The microfluidic device included two layers, with a microfluidic channel and microcavity as the upper and lower layers respectively. A double layer microfluidic chip with permanent magnets was used in this study for magnetic particle nano/hybrid microgel-decorated cancer cell capturing. Both the microchannel and the micromagnet arrays were manufactured using soft lithography with two different SU-8 molds so that the microchannel and micromagnet array molds had heights of 100 μm and 200 μm, respectively. PDMS replication procedure was resulted into the upper fluidic channel and the lower microcavity layer. In this study, due to investigating the effect of micromagnet material and its magnetization order on the magnetophoresis behavior of the cells, a common lift-off method for micromagnet fabrication was replaced with a PDMS microcavities layer filled with two different magnetic nanopowder pastes (MnFe₂O₄ and gama-Fe₂O₃) having various magnetic saturations. The microfluidic device was assembled using O₂-plasma treatment of each PDMS layer followed by bonding and heating at 70° C. for 30 minutes.

Optimization of the fluidic and magnetic parameters of the microfluidic chip: To optimize the device design parameters (including micromagnet geometry and materials, fluid flow rate, and the external magnetic field strength), magnetic microparticle suspensions with different concentrations were tested in the fabricated microfluidic device. To mimic CTCs, the magnetic particles used in this study were 11 μm (size distribution of 10-13.9 μm) paramagnetic polystyrene magnetic beads. Magnetic particles were prepared at a concentration of 6×10⁴ particles/ml in deionized water and were injected into chips using a syringe pump (Legato 110, KD Scientific, USA). The applied flow rate was varied in the range of 0.5-5 μl/min to investigate the effect of flow rate on particle capture rate and location within the microchannel. External magnets with remanent magnetization (Br) of 0.8 T and 1.3 T (“weak” and “strong” magnets, respectively) were used to measure the effect of external magnetic field on the particle capture rate. Additionally, the effects of micromagnet materials and geometry on particle capture rate were assessed using micromagnets made using MnFe₂O₄ and gama-Fe₂O₃ and having two geometries: ellipsoidal and arrowhead shape.

Magnetic nano/hybrid microgel surface activation and antibody conjugation: To activate the carboxyl functional groups of the magnetic nano/hybrid microgels, a microgel suspension (1 mg/mL) was made by diluting a solution of the synthetized microgels in 500 μL of MES buffer at pH 5.5 (solution A), followed by mixing with 0.5 mg of ethylene dichloride (EDC) and 0.5 mg of N-hydroxysuccinimide (NHS) for 30 and 15 min, respectively. Then, the mixture was washed three times with PBS. Antibody conjugation was performed using antibody dilution in PBS at pH=7.4 at 100 μg/mL at room temperature (solution B). Then, solution B was added to solution A and stirred at room temperature for 2, 4, and 6 or for 2 h followed by overnight incubation at 4° C. to ensure the antibody conjugation within the structure of the magnetic microgel. Nonconjugated antibodies were removed by three washes with PBS. Antibody conjugation efficiency was measured using the Bradford assay (Sigma-Aldrich). To conjugate antibodies in an oriented manner, protein G was used as a linker between microgel and antibody. In this method (called “end-on”), the fragment-crystallizable region (Fc) of the antibody faces the substrate, and as a result, the fragment antigen binding fraction (fab) of the antibody is oriented outward the substrate. For this purpose, protein G solution in PBS was prepared at a concentration of 1 mg/mL and prior to antibody conjugation was coupled with magnetic microgels for 48 h at 4° C. The microgels were then washed three times with fresh, cold PBS, and the antibody conjugation procedure was conducted as explained above.

In Situ/On-Chip Cell Capturing:

MCF-7 cells (American Type Culture Collection, VA) were cultured in Dulbecco's modified eagle medium (DMEM, Thermo Fisher Scientific), 10% fetal bovine serum (FBS, Thermo Fisher Scientific) and 1% penicillin/streptomycin (10,000 U/ml, Thermo Fisher Scientific). Cells were trypsinized (Trypsin, Thermo Fisher Scientific) at 80% confluency. A cell suspension of 4×10⁴ cells in 1.5 mL of culture media was prepared and anti-EpCAM functionalized magnetic nano/hybrid microgels (reported previously³⁸) were added at a concentration of 500 μg/ml. The cells were incubated with the magnetic microgels for 30 mins at room temperature to allow binding of the functionalized magnetic microgels to the cells.

The capture experiments were performed using a sample liquid that included cancer cells in DMEM with FBS. A mixture of cancer cells and anti-EpCAM-conjugated magnetic nanogels in 1 ml PBS was injected into the inlet of the microfluidic chip. Cells were imaged and counted using fluorescent microscopy and a hemocytometer to calculate capture efficiency and purity. Prior to magnetic separation, cells were pre-stained using nucleic acid DAPI dye. After cell trapping inside the chambers, captured cells were washed three times with PBS to ensure elution of the non-magnetic microgel-bound cells. Magnets on the sides of the device were then removed and PBS back-flow washing was repeated to collect all captured cells outside the microchannel (i.e., to remove captured cells from the microchannel). The capture efficiency (CE) was measured by counting isolated cells in the hemocytometer and applying the following equation:

CE (%)=(number of captured EpCAM-expressing cells/number of initial spiked EpCAM-expressing cells)×100

To examine the specificity of cancer cell detection in the presence of nontarget cells, different concentrations of MCF-7 cells were mixed with 1×10⁶ Jurkat cells (an epithelial marker negative cell line), followed by incubation, separation, and washing steps as described above. To measure the capture purity (CP), magnetic microgel-bound MCF-7 cells stained with DAPI and Jurkat cells stained with green cell marker dye were counted using a hemocytometer.

CP (%)=(number of captured EpCAM-expressing cells/number of all captured cells)×100

Real time and on-chip monitoring of captured cells inside the channel: Real-time and on-chip monitoring of the captured cells was conducted by staining the cancer cells using silver nanocluster (AgNC) dye with inherent red fluorescent emission. AgNCs were synthesized using the chemical reaction protocol reported by Shamsipour et al.⁴⁰ A DNA aptamer was used as a template for AgNCs probe synthesis. DNA/AgNC probes were synthesized as follows: A 100 μM solution of the oligonucleotide was added to an AgNO₃ solution and incubated for 15 min. Then, the resulting DNA/Ag⁺ mixture was reduced by adding the required amount of freshly prepared NaBH₄ within 30 seconds, followed by vigorous shaking for 5 seconds. The reaction was kept in the dark at room temperature for 6 hours before use. Synthesized AgNC solution with a concentration of 1 mg/ml was loaded inside the structure of the hybrid magnetic microgel using 24 hours of incubation at 4° C. Release behavior of the loaded hybrid microgels was assessed in the presence of the captured cells by incubation at two different temperatures of 25° C. and 37.5° C. over 60 min. Release of the dye from the nano/hybrid microgels to decorate cancer cells inside the microfluidic channel was monitored over time using fluorescent microscopy.

Finite element simulations: Finite element simulations were conducted to optimize the design of the integrated microfluidic device and to improve the efficiency of particle capturing. The entire system was modeled in COMSOL Multiphysics 5 software by combining the “Magnetic Fields”, “Coefficient Form PDE”, “Laminar Flow”, and “Particle Tracing for Fluid Flow” interfaces. The magnetic force exerted on the particles in the microfluidic system can be determined using the formula⁴¹:

$${F}_{m} = \frac{V {Δ}_{χ}}{2 {μ}_{0}} ∇ {B}^{2} , B = ∇ \times A$$

where V, χ, μ₀, B, and A are the volume of the particle, magnetic susceptibility of the particle, magnetic permeability of vacuum, magnetic flux density, and magnetic vector potential at the particle position, respectively. While the magnetic flux density can be obtained in the “Magnetic Fields” module using Ampere's law, the gradients of this parameter cannot be directly calculated. In 3D “Magnetic Fields” simulations, the magnetic vector potential, A, is solved using “vector” elements, while the second derivative of vector elements are not defined. As a result, gradients of magnetic flux density, and therefore the magnetic force, cannot be calculated. To resolve this issue, “Coefficient Form PDE” was used to map the vector elements on the Lagrange elements. Subsequently, “Laminar Flow” was solved in the microchannels, again using a stationary solver, to induce the drag force on the particles. Finally, using the “Particle Tracing for Fluid Flow” module, the drag and magnetic forces were formulated, a “Bounce” boundary condition was considered, and the particle trajectory was assessed in a time-dependent solver. In all simulations, the model was discretized using a reasonably fine tetrahedral mesh.

Statistical analysis: All data were attained from a minimum of three replicates. Error bars show the standard deviation, and one-way analysis of variance (ANOVA, Tukey HSD as a post-hoc test) was employed for statistical analyses to assess multiple assessments. A p-value <0.05 was considered statistically significant.

### Results and Discussion

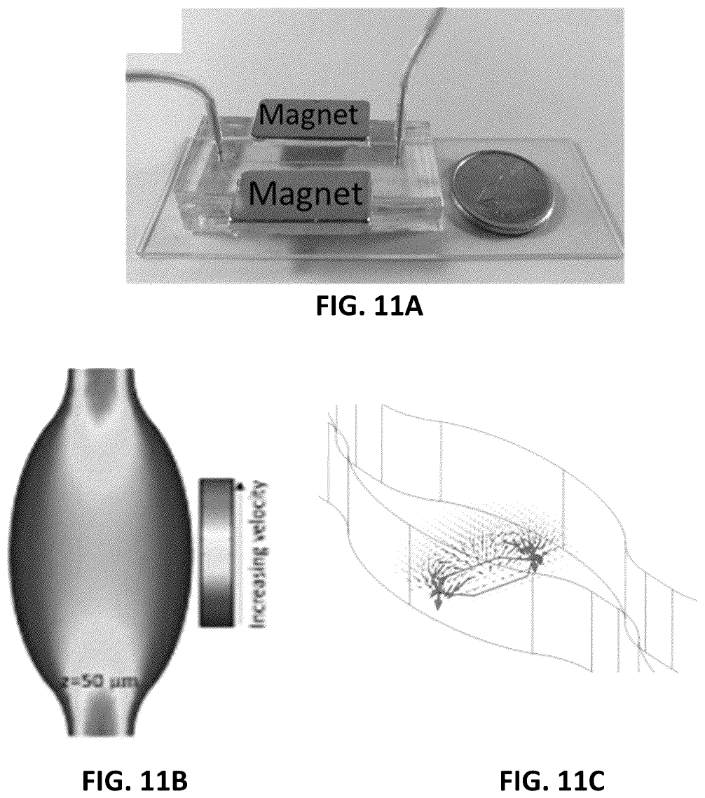

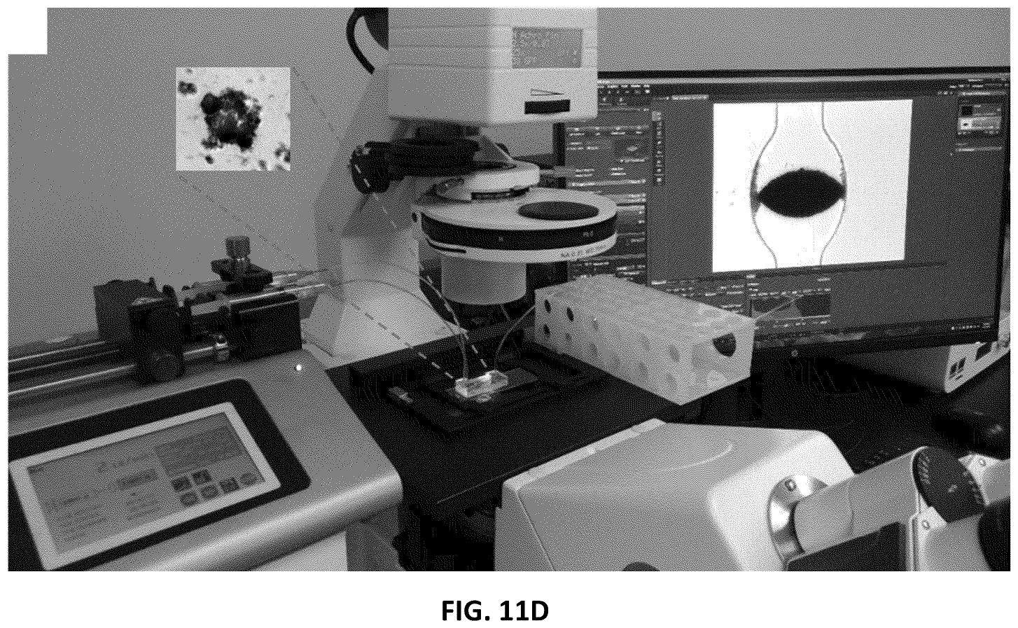

As shown in the experimental setup depicted in FIGS. 1A, 1B, 11A and 11D, a goal of the current design was to provide a chip-based platform, including a two-layer continuous flow microfluidic chip as well as antibody conjugated magnetic nano/hybrid microgels that can capture (e.g., immobilize) cells with high efficiency and without causing additional stress to the cells. This platform can also enable real time analysis of the captured cells for further on-chip assays. While the number of chambers of a channel of a disclosed device can vary depending on the application, the fabricated channel in the upper PDMS layer of the exemplary microfluidic device assessed herein included 40 ellipsoidal chambers while the lower layer included micromagnets which are formed by filling the fabricated microcavites using a magnetic nanopowder paste. The upper and lower PDMS layers were aligned so that each chamber of the upper layer was oriented directly above a corresponding micromagnet in the lower PDMS layer (FIGS. 1A, 1B, and 11C). For generating the localized magnetic field at the tip of each micromagnet, two permanent magnets were placed on either side of fluidic channel (FIGS. 1A, 1B, and 11A). Each chamber provided a localized area for efficient cell trapping at a region of greatest width and lowest fluid velocity compared to the narrower parts of the channel (FIG. 11B). The lower fluid velocity at the widest part of the chamber along with a greater magnetic field gradient due to the micromagnet presence in a central zone of each chamber facilitated magnetic particle capturing in the presence of the external magnetic forces depicted in FIGS. 11B and 11C. The final assembled magnetic microfluidic device was used to assess continuous flow tumor cell capturing under different flow rates (FIG. 11D).

Numerical evaluation of the cell capturing process in the two-layer microfluidic chip: The magnetic capturing strategy used in this work was based on the localization of a magnetic field close to the micromagnets, and consequently the successive attraction of the magnetic particles toward the micromagnets (FIG. 12A). In this system, two main forces affected the movement of the particles, including the fluid drag force and magnetic force exerted by the magnetic field. A smaller drag force and relatively higher magnetic force enable continuous capture of the magnetic particles (for example, the magnetic particles bound to one or more biomarkers) with high efficiency, while also keeping the throughput of the system as high as possible. Although a decrease in the fluid velocity can reduce the drag force on the particles, it can also decrease the throughput of the device. A higher throughput can be helpful for clinical applications (such as diagnostic applications), for example, given to the low number of rare disease-associated biomarkers in the circulation and therefore the requirement of processing a large volume of body fluid to detect them⁴². To address this challenge, a combined computational/experimental study was performed. Preliminary experimental studies using conventional straight channels (data not shown) resulted in low capturing efficiency, mainly due to the release of the captured particles by the drag force over time. Consequently, the straight structure was changed to a multi-chamber configuration. FIG. 12B compares the distribution of the drag force in both straight and well-like channels. While the drag force is increased at the center of the well-like channel compared to the straight one, the figure indicates that this force is reduced in proximity of the micromagnet tips, where the cells are captured. The ratio of the drag force in a chamber to that in straight channel, shown in FIG. 12C, confirms this finding (FIG. 12D shows the drag forces in a chamber and the drag forces in a straight channel separately). Using the multi-chamber channel structure, the drag force at the micromagnet tip was 23% decreased.

Based on simulation results, an attracting configuration of external permanent magnets was selected for this study. While this configuration can generate an almost uniform magnetic field between the magnets in the absence of patterned micromagnets, the presence of micromagnets can localize the field, particularly close to the micromagnet tips (FIG. 11C). The preliminary simulation results showed that this configuration can form a symmetric mapping of magnetic flux density inside the microchannel with respect to the channel center-line (y axis), while the density gradually increases approaching the bottom surface of the channel (FIGS. 12E and 12J). This forms a force field directing particles toward both tips of the micromagnets and has been depicted for the x, y, and z directions in FIG. 12D. The possibility of capturing cells at both sides of the channel reduces the magnetic particle traveling distance across the channel, and therefore enhances the chance of magnetic particle capture at a given flow rate. As a result, the capturing efficiency improves without negatively effecting the throughput of the system.

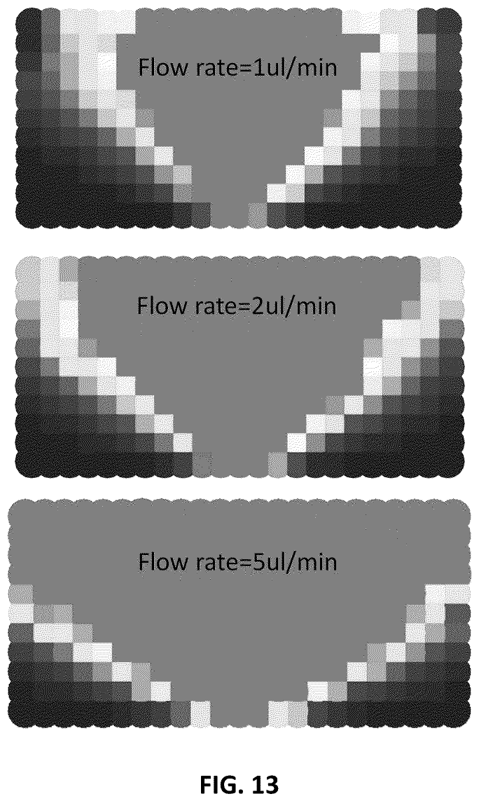

FIG. 12G compares the drag and magnetic forces exerted on the magnetic particles in different positions of the channel. As shown in FIG. 12E, magnetic force directs the magnetic particles towards the bottom corners of the channel, where the magnetic force is larger than the drag force. This enables a strong and stable capture of the particles inside the chambers. In other words, the magnetic particles that are entering the channel close to the bottom corners can be rapidly captured by the micromagnets, while those far from the micromagnet tips have more chance to escape the magnetic field. A magnetic particle tracing simulation was implemented to assess this phenomenon (FIG. 12H). FIG. 12H indicates the capture positions of the magnetic particles along the channel, y direction, based on their initial position when entering the microfluidic channel. (FIG. 12I shows the capture positions of the magnetic particles along the channel, y direction, based on their initial position when entering the microfluidic channel in a comparison study using arrow-shaped micromagnets rather than the ellipsoid-shaped micromagnets used in the experiment depicted in FIG. 12H.) As simulation results demonstrated, the magnetic particles entering the channel close to the bottom corners are captured in initial chambers (dark color). Approaching the top center, the possibility of capturing the magnetic particles will be decreased. It is noted that magnetic particles with initial positions in the central region are not captured in the simulations. While the results demonstrated that the capturing of the particles is dependent on the applied flow rates (FIG. 13), in all studies, the particles entering from the top-center of the microchannel had a low capturing probability. This outcome encouraged the modification of the channel design to a core-sheath system, shown in FIGS. 1A and 1B. The addition of a core flow of a buffer solution, with the same flow rate as the sheath flow containing the sample of interest, significantly enhanced the capturing efficiency in simulation results. As shown by the dashed lines in the FIG. 12H, the core-sheath system eliminated the majority of the non-capture positions and increased the capture efficiency from 48% to 84%.

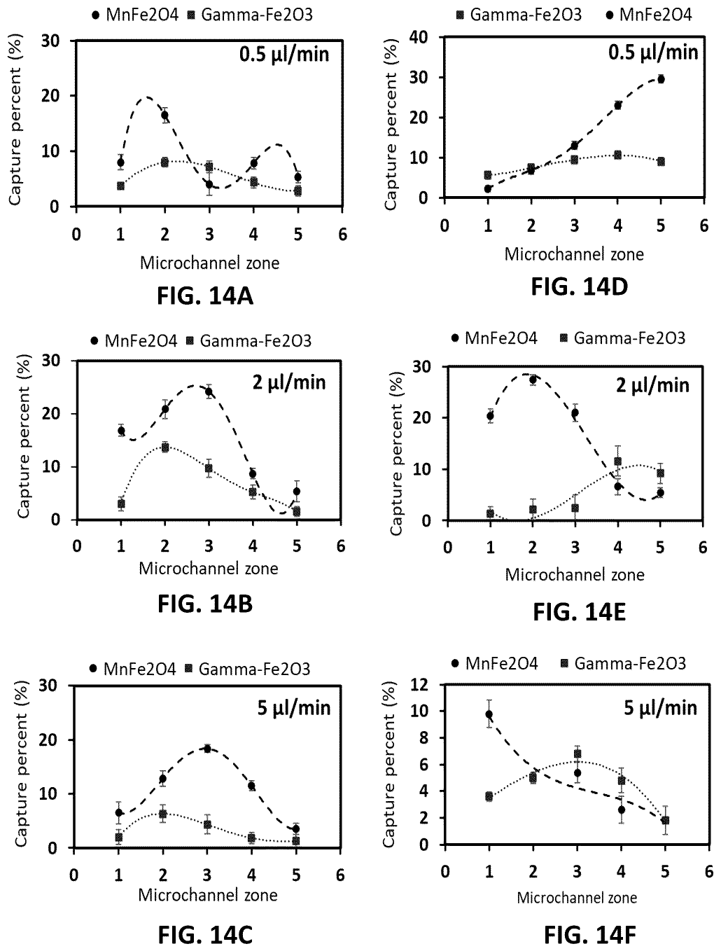

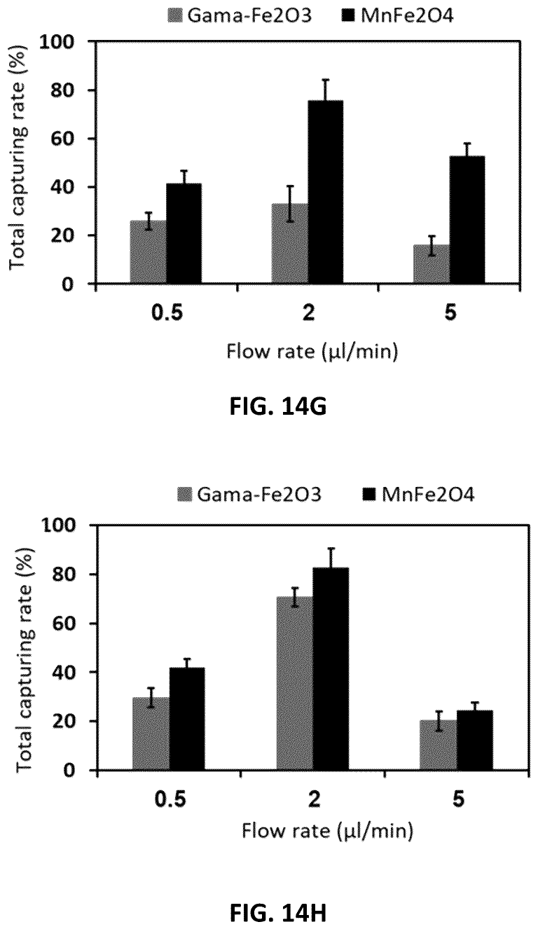

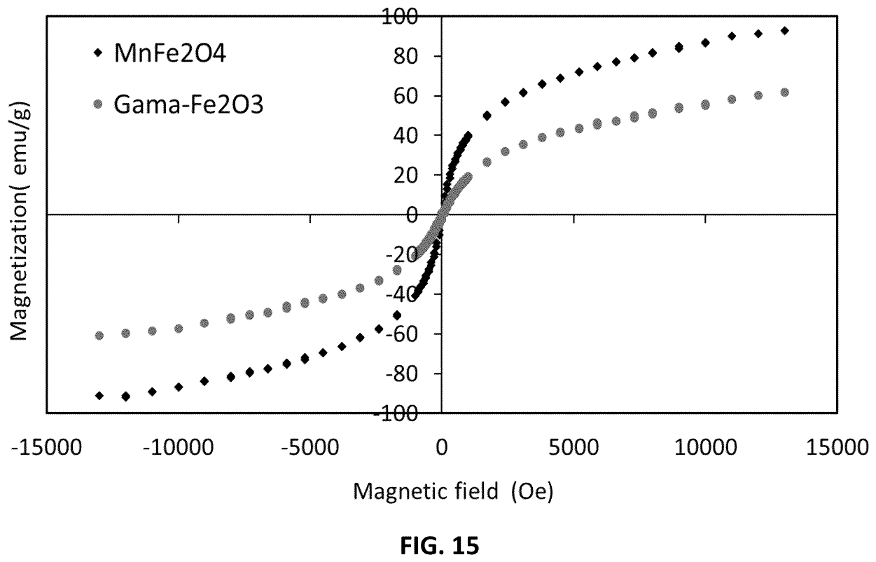

Microfluidic device setup and optimization of the capturing parameters: As mentioned in the experimental section, the magnetic nanopowder for making the micromagnets, the strengths of the side permanent magnets, and the channel geometry and dimensions were varied in the isolation experiments. Magnetic particle capturing efficiency was assessed at three different flow rates in the presence of two different micromagnet materials as well as two different permanent magnet strengths (0.8 and 1.3 T) at both sides of the microchannel. FIG. 14 shows that in the presence of the external magnetic field, there is a greater magnetic particle capturing rate for the MnFe₂O₄ micromagnet with a saturation magnetization (Ms) of 94 emu/g in comparison to the gama-Fe2O3 micromagnet with a Ms of 65 emu/g. The magnetic hysteresis loop of both the MnFe₂O₄ and gama-Fe₂O₃ nanopowders is depicted in FIG. 15.

Dividing the device into 5 different zones, each with 8 chambers, showed how changing the flow rate, permanent magnet strength, and micromagnet material affected the CTC capture rate in each zone as well as the total capturing rate for each set of conditions. Zone 1 was adjacent to the fluid inlets and the zones incremented up along the channel until zone 5, which was adjacent to the fluid outlets. The capture regions were slightly shifted to the higher numbered zones by increasing the flow rate. This behavior was more evident with weaker permanent magnets (0.8 T) and MnFe₂O₄ micromagnets, so that the generated magnetic gradient at the tip of micromagnets caused more magnetic particle accumulation in the second zone of the channel, but was shifted to the 3^{rd} and 4^{th} zones by increasing the flow rate from 0.5 to 5 μL/min (FIGS. 14A-14E). When using permanent magnets with a higher magnetic flux remanence (1.3 T), the majority of magnetic particles were trapped in the first zones for MnFe₂O₄ micromagnets. For gamma-Fe₂O₃ micromagnets, particles escaped from the first zones and were trapped in chambers in the middle or final zones (FIG. 14D-14F). These results showed that varying the length of the channel can increase the number of captured particles that initially escaped from the initial chambers at elevated flow rates. Increasing the strength of the external magnetic field induced a larger localized magnetic flux gradient and consequently increased the magnetic force acting on the magnetic particles. However, variation of the capturing efficiency between two micromagnets was greater when using the weaker external magnet (FIGS. 14G and 14H). This may be due to high magnetic flux remanence of the permanent magnet by which a great magnetic susceptibility difference is created and the effect of the magnetic gradient on the magnetic force is partially ignored.

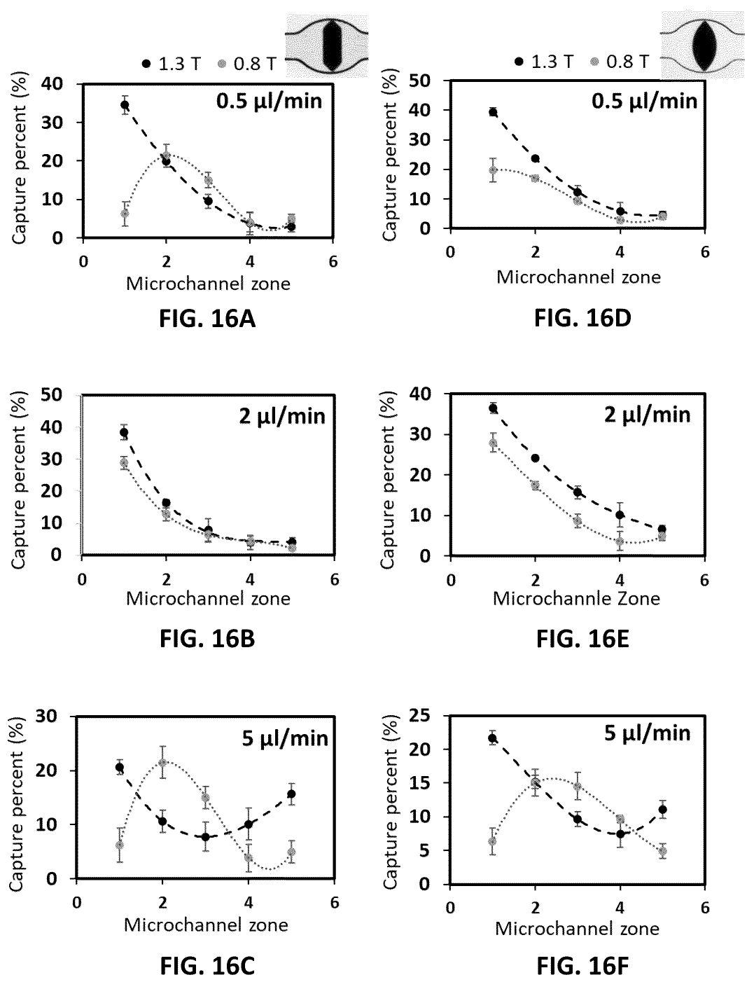

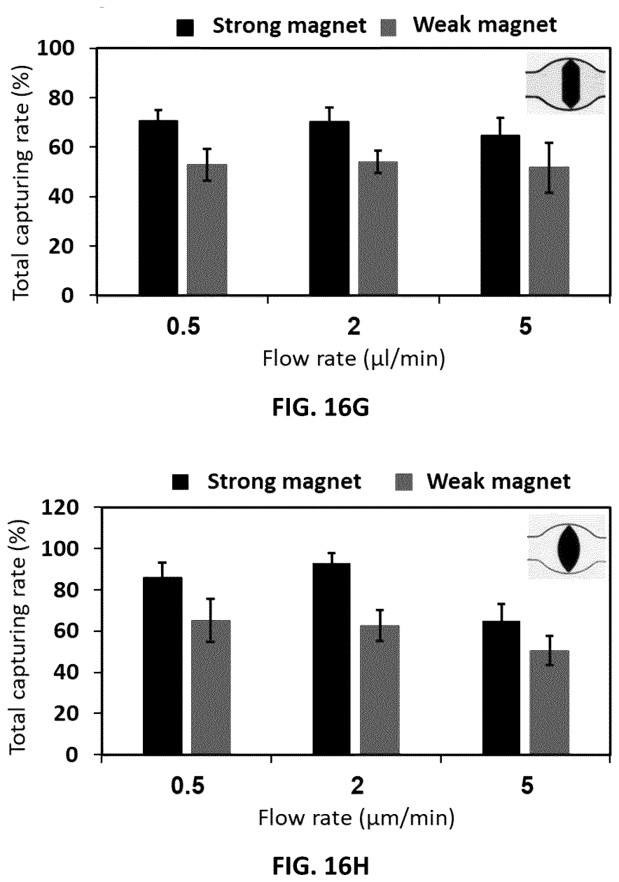

As demonstrated in FIGS. 16A-16F, by keeping the micromagnetic material constant (MnFe₂O₄), the effect of other variables such as micromagnetic geometry and external magnet strength on the capture efficiency was assessed. As shown in FIG. 16, the ellipsoidal micromagnet can provide greater capture efficiency at all flow rates compared to the arrow-shaped micromagnet. The pattern of magnetic particle capturing differed in the case of using weak permanent magnets at the higher flow rates, so that unlike the flow rates of 0.5 and 2 μL/min, magnetic particles escaping from the first chambers were trapped in the middle zones of the channel in response to an induced gradient field at the tips of micromagnets. This might be related to the higher magnetic field strength at the middle of the permanent magnet. As shown in FIGS. 16G and 16H, greater capture efficiency using the ellipsoidal micromagnet as compared to that of the arrow-shaped micromagnet was attributed to the micromagnet size and magnetic nanopowder quantity. However, the induced gradient field at the two side angles of the arrow-shaped micromagnet might have had a weakening effect on the induced magnetic force at the micromagnet tip.

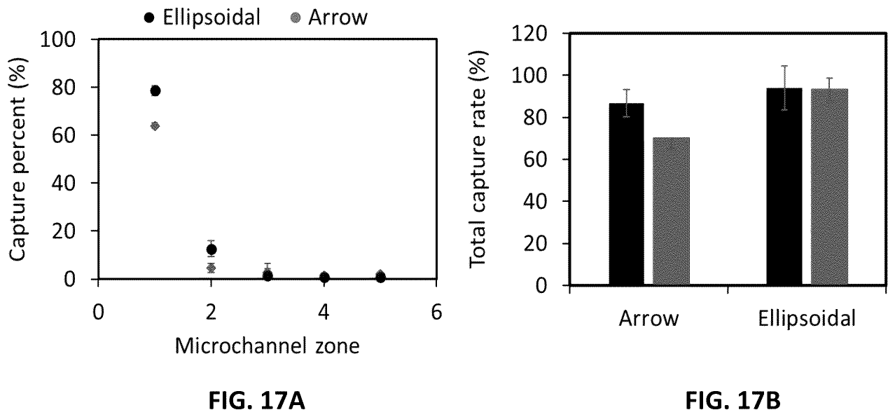

Further optimization of the micromagnet design and experimental conditions was conducted to elucidate the role of micromagnet geometry on the total capture efficiency. FIG. 17 demonstrates that by adding a fixed concentration of non-magnetic polystyrene particles (1×10⁶ particle/mL), more than 70% of the magnetic beads were captured in the first zone of the channel, while there was no significant difference between the capturing pattern of the arrow-shaped versus ellipsoidal micromagnets. Moreover, the presence of the non-magnetic microparticles in the fluid flow can substantially decrease the total capture rate using the arrow geometry while total capture rate was not altered significantly using the ellipsoidal micromagnet. Guided by the optimization of the various experimental parameters, MnFe₂O₄ micromagnets with ellipsoidal geometries were used in the presence of 1.3 T permanent magnets for the subsequent cell capturing experiments.

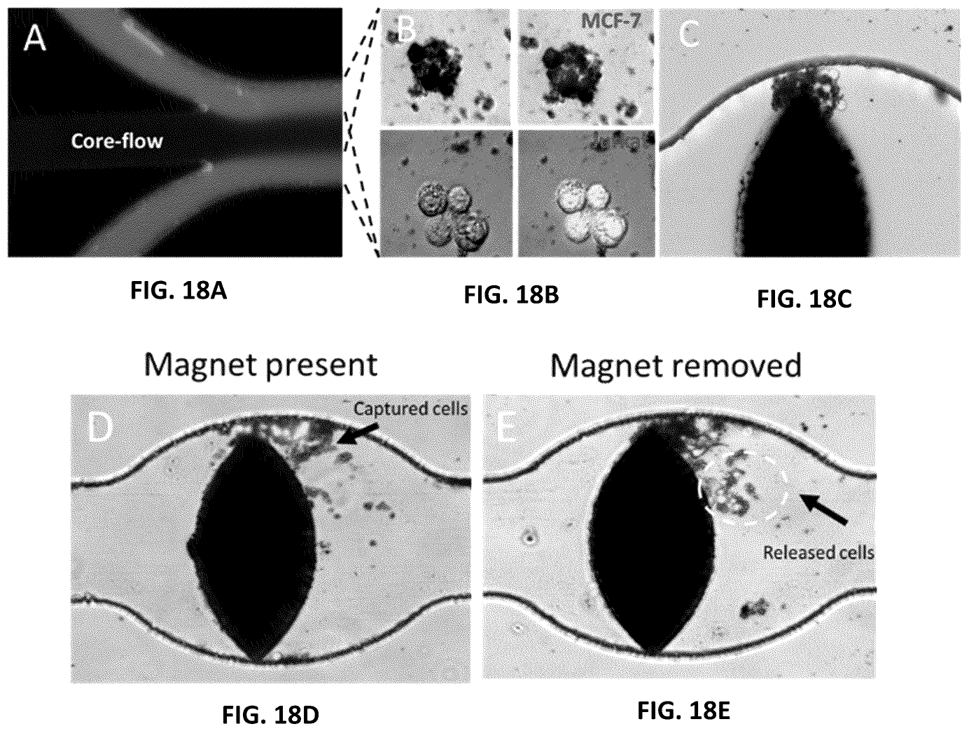

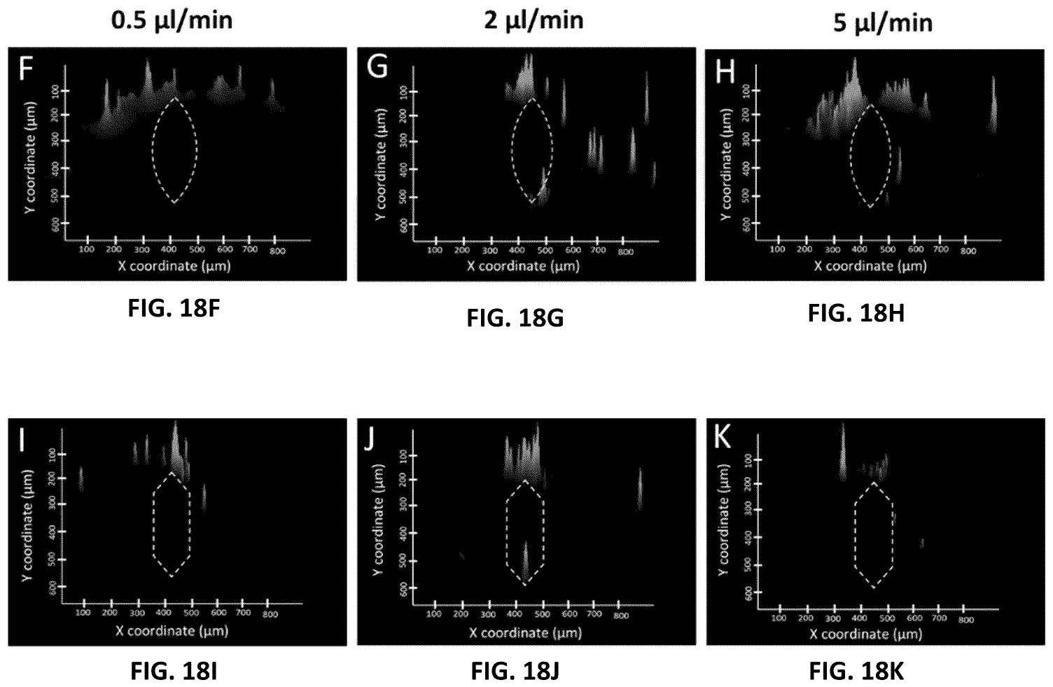

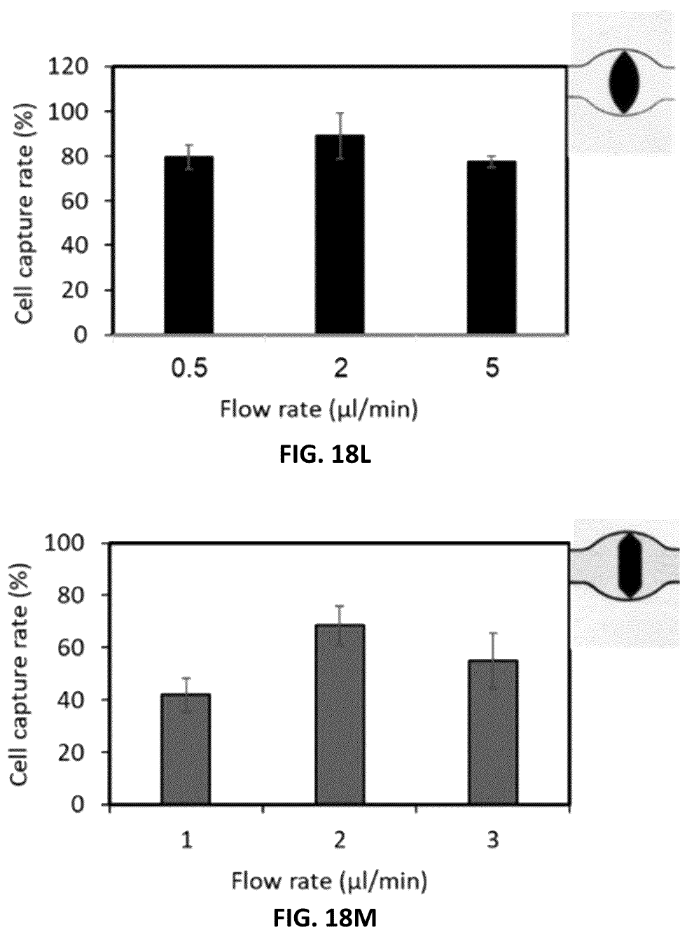

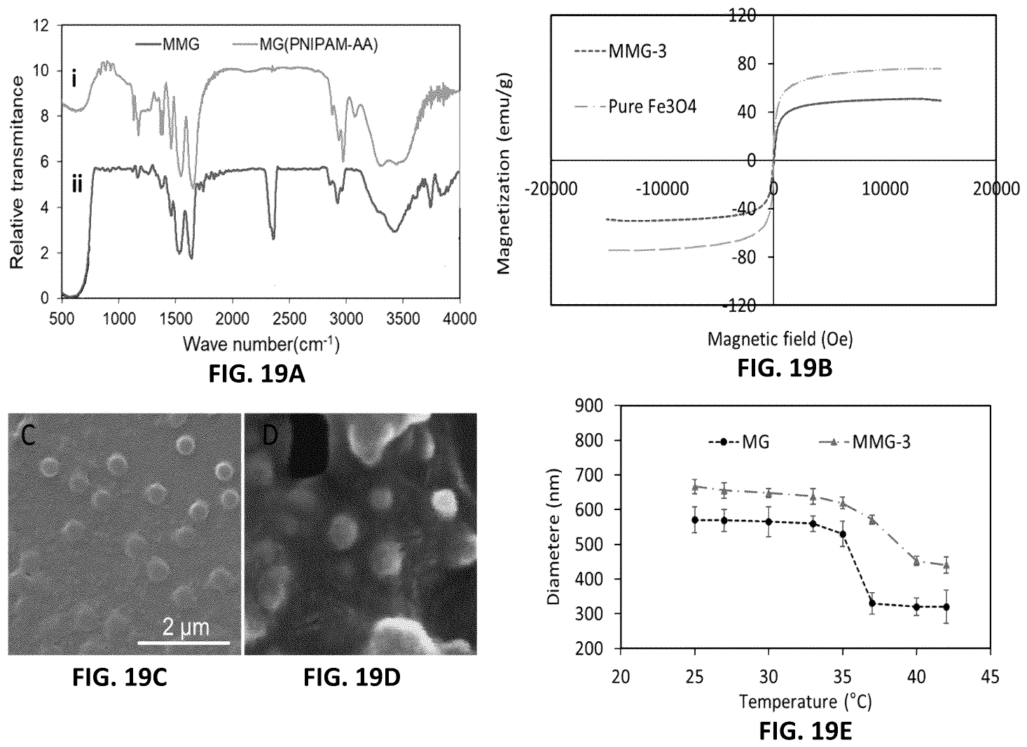

On-chip tumor cell capturing optimization: A previous study developed magnetic nano/hybrid microgels for efficient antibody conjugation and targeted cell capturing³⁸. The current study used these microgels with optimized anti-EPCAM conjugation at an antibody concentration of 100 μg/mL for targeted MCF-7 cell capturing. As illustrated in FIG. 18, magnetic nano/hybrid microgel-labeled cells were injected into the sheath flow of the channel, while the core flow liquid was DMEM to direct the cell suspension towards the side walls of the channel. This strategy improved the chances of capturing magnetic nano/hybrid microgel-labeled-cells at the tips of the micromagnets (FIGS. 18C and 18D). In a sample that included both target cells (MCF-7) and non-target blood cells (Jurkat), the antibody conjugated nano/hybrid microgels did not label the Jurkat cells. Thus, using a suitable flow rate, targeted MCF-7 cells could be captured in the chambers (FIGS. 18B and 18C). Moreover, due to the superparamagnetic properties of the synthesized magnetic nano/hybrid microgels (FIGS. 19A-19E), cells could be released from the micromagnets for downstream applications by removing the external magnetic field and applying back flow. FIGS. 18D and 18E show MCF-7 cells captured in a chamber near the tip of a micromagnet and their release after removing the permanent magnets.

To investigate the cancer cell capture efficiency of the microfluidic device design, followed by the optimized parameters reported above, 1 mg/mL of the antibody conjugated magnetic nano/hybrid microgels were incubated with a 1 mL suspension of 6×10² MCF-7 cells per mL expressing the EpCAM receptor for 10 min at 37° C.

FIGS. 18F-18K depict a 2.5-dimensional (2.5D) view of the DAPI stained MCF-7 cells after capture in the center chamber of the chip (the 20^{th} chamber) at inlet flow rates of 0.5, 2, or 5 μL/min. The figures show the fluorescence density distribution of the cells around the micromagnet, showing that the cells are more concentrated around the arrow micromagnet tip, but the total number of captured cells is less than that captured near the tip of the ellipsoidal micromagnet. This can be explained by the greater local magnetic field that is generated by the ellipsoidal micromagnets and thus the magnetic nano/hybrid microgel-labeled cells tend to be captured at greater distances from the ellipsoidal micromagnet tip. In contrast, for the ellipsoidal micromagnets the total number of captured cells in the entire chip is greater than for the arrow-shaped micromagnets. FIGS. 18L and 18M also show that according to primary capturing optimization experiments, a flow rate of 2 μL/min resulted in the highest capture rate in both micromagnet geometries.

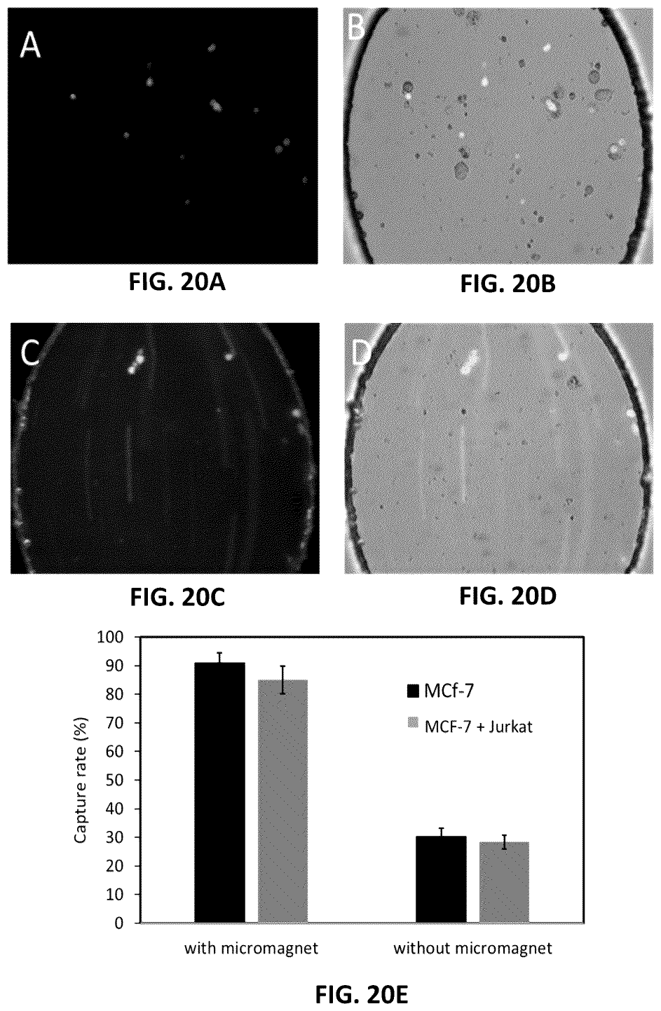

Next, the effect of permeant magnets in the absence of micromagnets was analyzed to determine the contribution of the micromagnets to the capture efficiency. As shown in FIG. 20, due to the presence of a uniform magnetic field at the center of the channel (middle of zone 3), magnetic nano/hybrid microgel-labeled target cells stained with DAPI did not deviate towards the chamber walls, and instead remained near the center of the channel. Similar to results above, the non-target Jurkat cells passed through the channel without being captured, as shown by the green fluorescent stream lines in FIGS. 20C and 20D. The results of captured cell enumeration following the experiments without micromagnets demonstrated the significance of using micromagnets inside the microfluidic device (FIG. 20E). The capture rate in the absence of micromagnets was 30% and less for both the MCF-7 cell and the MCF-7+Jurkat cell capturing conditions.

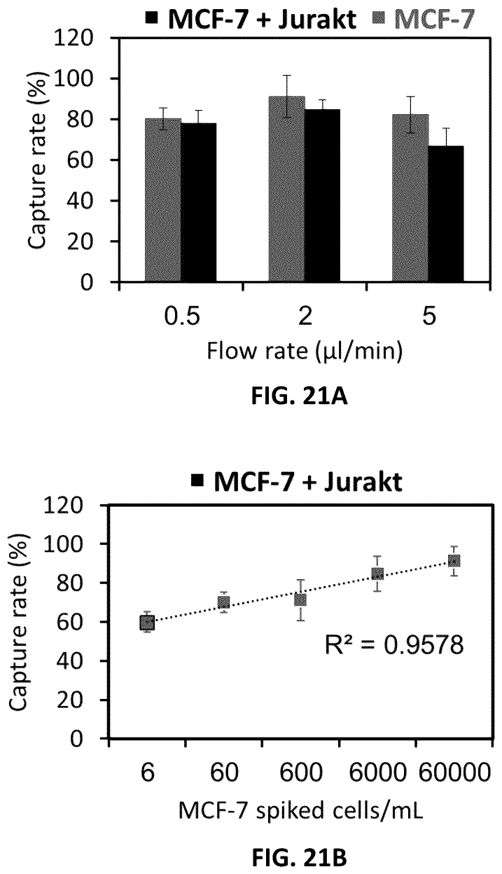

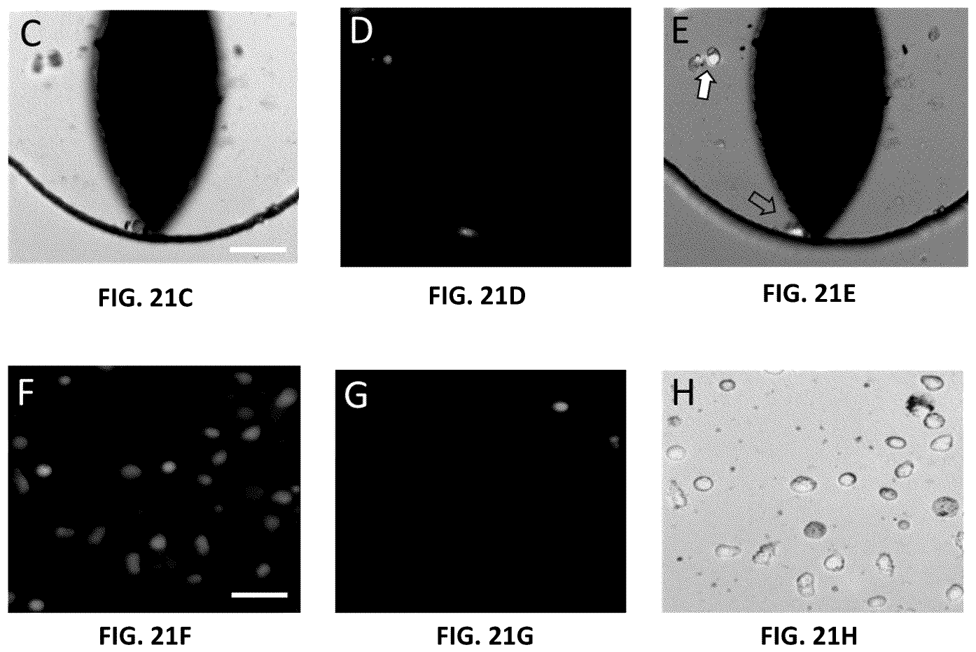

To investigate the efficiency of the anti-EpCAM-coated nano/hybrid microgels, the magnetic nano/hybrid microgel-coated cells were injected through the inlet of the channel, and MCF-7 cells (6×10³ cells/mL) were separated from Jurkat cells (6×10⁶ cells/mL) in the mixture. As shown in FIG. 21A, the total capture rate was approximately 89% for the flow rate of 2 μL/min, which was in accordance with the optimization studies for this flow rate. Additionally, by increasing the spiked cell number from 6 to 6×10⁴ cell/mL of the culture media, on-chip trapping efficiency increased from 62% to 91%, respectively (FIG. 21B). These experiments showed the efficacy of the antibody conjugated nano/hybrid microgels and the magnetic microfluidic platform for capture and detection of specific rare cancer cells in a mixed solution. The purity of the entrapped cells in the chambers was examined when the input solution contained 6×10³ target cancer cells mixed with 6×10⁶ non-target blood cells (Jurkat). The target and non-target cells were stained with DAPI and green fluorescent dyes, respectively, allowing for real-time monitoring on the microfluidic chip through fluorescent microscopy. Using the antibody coated nano/hybrid microgels in the presence of ellipsoidal micromagnets, the targeted cells were captured at a purity of approximately 87%. The majority of cells that flowed through the outlet of the microfluidic device during the capturing process were non-targeted, green-stained Jurkat cells as shown in FIGS. 21F-21H. The magnetic microfluidic platform described in this study effectively increased the capture purity in comparison to a previous study using the same antibody conjugated magnetic nano/hybrid microgels. In the present study, due to continuous sheath flow of the sample liquid containing the targeted cells, the probability of trapping nontarget cells is decreased and non-target cells are washed out by the continuous flow. FIGS. 21C-21E show that green fluorescent Jurkat cells were not attracted towards the micromagnet tip, and instead passed through the channel. Conversely, magnetized MCF-7 cells were captured in the chambers of the channel. These results show that the ligand-conjugated magnetic nano/hybrid microgels in combination with the microfluidic platform described herein are a powerful tool for specific, rare cell capture, detection, and isolation.

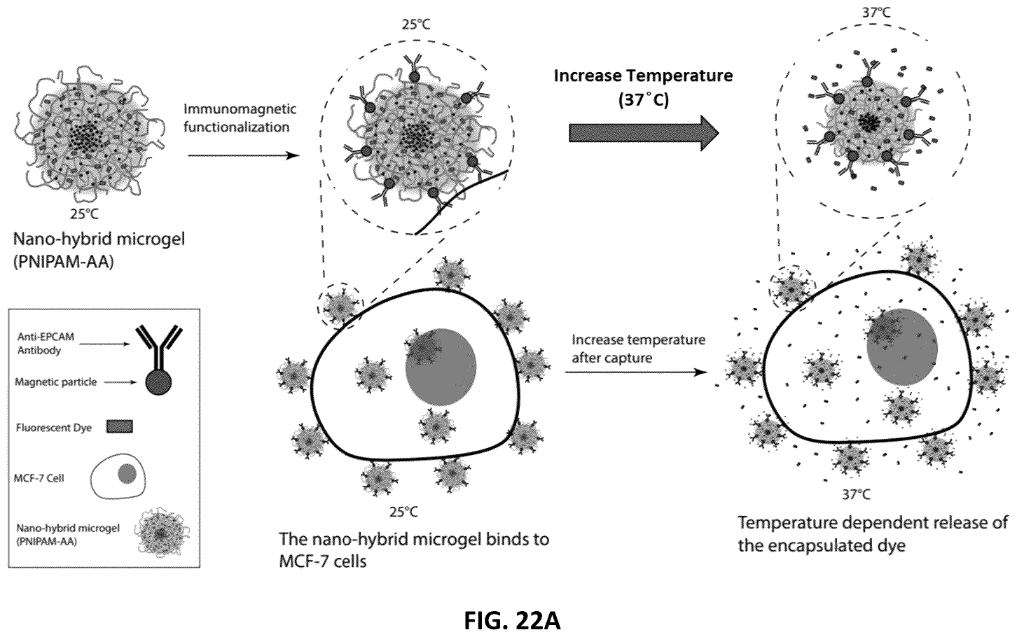

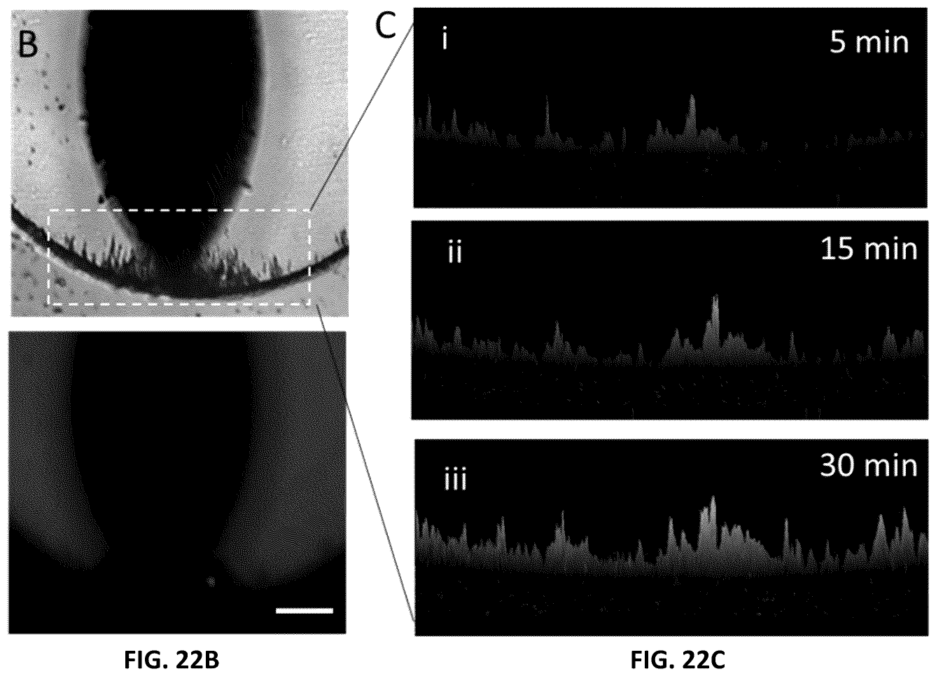

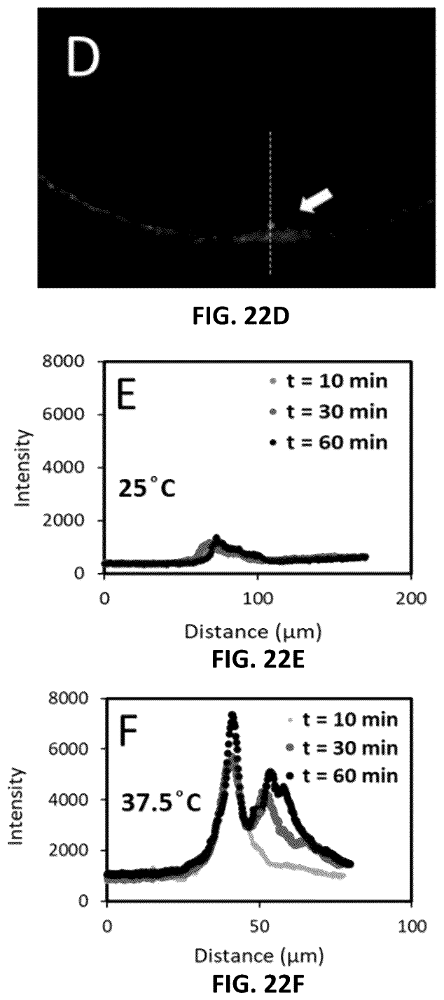

Tumor cell immobilization and real-time monitoring: The developed magnetic nano/hybrid microgels exhibit smart, thermo-responsive behavior. As shown in FIG. 19E, by incorporating magnetic nanoparticles inside the PNIPAM-AA microgel structure, the lower critical solution temperature (LCST) of the nano/hybrid microgels shifted to a higher temperature (37° C.) as compared to pure PNIPAM-AA (34° C.). This shift leads to structural shrinkage of the gels (660 μm to 450 μm) at 37° C. in comparison to the pure PNIPAM-AA microgel. We used this property for in-situ staining of the captured cells in the microfluidic device. As shown in FIG. 22, followed by cell marker fluorescent dye loading of the magnetic nano/hybrid microgels at concentration of 1 mg/mL, a significant difference between the cumulative release profiles of the magnetic nano/hybrid microgels at two working temperatures of 25° C. and 37° C. was detected. The mechanism of the dye release at the elevated working temperature is illustrated in FIG. 22A. As described above, at temperatures above the LCST of the magnetic nano/hybrid microgels, structural shrinkage along with a reduction in pore size occurs, and hence the payload of the magnetic nano/hybrid microgels is released into their environment. Using this characteristic, the tumor cells inside the channel were stained and monitored in real-time to observe the capturing process. Following the CTC capture process, the microfluidic device was incubated at 37.5° C. for 5, 15, and 30 min, and as shown in FIGS. 22B and 22C(i-iii), both the fluorescence intensity and the area of fluorescence are increased over the time.

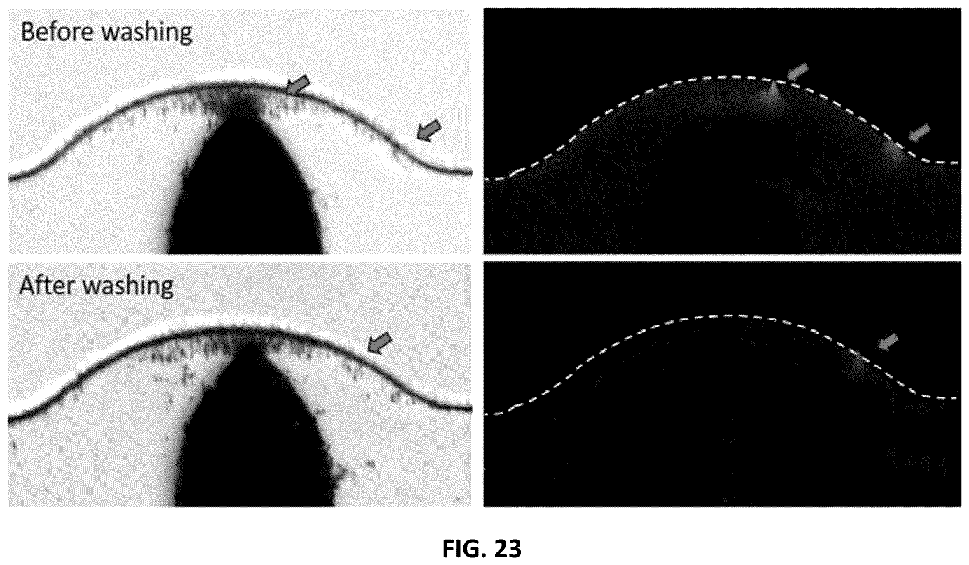

These results show that the magnetic nano/hybrid microgels (with their temperature sensitive dye release capabilities) can be used for efficient, smart and real-time monitoring of captured cells without negatively impacting cell efficacy (e.g., without leading to cell loss), such as during the processes of washing and staining. As another proof of concept, an Ag nanocluster cell marker (a cell staining fluorescent dye) at concentration of 1 mg/mL was loaded in the hybrid microgel structure for 24 hours at 4° C. Followed by 3 iterations of washing with PBS and centrifuging, the capture procedure was conducted under the same conditions as described above. As shown in FIGS. 22D-22F, there was a significant difference between the fluorescent intensity profiles of the captured cell at two different incubation temperatures. At 25° C. (FIG. 22E), no significant dye release was observed and the fluorescence intensity of the target cell was not changed remarkably over time from 5 to 30 min. In contrast, by incubating the microfluidic device at 37.5° C., the loaded fluorescent dye is gradually released over time. Ag-nanocluster probes can rapidly penetrate through the cell membrane and due to their intrinsic fluorescent properties, when they reach the cell cytoplasm, they can identify cells when observed using fluorescent microscopy. As such, the fluorescent intensity of the target cell increased over time up to a relative fluorescent intensity index of 7800. As indicated in FIG. 23, after 2 on-chip washing steps with PBS for 5 minutes each, the fluorescent intensity of the magnetic nano/hybrid microgels decreased due to payload depletion. At the same time, stained cells retained fluorescent signals. This confirms the penetration and persistence of the nanoclusters inside the cell cytosol over time. The on-demand dye release characteristics of the magnetic nano/hybrid microgels can be also used for further on-chip (in situ) biological studies, such as drug testing on single cells captured inside the chambers. Through capturing, detecting, in-situ analysis, and/or isolation of captured biomarkers, the disclosed technology can be used for high throughput screening of drugs, such as anti-cancer therapeutics, and for testing patient-derived CTCs in personalized cancer medicine. Similarly, the disclosed device enables monitoring of disease progression (such as cancer progression) and response to treatment in patients.

### REFERENCES

1. Castro-Giner, F.; Aceto, N., Tracking cancer progression: from circulating tumor cells to metastasis. Genome Medicine 2020, 12 (1), 31.
2. Rossi, E.; Zamarchi, R., Single-Cell Analysis of Circulating Tumor Cells: How Far Have We Come in the -Omics Era? Frontiers in Genetics 2019, 10 (958).
3. Duan, G.-C.; Zhang, X.-P.; Wang, H.-E.; Wang, Z.-K.; Zhang, H.; Yu, L.; Xue, W.-F.; Xin, Z.-F.; Hu, Z.-H.; Zhao, Q.-T., Circulating tumor cells as a screening and diagnostic marker for early-stage non-small cell lung cancer. OncoTargets and therapy 2020, 13, 1931.
4. Tellez-Gabriel, M.; Knutsen, E.; Perander, M., Current status of circulating tumor cells, circulating tumor DNA, and exosomes in breast cancer liquid biopsies. International Journal of Molecular Sciences 2020, 21 (24), 9457.
5. Wang, Y.; Yu, X.; Hartmann, D.; Zhou, J., Circulating tumor cells in peripheral blood of pancreatic cancer patients and their prognostic role: a systematic review and meta-analysis. HPB 2020, 22 (5), 660-669.
6. Cohen, S. J.; Punt, C.; Iannotti, N.; Saidman, B. H.; Sabbath, K. D.; Gabrail, N. Y.; Picus, J.; Morse, M.; Mitchell, E.; Miller, M. C., Relationship of circulating tumor cells to tumor response, progression-free survival, and overall survival in patients with metastatic colorectal cancer. 2008.
7. Shishido, S. N.; Carlsson, A.; Nieva, J.; Bethel, K.; Hicks, J. B.; Bazhenova, L.; Kuhn, P., Circulating tumor cells as a response monitor in stage IV non-small cell lung cancer. Journal of translational medicine 2019, 17 (1), 1-14.
8. Wang, J.; Dong, H.-y.; Zhou, Y.; Han, L.-y.; Zhang, T.; Lin, M.; Wang, C.; Xu, H.; Wu, Z.-S.; Jia, L., Immunomagnetic antibody plus aptamer pseudo-DNA nanocatenane followed by rolling circle amplication for highly-sensitive CTC detection. Biosensors and Bioelectronics 2018, 122, 239-246.
9. Bai, L.; Du, Y.; Peng, J.; Liu, Y.; Wang, Y.; Yang, Y.; Wang, C., Peptide-based isolation of circulating tumor cells by magnetic nanoparticles. Journal of Materials Chemistry B 2014, 2 (26), 4080-4088.
10. Riethdorf, S.; O'Flaherty, L.; Hille, C.; Pantel, K., Clinical applications of the CellSearch platform in cancer patients. Advanced drug delivery reviews 2018, 125, 102-121.
11. Jou, H.-J.; Chou, L.-Y.; Chang, W.-C.; Ho, H.-C.; Zhang, W.-T.; Ling, P.-Y.; Tsai, K.-H.; Chen, S.-H.; Chen, T.-H.; Lo, P.-H., An automatic platform based on nanostructured microfluidic chip for isolating and identification of circulating tumor cells. Micromachines 2021, 12 (5), 473.
12. Nagrath, S.; Sequist, L. V.; Maheswaran, S.; Bell, D. W.; Irimia, D.; Ulkus, L.; Smith, M. R.; Kwak, E. L.; Digumarthy, S.; Muzikansky, A., Isolation of rare circulating tumour cells in cancer patients by microchip technology. Nature 2007, 450 (7173), 1235-1239.
13. Kwizera, E. A.; Sun, M.; White, A. M.; Li, J.; He, X., Methods of Generating Dielectrophoretic Force for Microfluidic Manipulation of Bioparticles. ACS Biomaterials Science & Engineering 2021.
14. Sun, M.; Xu, J.; Shamul, J. G.; Lu, X.; Husain, S.; He, X., Creating a capture zone in microfluidic flow greatly enhances the throughput and efficiency of cancer detection. Biomaterials 2019, 197, 161-170.
15. Chen, J.; Yang, Z.; Xu, W.; Yi, M.; Zhong, M.; Li, X.; Tian, H., Sorting of circulating tumor cells based on the microfluidic device of a biomimetic splenic interendothelial slit array. Microfluidics and Nanofluidics 2021, 25 (7), 1-13.
16. Fukuyama, S.; Kumamoto, S.; Nagano, S.; Hitotsuya, S.; Yasuda, K.; Kitamura, Y.; Iwatsuki, M.; Baba, H.; Ihara, T.; Nakanishi, Y., Detection of cancer cells in whole blood using a dynamic deformable microfilter and a nucleic acid aptamer. Talanta 2021, 228, 122239.
17. Cho, H.; Chung, J. I.; Kim, J.; Seo, W. I.; Lee, C. H.; Morgan, T. M.; Byun, S. S.; Chung, J. S.; Han, K. H., Multigene model for predicting metastatic prostate cancer using circulating tumor cells by microfluidic magnetophoresis. Cancer science 2021, 112 (2), 859.
18. Stevens, M.; Liu, P.; Niessink, T.; Mentink, A.; Abelmann, L.; Terstappen, L., Optimal Halbach Configuration for Flow-through Immunomagnetic CTC Enrichment. Diagnostics 2021, 11 (6), 1020.
19. Lin, Z.; Lin, S.-Y.; Xie, P.; Lin, C.-Y.; Rather, G. M.; Bertino, J. R.; Javanmard, M., Rapid Assessment of Surface Markers on cancer cells Using immuno-Magnetic Separation and Multi-frequency impedance cytometry for targeted therapy. Scientific reports 2020, 10 (1), 1-10.
20. Williams, P. S.; Moore, L. R.; Joshi, P.; Goodin, M.; Zborowski, M.; Fleischman, A., Microfluidic chip for graduated magnetic separation of circulating tumor cells by their epithelial cell adhesion molecule expression and magnetic nanoparticle binding. Journal of Chromatography A 2021, 1637, 461823.
21. Chiu, T.-K.; Chao, A.-C.; Chou, W.-P.; Liao, C.-J.; Wang, H.-M.; Chang, J.-H.; Chen, P.-H.; Wu, M.-H., Optically-induced-dielectrophoresis (ODEP)-based cell manipulation in a microfluidic system for high-purity isolation of integral circulating tumor cell (CTC) clusters based on their size characteristics. Sensors and Actuators B: Chemical 2018, 258, 1161-1173.
22. Ren, X.; Foster, B. M.; Ghassemi, P.; Strobl, J. S.; Kerr, B. A.; Agah, M., Entrapment of prostate cancer circulating tumor cells with a sequential size-based microfluidic chip. Analytical chemistry 2018, 90 (12), 7526-7534.
23. Belotti, Y.; Lim, C. T., Microfluidics for Liquid Biopsies: Recent Advances, Current Challenges, and Future Directions. Analytical Chemistry 2021, 93 (11), 4727-4738.
24. Wang, Z.; Wu, W.; Wang, Z.; Tang, Y.; Deng, Y.; Xu, L.; Tian, J.; Shi, Q., Ex vivo expansion of circulating lung tumor cells based on one-step microfluidics-based immunomagnetic isolation. Analyst 2016, 141 (12), 3621-3625.
25. Zhou, R.; Yang, Q.; Bai, F.; Werner, J. A.; Shi, H.; Ma, Y.; Wang, C., Fabrication and integration of microscale permanent magnets for particle separation in microfluidics. Microfluidics and Nanofluidics 2016, 20 (7), 1-12.
26. Jaiswal, D.; Rad, A. T.; Nieh, M.-P.; Claffey, K. P.; Hoshino, K., Micromagnetic cancer cell immobilization and release for real-time single cell analysis. Journal of Magnetism and Magnetic Materials 2017, 427, 7-13.
27. Esmaeilsabzali, H.; Beischlag, T. V.; Cox, M. E.; Dechev, N.; Parameswaran, A. M.; Park, E. J., An integrated microfluidic chip for immunomagnetic detection and isolation of rare prostate cancer cells from blood. Biomedical microdevices 2016, 18 (1), 22.
28. Mishra, A.; Dubash, T. D.; Edd, J. F.; Jewett, M. K.; Garre, S. G.; Karabacak, N. M.; Rabe, D. C.; Mutlu, B. R.; Walsh, J. R.; Kapur, R., Ultrahigh-throughput magnetic sorting of large blood volumes for epitope-agnostic isolation of circulating tumor cells. Proceedings of the National Academy of Sciences 2020, 117 (29), 16839-16847.
29. Cho, H.; Chung, J.-S.; Han, K.-H., A Direct Comparison between the Lateral Magnetophoretic Microseparator and AdnaTest for Isolating Prostate Circulating Tumor Cells. Micromachines 2020, 11 (9), 870.
30. Kim, J.; Cho, H.; Han, S.-I.; Han, K.-H., Single-cell isolation of circulating tumor cells from whole blood by lateral magnetophoretic microseparation and microfluidic dispensing. Analytical chemistry 2016, 88 (9), 4857-4863.
31. Xiang, A.; Xue, M.; Ren, F.; Wang, L.; Ye, Z.; Li, D.; Ji, Q.; Ji, G.; Lu, Z., High-throughput and continuous flow isolation of rare circulating tumor cells and clusters in gastric cancer from human whole blood samples using electromagnetic vibration-based filtration. Oncology reports 2020, 43 (6), 1975-1985.
32. Kang, J. H.; Krause, S.; Tobin, H.; Mammoto, A.; Kanapathipillai, M.; Ingber, D. E., A combined micromagnetic-microfluidic device for rapid capture and culture of rare circulating tumor cells. Lab on a Chip 2012, 12 (12), 2175-2181.
33. Liu, Y.; Zhao, W.; Cheng, R.; Harris, B. N.; Murrow, J. R.; Hodgson, J.; Egan, M.; Bankey, A.; Nikolinakos, P. G.; Laver, T., Fundamentals of integrated ferrohydrodynamic cell separation in circulating tumor cell isolation. Lab on a Chip 2021, 21 (9), 1706-1723.
34. Gusenbauer, M.; Schrefl, T., Simulation of magnetic particles in microfluidic channels. Journal of Magnetism and Magnetic Materials 2018, 446, 185-191.
35. Descamps, L.; Le Roy, D.; Tomba, C.; Deman, A.-I., Magnetic Polymers for Magnetophoretic Separation in Microfluidic Devices. Magnetochemistry 2021, 7 (7), 100.
36. Freedman, A. N.; Klabunde, C. N.; Wiant, K.; Enewold, L.; Gray, S. W.; Filipski, K. K.; Keating, N. L.; Leonard, D. G.; Lively, T.; McNeel, T. S., Use of next-generation sequencing tests to guide cancer treatment: results from a nationally representative survey of oncologists in the United States. JCO Precision Oncology 2018, 2, 1-13.
37. Jin, L.; Fan, W.-H.; Luan, Y.; Wu, M.; Zhao, W., Evaluation of circulating tumor cells as a prognostic biomarker for early recurrence in stage II-III breast cancer patients using CytoSorter® system: a retrospective study. Peer J 2021, 9, e11366.
38. Seyfoori, A.; Seyyed Ebrahimi, S.; Samiei, E.; Akbari, M., Multifunctional Hybrid Magnetic Microgel Synthesis for Immune-Based Isolation and Post-Isolation Culture of Tumor Cells. ACS applied materials & interfaces 2019, 11 (28), 24945-24958.
39. Seyfoori, A.; Ebrahimi, S. S.; Yousefi, A.; Akbari, M., Efficient targeted cancer cell detection, isolation and enumeration using immuno-nano/hybrid magnetic microgels. Biomaterials science 2019, 7 (8), 3359-3372.
40. Shamsipur, M.; Chabok, A.; Molaabasi, F.; Seyfoori, A.; Hajipour-Verdom, B.; Shojaedin-Givi, B.; Sedghi, M.; Naderi-Manesh, H.; Yeganeh-Faal, A., Label free phosphate functionalized semiconducting polymer dots for detection of iron(III) and cytochrome c with application to apoptosis imaging. Biosensors and Bioelectronics 2019, 141, 111337.
41. Chen, P.; Huang, Y.-Y.; Hoshino, K.; Zhang, J. X. J., Microscale Magnetic Field Modulation for Enhanced Capture and Distribution of Rare Circulating Tumor Cells. Scientific Reports 2015, 5 (1), 8745.
42. Dalili, A.; Samiei, E.; Hoorfar, M., A review of sorting, separation and isolation of cells and microbeads for biomedical applications: Microfluidic approaches. Analyst 2019, 144 (1), 87-113.

### Additional Examples of the Disclosed Technology

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A microfluidic device, comprising a channel, comprising converging and diverging portions; and a plurality of magnets arranged next to the channel; wherein the plurality of magnets is arranged to apply a magnetic field across the channel to capture magnetic particles in diverging portions of the channel where a velocity of a liquid in the channel is reduced.

Example 2. The microfluidic device of any example herein, particularly example 1, wherein the plurality of magnets comprises a first magnet on a first side of the channel, a second magnet on a second side of the channel, and a third magnet on a third side of the channel.

Example 3. The microfluidic device of any example herein, particularly example 1 or example 2, wherein the first magnet is beneath the channel.

Example 4. The microfluidic device of any example herein, particularly any one of examples 1-3, wherein the channel is disposed between the second magnet and the third magnet.

Example 5. The microfluidic device of any example herein, particularly any one of examples 1-4, wherein the channel is equidistant from the second magnet and the third magnet.

Example 6. The microfluidic device of any example herein, particularly any one of examples 2-5, wherein the plurality of magnets further comprises a fourth magnet; the first and second magnets are on the first side of the channel, the third and fourth magnets are on the second side of the channel, and the first and second magnets are on an opposite side of the channel from the third and fourth magnets; the channel is between the first magnet and the fourth magnet, and the first and fourth magnets are between the second and third magnets; and the channel, the first magnet, the second magnet, the third magnet, and the fourth magnet are all arranged on a plane.

Example 7. The microfluidic device of any example herein, particularly example 6, wherein the first magnet and the fourth magnet are aligned with the chambers of the channel along a direction of flow.

Example 8. The microfluidic device of any example herein, particularly example 6 or example 7, wherein the channel is equidistant from the first magnet and the fourth magnet, and the channel is equidistant from the second magnet and the third magnet.

Example 9. The microfluidic device of any example herein, particularly any one of examples 1-8, wherein a south pole of the first magnet is arranged opposite a north pole of the second magnet, or a north pole of the first magnet is opposite a south pole of the second magnet; a south pole of the first magnet is arranged opposite a north pole of the third magnet, or a north pole of the first magnet is opposite a south pole of the third magnet; a south pole of the second magnet is arranged opposite a north pole of the third magnet or a north pole of the second magnet is arranged opposite a south pole of the third magnet; and/or a south pole of the first magnet is arranged opposite a north pole of the fourth magnet or a north pole of the first magnet is arranged opposite a south pole of the fourth magnet.

Example 10. The microfluidic device of any example herein, particularly any one of examples 1-9 wherein the first magnet comprises a soft, superparamagnetic material.

Example 11. The microfluidic device of any example herein, particularly any one of examples 6-9, wherein the fourth magnet comprises a soft, superparamagnetic material.

Example 12. The microfluidic device of any example herein, particularly example 11, wherein the soft, superparamagnetic material comprises superparamagnetic iron oxide nanoparticles (SPIONS), a ferrite, or iron particles.

Example 13. The microfluidic device of any example herein, particularly example 12, wherein the ferrite is MnFe₂O₄, gamma-Fe₂O₃ nanopowder, ZnFe₂O₄, nickel ferrite, Mg-nickle ferrite, or Fe₃O₄.

Example 14. The microfluidic device of any one of claims 1-13, wherein the second and third magnets are permanent magnets or electromagnets.

Example 15. The microfluidic device of any example herein, particularly any one of examples 1-14, wherein the second and third magnets comprise neodymium (NdFeB), samarium cobalt (SmCo), AlNiCo (aluminum, nickel, and cobalt), or ferrite.

Example 16. The microfluidic device of any example herein, particularly any one of examples 1-15, wherein the first magnet is one magnet of an array of magnets; the number of magnets in the array of magnets is equal to a number of chambers of the channel, wherein a chamber comprises a portion of the channel wherein the walls of the channel diverge in the direction of flow to a widest portion of the diverging portion, and subsequently converge from the widest portion to a narrowest portion; and the magnets of the array of magnets are spaced apart along the direction of flow through the channel.

Example 17. The microfluidic device of any example herein, particularly example 15 or example 16, wherein the array of magnets is aligned with the chambers of the channel along a direction of flow.

Example 18. The microfluidic device of any example herein, particularly any one of examples 15-17, wherein each magnet of the array of magnets has an ellipsoid shape or an arrow shape.

Example 19. The microfluidic device of any example herein, particularly any one of examples 1-18, wherein a length dimension of each magnet of the array of magnets has a greater numerical value than a width dimension of each magnet of the array of magnets; and each magnet of the array of magnets is arranged such that the length dimension is perpendicular to a flow direction of the channel and the width dimension is along the flow direction.

Example 20. The microfluidic device of any example herein, particularly example 19, wherein each magnet of the array of magnets has the same length dimension; and each magnet of the array of magnets has the same width dimension.

Example 21. The microfluidic device of any example herein, particularly example 19 or example 20, wherein the length dimension of each magnet of the array of magnets is about equal to a widest diameter of each of the chambers of the channel.

Example 22. The microfluidic device of any example herein, particularly any one of examples 19-21, wherein a center of each magnet of the array of magnets is aligned beneath a center of a chamber of the channel, and each magnet of the array of magnets is arranged such that the length dimension of each magnet is perpendicular to the flow direction of the channel.

Example 23. The microfluidic device of any example herein, particularly any one of examples 1-22, wherein the channel further comprises a plurality of inlets and a plurality of outlets.

Example 24. The microfluidic device of any example herein, particularly example 23, wherein the plurality of inlets comprises a first inlet and second inlet.

Example 25. The microfluidic device of any example herein, particularly example 23 or example 24, wherein the plurality of outlets comprises a first outlet.

Example 26. The microfluidic device of any example herein, particularly example 25, wherein the plurality of outlets further comprises a second outlet.

Example 27. The microfluidic device of any example herein, particularly example 26, wherein the first inlet and the second inlet are fluidly coupled to the channel; and the first outlet, and optionally the second outlet, are fluidly coupled to the channel.

Example 28. The microfluidic device of any example herein, particularly example 26 or example 27, wherein the second inlet comprises a first channel and a second channel; and the first inlet, the first channel of the second inlet, and the second channel of the second inlet are fluidly coupled to the channel such that the first inlet is fluidly coupled to a center of the channel, the first channel of the second inlet is fluidly coupled to the channel between the center of the channel and a first wall of the channel; the second channel of the second inlet is fluidly coupled to the channel between the center of the channel and a second wall of the channel; and the first wall of the channel and the second wall of the channel are on opposite sides of the center of the channel.

Example 29. The microfluidic device of any example herein, particularly any one of examples 26-28, wherein the second inlet communicates with the channel radially outward of the first inlet.

Example 30. The microfluidic device of any example herein, particularly any one of examples 26-29, wherein: the first inlet communicates with the channel along a longitudinal axis of the channel; and the second inlet communicates with the channel radially outward of the longitudinal axis of the channel such that liquid injected into the channel through the second inlet is radially outward of liquid injected into the channel through the first inlet.

Example 31. The microfluidic device of any example herein, particularly any one of examples 26-30, wherein the second outlet comprises a first channel and a second channel; and the first outlet, the first channel of the second outlet, and the second channel of the second outlet are fluidly coupled to the channel such that the first outlet is fluidly coupled to the center of the channel, the first channel of the second outlet is fluidly coupled to the channel between the center of the channel and the first wall of the channel; the second channel of the second outlet is fluidly coupled to the channel between the center of the channel and the second wall of the channel; and the first wall of the channel and the second wall of the channel are on opposite sides of the center of the channel.

Example 32. The microfluidic device of any example herein, particularly any one of examples 26-31, wherein the second outlet communicates with the channel radially outward of the first outlet.

Example 33. The microfluidic device of any example herein, particularly any one of examples 26-32, wherein: the first outlet communicates with the channel along the longitudinal axis of the channel; and the second outlet communicates with the channel radially outward of the longitudinal axis of the channel.

Example 34. The microfluidic device of any example herein, particularly any one of examples 1-33, wherein a widest diameter of the chambers of the channel and a widest diameter of connecting portions of the channel are in a ratio of 2:1 to 4:1, wherein each connecting portion of the channel is arranged between two chambers of the channel, and the widest diameter of the connecting portions is less than the widest diameter of chambers.

Example 35. The microfluidic device of any example herein, particularly any one of examples 1-34, comprising 1 to 50 chambers.

Example 36. The microfluidic device of any example herein, particularly any one of examples 1-35 comprising 24 or 40 chambers.

Example 37. The microfluidic device of any example herein, particularly any one of examples 1-35, wherein the channel and the plurality of magnets are arranged on a plurality of substrates.

Example 38. The microfluidic device of any example herein, particularly example 37, wherein the plurality of substrates comprises a first substrate and a second substrate.

Example 39. The microfluidic device of any example herein, particularly any one of examples 2-38 wherein the channel, the second magnet, and the third magnet are arranged on the first substrate.

Example 40. The microfluidic device of any example herein, particularly any one of examples 2-39, wherein the first magnet is arranged on the second substrate.

Example 41. The microfluidic device of any example herein, particularly any one of examples 6-39, wherein the second magnet, the first magnet, the channel, the fourth magnet, and the second magnet are arranged on a first substrate.

Example 42. The microfluidic device of any example herein, particularly any one of examples 37-41, wherein the plurality of substrates comprise a plastic, polydimethylsiloxane (PDMS), poly(ethylene glycol) diacrylate (PEGDA), cyclic olefin copolymer (COP), cyclic olefin polymer (COP), or any combination thereof.

Example 43. The microfluidic device of any example herein, particularly example 42 wherein the plastic is a thermoplastic.

Example 44. The microfluidic device of any example herein, particularly example 43, wherein the thermoplastic is poly(methyl methacrylate) (PMMA), polyester, polycarbonate, or any combination thereof.

Example 45. The microfluidic device of any example herein, particularly any one of examples 37-44, wherein the plurality of substrates are manufactured using soft-lithography, replica molding, 3D printing, injection molding, micromilling, hot embossing, or any combination thereof.

Example 46. The microfluidic device of any example herein, particularly any one of examples 40-45, wherein the first magnet is introduced to the first substrate or the second substrate using casting, 3D printing, sputter coating, soft lithography, or any combination thereof.

Example 47. The microfluidic device of any example herein, particularly any one of examples 38-46, wherein the first substrate is arranged above the second substrate such that the channel in the first substrate is located directly above and is aligned with the first magnet in the second substrate.

Example 48. A microfluidic device, comprising: a substrate defining a channel, the channel extending between an inlet and an outlet, the channel alternatingly widening and narrowing to define a plurality of chambers in a direction of flow along the channel between the inlet and the outlet; and a plurality of magnets arranged about the channel and configured to apply a magnetic field to the chambers to capture magnetic particles in the chambers,

Example 49. The microfluid device of any example herein, particularly example 48, wherein the plurality of magnets includes a first magnet array positioned beneath the channel.

Example 50. The microfluidic device of any example herein, particularly example 49, wherein: magnets of the first magnet array are aligned with the chambers; and the plurality of magnets further comprises a second magnet array comprising a plurality of permanent magnets arranged on opposite sides of the channel.

Example 51. A microfluidic device, comprising: a substrate defining a channel extending between an inlet and an outlet; and a plurality of magnets positioned beneath the channel and spaced apart along its length.

Example 52. The microfluidic device of any example herein, particularly example 51, wherein: the channel defines a plurality of chambers along a direction of flow; and magnets of the plurality of magnets are aligned with the chambers along the direction of flow.

Example 53. A method, comprising flowing a first liquid and a second liquid through the channel of the microfluidic device of any example herein, particularly any one of examples 1-52.

Example 54. The method of any example herein, particularly example 53, wherein the first liquid is introduced to the channel through the first inlet and the second liquid is introduced to the channel through the second inlet such that the first liquid displaces the second liquid outwardly toward walls of the channel.

Example 55. A method, comprising: in a microfluidic device comprising a channel, flowing a sample liquid through the channel, the sample liquid comprising magnetic particles; applying a magnetic field across the channel to direct the magnetic particles toward walls of the channel; and capturing the magnetic particles in portions of the channel where a velocity of the sample liquid is reduced.

Example 56. A method, comprising: in a microfluidic device comprising a channel, flowing a sample liquid through the channel, the sample liquid comprising magnetic particles; applying a magnetic field across the channel to direct the magnetic particles toward walls of the channel; and capturing at least 50% of the magnetic particles in portions of the channel where a velocity of the sample liquid is reduced.

Example 57. A method, comprising: in a microfluidic device comprising a channel, flowing a sample liquid through the channel, the sample liquid comprising magnetic particles; applying a magnetic field across the channel to direct the magnetic particles toward walls of the channel; and capturing at least 60% of the magnetic particles in portions of the channel where a velocity of the sample liquid is reduced.

Example 58. A method, comprising: in a microfluidic device comprising a channel, flowing a sample liquid through the channel, the sample liquid comprising magnetic particles; applying a magnetic field across the channel to direct the magnetic particles toward walls of the channel; and capturing at least 70% of the magnetic particles in portions of the channel where a velocity of the sample liquid is reduced.

Example 59. A method, comprising: in a microfluidic device comprising a channel, flowing a sample liquid through the channel, the sample liquid comprising magnetic particles; applying a magnetic field across the channel to direct the magnetic particles toward walls of the channel; and capturing at least 80% of the magnetic particles in portions of the channel where a velocity of the sample liquid is reduced.

Example 60. A method, comprising: in a microfluidic device comprising a channel, flowing a sample liquid through the channel, the sample liquid comprising magnetic particles; applying a magnetic field across the channel to direct the magnetic particles toward walls of the channel; and capturing at least 90% of the magnetic particles in portions of the channel where a velocity of the sample liquid is reduced.

Example 61. A method, comprising: in a microfluidic device comprising a channel, flowing a sample liquid through the channel, the sample liquid comprising magnetic particles; applying a magnetic field across the channel to direct the magnetic particles toward walls of the channel; and capturing at least 95% of the magnetic particles in portions of the channel where a velocity of the sample liquid is reduced.

Example 62. A method, comprising: (i) flowing a first liquid and a second liquid through the channel of the microfluidic device of any example herein, particularly any one of examples 1-52, wherein (a) the first liquid is introduced to the channel through the first inlet and the second liquid is introduced to the channel through the second inlet; (b) the second liquid comprises a sample and magnetic particles; (c) the magnetic particles comprise one or more ligands that specifically bind one or more biomarkers in the sample; and (ii) applying a magnetic field across the channel to capture the magnetic particles bound to the one or more biomarkers in the chambers of the channel.

Example 63. A method, comprising: (i) flowing a first liquid and a second liquid through the channel of the microfluidic device of any example herein, particularly any one of examples 1-52, wherein (a) the first liquid is introduced to the channel through the first inlet and the second liquid is introduced to the channel through the second inlet; (b) the second liquid comprises a sample and magnetic particles; (c) the magnetic particles comprise one or more ligands that specifically bind one or more biomarkers in the sample; (ii) applying a magnetic field across the channel to capture the magnetic particles bound to the one or more biomarkers in the divergent portions of the channel; and (iii) removing the one or more biomarkers bound to the magnetic particles from the microfluidic device; thereby isolating the one or more biomarkers.

Example 64. A method, comprising: (i) flowing a first liquid and a second liquid through the channel of the microfluidic device of any example herein, particularly any one of examples 1-52, wherein (a) the first liquid is introduced to the channel through the first inlet and the second liquid is introduced to the channel through the second inlet; (b) the second liquid comprises a sample and magnetic particles; (c) the magnetic particles comprise one or more ligands that specifically bind one or more biomarkers in the sample; and (ii) applying a magnetic field across the channel to direct the magnetic particles toward walls of the channel.

Example 65. A method, comprising: (i) flowing a first liquid and a second liquid through the channel of the microfluidic device of any example herein, particularly any one of examples 1-52, wherein (a) the first liquid is introduced to the channel through the first inlet and the second liquid is introduced to the channel through the second inlet; (b) the second liquid comprises a sample and magnetic particles; (c) the magnetic particles comprise one or more ligands that specifically bind one or more biomarkers in the sample; (ii) applying a magnetic field across the channel to direct the magnetic particles toward walls of the channel; and (iii) removing the one or more biomarkers bound to the magnetic particles from the microfluidic device; thereby isolating the one or more biomarkers.

Example 66. A method of isolating circulating tumor cells (CTCs) from a sample from a subject, comprising (i) flowing a first liquid and a second liquid through the channel of the microfluidic device of any example herein, particularly any one of examples 1-52, wherein (a) the first liquid is introduced to the channel through the first inlet and the second liquid is introduced to the channel through the second inlet; (b) the second liquid comprises the sample from the subject and magnetic particles; and (c) the magnetic particles comprise antibodies that specifically bind to epithelial cell adhesion molecule (EpCam) on CTCs in the sample; (ii) applying a magnetic field across the channel to direct the magnetic particles toward walls of the channel; and (iii) removing the CTCs bound to the magnetic particles from the microfluidic device; thereby isolating the CTCs.

Example 67. A method of diagnosing a condition or disease in a subject or predicting a survival outcome in a subject, comprising (i) flowing a first liquid and a second liquid through the channel of the microfluidic device of any example herein, particularly any one of examples 1-52, wherein (a) the first liquid is introduced to the channel through the first inlet and the second liquid is introduced to the channel through the second inlet; (b) the second liquid comprises a sample from the subject and magnetic particles; and (c) the magnetic particles comprise one or more ligands that specifically bind one or more biomarkers in the sample; (ii) applying a magnetic field across the channel to direct the magnetic particles toward walls of the channel; and (iii) detecting and/or measuring one or more biomarkers; thereby diagnosing the condition or disease in the subject or predicting the survival outcome in the subject.

Example 68. A method of diagnosing a cancer in a subject or predicting a survival outcome in a subject, comprising (i) flowing a first liquid and a second liquid through the channel of the microfluidic device of any example herein, particularly any one of examples 1-52, wherein (a) the first liquid is introduced to the channel through the first inlet and the second liquid is introduced to the channel through the second inlet; (b) the second liquid comprises a sample from the subject and magnetic particles; and (c) the magnetic particles comprise antibodies that specifically bind to epithelial cell adhesion molecule (EpCam) on CTCs in the sample; (ii) applying a magnetic field across the channel to direct the magnetic particles toward walls of the channel; and (iii) detecting and/or measuring one or more cancer biomarker in the CTCs; thereby diagnosing the cancer in the subject or predicting the survival outcome in the subject.

Example 69. A method of determining recurrence of a cancer in a subject, comprising (i) flowing a first liquid and a second liquid through the channel of the microfluidic device of any example herein, particularly any one of examples 1-52, wherein (a) the first liquid is introduced to the channel through the first inlet and the second liquid is introduced to the channel through the second inlet; (b) the second liquid comprises a sample from the subject and magnetic particles; and (c) the magnetic particles comprise antibodies that specifically bind to epithelial cell adhesion molecule (EpCam) on CTCs in the sample; (ii) applying a magnetic field across the channel to direct the magnetic particles toward walls of the channel; and (iii) detecting and/or measuring one or more cancer biomarkers in the CTCs; thereby determining recurrence of the cancer in the subject.

Example 70. A method of predicting metastasis of a cancer in a subject, comprising: (i) flowing a first liquid and a second liquid through the channel of the microfluidic device of any example herein, particularly any one of examples 1-52, wherein (a) the first liquid is introduced to the channel through the first inlet and the second liquid is introduced to the channel through the second inlet; (b) the second liquid comprises a sample from the subject and magnetic particles; and (c) the magnetic particles comprise antibodies that specifically bind to epithelial cell adhesion molecule (EpCam) on CTCs in the sample; (ii) applying a magnetic field across the channel to direct the magnetic particles toward walls of the channel; and (iii) detecting and/or measuring one or more cancer biomarkers in the CTCs; thereby predicting metastasis of the cancer in the subject.

Example 71. A method of treating a condition or disease in a subject, comprising (i) flowing a first liquid and a second liquid through the channel of the microfluidic device of any example herein, particularly any one of examples 1-52, wherein (a) the first liquid is introduced to the channel through the first inlet and the second liquid is introduced to the channel through the second inlet; (b) the second liquid comprises a sample from the subject and magnetic particles; and (c) the magnetic particles comprise one or more ligands that specifically bind to one or more biomarkers in the sample, wherein the presence of the one or more biomarker is indicative of the disease or condition; (ii) applying a magnetic field across the channel to direct the magnetic particles toward walls of the channel; (iii) detecting and/or measuring the one or more biomarkers; and (iv) administering one or more treatments for the condition or disease to the subject.

Example 72. A method of treating a cancer in a subject, comprising (i) flowing a first liquid and a second liquid through the channel of the microfluidic device of any example herein, particularly any one of examples 1-52, wherein (a) the first liquid is introduced to the channel through the first inlet and the second liquid is introduced to the channel through the second inlet; (b) the second liquid comprises a sample from the subject and magnetic particles; and (c) the magnetic particles comprise antibodies that specifically bind to epithelial cell adhesion molecule (EpCam) on CTCs in the sample; (ii) applying a magnetic field across the channel to direct the magnetic particles toward walls of the channel; (iii) detecting and/or measuring one or more cancer biomarkers in the CTCs; and (iv) administering one or more treatments for cancer to the subject.

Example 73. The method of any example herein, particularly example 71 or example 72, further comprising selecting the subject that is in need of the treatment.

Example 74. The method of any example herein, particularly any one of examples 55-65, wherein the sample liquid or the sample comprises a sample from a subject.

Example 75. The method of any example herein, particularly any one of examples 56-74, further comprising obtaining the sample from the subject.

Example 76. The method of any example herein, particularly any one of examples 62-65, 67, 71, or 73-75, wherein the biomarker is a cell, nucleotide, modified nucleotide, nucleic acid, peptide or protein, lipid, glycolipid, polysaccharide, extracellular vesicle, or metabolite.

Example 77. The method of any example herein, particularly example 76, wherein the cell is a circulating tumor cell.

Example 78. The method of any example herein, particularly example 76, wherein the extracellular vesicle is an exosome.

Example 79. The method of any example herein, particularly any one of examples 62-65, 67, 71, or 73-78, wherein the biomarker is EpCam, HER2, EGFR, CD4, CD8, or CD44.

Example 80. The method of any example herein, particularly any one of examples 55-79, further comprising concentrating the magnetic field at locations along the channel where the velocity of the sample liquid is reduced.

Example 81. The method of any example herein, particularly any one of examples 55-80, further comprising removing the magnetic particles from the microfluidic device after applying the magnetic field across the channel.

Example 82. The method of any example herein, particularly any one of examples 67-81, further comprising removing the one or more biomarkers bound to the magnetic particles from the microfluidic device after applying the magnetic field across the channel.

Example 83. The method of any example herein, particularly any one of examples 53-82, wherein a first drag force measured at the periphery of each of the chambers of the channel is lower than a second drag force measured at a center of each of the chambers of the channel; and a third drag force measured at a center of each of the converging portions of the channel.

Example 84. The method of any example herein, particularly any one of examples 53-82, wherein introducing the first liquid to the channel through the first inlet and introducing the second liquid to the channel through the second inlet produces a first drag force measured at the periphery of each of the chambers of the channel that is lower than (i) a second drag force measured at a center of each of the chambers of the channel and (ii) a third drag force measured at a center of each of the converging portions of the channel.

Example 85. The method of any example herein, particularly any one of examples 53-84, wherein the first liquid and the second liquid are aqueous liquids.

Example 86. The method of any example herein, particularly any one of examples 53-85, wherein the first liquid comprises a cell culture medium or phosphate-buffered saline (PBS).

Example 87. The method of any example herein, particularly example 86, wherein the cell culture medium is Dulbecco's Modified Eagle Medium (DMEM), Basal Medium Eagle (BME), Minimum Essential Medium (MEM), Ham's F-10 Nutrient Mixture Media, Ham's F-12 Nutrient Mixture Media, McCoy's 5A medium, a Roswell Park Memorial Institute (RPMI) medium, Medium 199, Human Plasma-like Medium (HPLM), or any derivations or combinations thereof.

Example 88. The method of any example herein, particularly example 53 or example 54, wherein the second liquid comprises a sample.

Example 89. The method of any example herein, particularly example 88, wherein the sample comprises a sample from a subject.

Example 90. The method of any example herein, particularly any one of examples 66-89, wherein the subject is a mammal.

Example 91. The method of any example herein, particularly any one of examples 66-90, wherein the subject is a human.

Example 92. The method of any example herein, particularly any one of examples 66-91, wherein the sample from the subject comprises tissue, whole blood, plasma, serum, stool/feces, saliva, sputum, urine, bronchoalveolar lavage, semen, cerebrospinal fluid (CSF), or breast milk.

Example 93. The method of any example herein, particularly any one of examples 53-92, wherein the first liquid and the second liquid are flowed through the channel at a rate of 0.5 to 50 μl per minute.

Example 94. The method of any example herein, particularly any one of examples 53-93, wherein the first liquid and the second liquid are flowed through the channel at a rate of 2 μl per minute.

Example 95. The method of any example herein, particularly any one of examples 55-94, wherein a strength of the magnetic field is 0.5 to 1.5 Tesla.

Example 96. The method of any example herein, particularly any one of examples 55-95, wherein the strength of the magnetic field is 1.3 Tesla.

Example 97. The method of any example herein, particularly example 53 or example 54, wherein the second liquid further comprises magnetic particles.

Example 98. The method of any example herein, particularly any one of examples 55-97, wherein a concentration of the magnetic particles in the second liquid is 6 particles per milliliter to 6×10⁴ particles per milliliter prior to introduction of the second liquid to the channel.

Example 99. The method of any example herein, particularly any one of examples 55-98, wherein the magnetic particles comprise magnetic microparticle hydrogels, magnetic nanoparticle hydrogels (nanogels), SPIONS, Dynabeads, paramagnetic polystyrene magnetic beads, or any combination thereof.

Example 100. The method of any example herein, particularly any one of examples 55-99, wherein the magnetic particles are 10 nm to 50 μm in diameter.

Example 101. The method of any example herein, particularly any one of examples 55-61 or 74-100, wherein the magnetic particles comprise one or more ligands that specifically bind one or more biomarkers.

Example 102. The method of any example herein, particularly any one of examples 62-101, wherein the one or more ligands comprises an antibody, an aptamer, biotin, avidin, streptavidin, or neutravidin.

Example 103. The method of any example herein, particularly any one of examples 62-65, 67, 71, or 73-101, wherein the one or more biomarkers is epithelial cell adhesion molecule (EpCam), HER2, EGFR, CD4, CD8, or CD44.

Example 104. The method of any example herein, particularly any one of examples 62-65, 67, 71, or 73-103, wherein the one or more ligands is an antibody and the one or more biomarkers is EpCam.

Example 105. A kit comprising the microfluidic device of any example herein, particularly any one of examples 1-52.

Example 106. The kit of any example herein, particularly example 105, further comprising: (i) instructions for use of the microfluidic device of any one of claims 1-52; (ii) a container comprising magnetic particles comprising one or more ligands that specifically bind to one or more biomarkers; (iii) a container comprising a liquid, wherein the liquid is a cell culture medium or PBS; (iv) one or more of a sample preparation reagent, a buffer, a detection reagent, or any combination thereof; or (v) any combination of (i)-(iv).

In view of the many possible embodiments to which the principles of the disclosed technology may be applied, it should be recognized that the illustrated embodiments are only examples and should not be taken as limiting the scope of the disclosure. Rather, the scope of the disclosure is at least as broad as the following claims and equivalents of the recited features. We therefore claim all that comes within the scope and spirit of these claims.

We claim:

1. A microfluidic device, comprising:
a channel, comprising converging and diverging portions; and
a plurality of magnets arranged next to the channel;
wherein the plurality of magnets is arranged to apply a magnetic field across the channel to capture magnetic particles in diverging portions of the channel where a velocity of a liquid in the channel is reduced.

2. The microfluidic device of claim 1, wherein the plurality of magnets comprises a first magnet, a second magnet, and a third magnet, the first magnet is beneath the channel, and the channel extends between the second magnet and the third magnet.

3. The microfluidic device of claim 2, wherein the second and third magnets are permanent magnets or electromagnets.

4. The microfluidic device of claim 3, wherein the first magnet comprises a soft, superparamagnetic material.

5. The microfluidic device of claim 2, wherein
the first magnet is one magnet of an array of first magnets; and
the first magnets of the array of first magnets are spaced apart along a direction of flow through the channel.

6. The microfluidic device of claim 5, wherein:
the channel comprises a plurality of chambers, each chamber comprising a portion of the channel wherein walls of the channel diverge in the direction of flow to a widest portion of the diverging portion and subsequently converge from the widest portion to a narrowest portion; and
first magnets of the array of first magnets are positioned beneath the chambers of the channel along a direction of flow through the channel.

7. The microfluidic device of claim 6, wherein sequential chambers of the channel are spaced apart from each other along the flow direction by narrower connecting portions, and a widest diameter of the chambers of the channel and a widest diameter of connecting portions of the channel are in a ratio of 2:1 to 4:1.

8. The microfluidic device of claim 5, wherein first magnets of the array of first magnets have an ellipsoid shape or an arrow shape.

9. The microfluidic device of claim 5, wherein:
a length dimension of the first magnets of the array of first magnets is greater than a width dimension of the first magnets of the array of first magnets; and
the first magnets of the array of first magnets are arranged such that their length dimensions are perpendicular to the flow direction of the channel.

10. The microfluidic device of claim 1, wherein:
the microfluidic device comprises a first inlet in fluid communication with the channel and a second inlet in fluid communication with the channel;
the first inlet communicates with the channel along a longitudinal axis of the channel; and
the second inlet communicates with the channel radially outward of the longitudinal axis of the channel such that liquid injected into the channel through the second inlet is radially outward of liquid injected into the channel through the first inlet.

11. The microfluidic device of claim 2, wherein:
the microfluidic device comprises a first substrate and a second substrate, the first substrate being arranged on top of the second substrate;
the second magnet and the third magnet are on the first substrate; and
the first magnet is on the second substrate and aligned with the channel on the first substrate above on the first magnet.

12. The microfluidic device of claim 1, wherein:
the plurality of magnets comprises a first magnet, a second magnet, a third magnet, and a fourth magnet;
the first, second, third, and fourth magnets are arranged on a plane with the channel, the first and fourth magnets are located between the second and third magnets, and the channel extends between the first and fourth magnets; and
the first and fourth magnets comprise a soft, superparamagnetic material and the second and third magnets are permanent magnets or electromagnets.

13. The microfluidic device of claim 12, wherein the first magnet and the fourth magnet are aligned with chambers of the channel along a direction of flow.

14. A microfluidic device, comprising:
a substrate defining a channel, the channel extending between an inlet and an outlet, the channel alternatingly widening and narrowing to define a plurality of chambers in a direction of flow along the channel between the inlet and the outlet; and
a plurality of magnets arranged about the channel and configured to apply a magnetic field to the chambers to capture magnetic particles in the chambers.

15. The microfluid device of claim 14, wherein the plurality of magnets includes a first magnet array positioned beneath the channel.

16. The microfluidic device of claim 15, wherein:
magnets of the first magnet array are aligned with the chambers; and
the plurality of magnets further comprises a second magnet array comprising a plurality of permanent magnets arranged on opposite sides of the channel.

17. The microfluidic device of claim 16, wherein:
the substrate is a first substrate, and the microfluid device further comprises a second substrate, the first substrate being arranged on top of the second substrate;
the plurality of permanent magnets is on the first substrate; and
the first magnet array is on the second substrate and aligned with the channel on the first substrate above the first magnet array.

18. The microfluidic device of claim 15, wherein magnets of the first magnet array have an ellipsoid shape or an arrow shape, and comprise a soft, superparamagnetic material.

19. The microfluidic device of claim 14, wherein sequential chambers of the channel are spaced apart from each other along the flow direction by narrower connecting portions, and a widest diameter of the chambers of the channel and a widest diameter of connecting portions of the channel are in a ratio of 2:1 to 4:1.

20. The microfluidic device of claim 14, wherein:
the microfluidic device comprises a first inlet in fluid communication with the channel and a second inlet in fluid communication with the channel;
the first inlet communicates with the channel along a longitudinal axis of the channel; and
the second inlet communicates with the channel radially outward of the longitudinal axis of the channel such that liquid injected into the channel through the second inlet is radially outward of liquid injected into the channel through the first inlet.
